(19) United States
(12) Patent Application Publication
(10) Pub. No.: US 2023/0113956 A1
(43) Pub. Date: Apr. 13, 2023

(54) GLOBAL PRIVACY AND DATA PROTECTION FRAMEWORK SYSTEM AND METHOD

(71) Applicant: PricewaterhouseCoopers LLP, New York, NY (US)

(72) Inventors: Manuj Lal, Chicago, IL (US); Jay Cline, Chicago, IL (US); Lana Bonadeo, Chicago, IL (US); Fallon Remington, Chicago, IL (US); Tyler Guryan, Chicago, IL (US); Brenden William Bixler, Chicago, IL (US); Aaron Lancaster, Chicago, IL (US)

(21) Appl. No.: 17/964,273

(22) Filed: Oct. 12, 2022

Related U.S. Application Data
(60) Provisional application No. 63/254,951, filed on Oct. 12, 2021.

(51) Int. Cl. G06F 21/62

(52) U.S. Cl. CPC G06F 21/6218

(57) ABSTRACT

A system for analyzing multiple authoritative sources of global privacy and data protection regulations and methods for making and using same. The system can be configured to receive source data associated with a regulation from one or more external data source systems. Receiving updated source data over time as the regulation changes, the system can store and maintain current and historic versions of the regulation. Upon receipt of a subsequent client query, the system can generate a report based upon the stored versions of the regulation. The report advantageously can enable the user to understand how the regulation changed over time and can help provide insights for a functional compliance program.

### CROSS-REFERENCE TO RELATED APPLICATIONS

This application claims the benefit of, and priority to, U.S. Provisional Application Ser. No. 63/254,951, filed Oct. 12, 2021, the disclosure of which is hereby incorporated herein by reference in its entirety and for all purposes.

### FIELD

The disclosed embodiments relate generally to the field of risk mitigation and more particularly, but not exclusively, to systems and methods for analyzing multiple authoritative sources of global privacy and data protection regulations to identify and mitigate risks.

### BACKGROUND

Reading, analyzing and mapping authoritative text to common privacy and data protection domains, sub-domains, and control statements can present many challenges. The authoritative text is different among countries and other geographic regions and must be considered in view of other local requirements. In addition, the authoritative text may be provided only in a local language, which must be translated or read by an individual fluent in the local language.

In view of the foregoing, a need exists for an improved system and method for analyzing multiple authoritative sources of global privacy and data protection to identify and mitigate risks that overcome the aforementioned obstacles and deficiencies of currently-available systems and methods.

### BRIEF DESCRIPTION OF THE DRAWINGS

FIG. 1 is a top-level flow chart illustrating an exemplary embodiment of a global privacy and data protection framework method.

FIG. 2A is a top-level flow chart illustrating an exemplary embodiment of a multi-step method for receiving current source data via the global privacy and data protection framework method of FIG. 1, wherein a work request associated with a new regulation is created, parsed and mapped.

FIG. 2B is a top-level flow chart illustrating an exemplary alternative embodiment of the multi-step method of FIG. 2A, wherein the created, parsed and mapped work request associated with the new regulation is reviewed.

FIG. 3A is a detailed flow chart illustrating an exemplary embodiment of a method for creating the work request of FIGS. 2A-B.

FIG. 3B is a detailed flow chart illustrating an exemplary embodiment of a method for reviewing the created work request of FIG. 3A.

FIG. 3C is a detailed flow chart illustrating an exemplary embodiment of a method for parsing the work request of FIGS. 2A-B.

FIG. 3D is a detailed flow chart illustrating an exemplary embodiment of a method for reviewing the parsed work request of FIG. 3C.

FIG. 3E is a detailed flow chart illustrating an exemplary embodiment of a method for mapping the work request of FIGS. 2A-B.

FIG. 3F is a detailed flow chart illustrating an exemplary embodiment of a method for reviewing the mapped work request of FIG. 3E.

FIG. 4 is a top-level flow chart illustrating an exemplary alternative embodiment of a multi-step method for receiving source data associated with a regulation via the global privacy and data protection framework method of FIG. 1, wherein a user is enabled to input, address and initiate storage of the source data.

FIG. 5A is a top-level flow chart illustrating another exemplary alternative embodiment of the method for receiving current source data via the global privacy and data protection framework method of FIG. 1, wherein a work request associated with a changed regulation is created.

FIG. 5B is a top-level flow chart illustrating an exemplary alternative embodiment of the method of FIG. 5A, wherein the created work request is reviewed.

FIG. 6A is a detailed flow chart illustrating an exemplary embodiment of a method for creating the work request of FIGS. 5A-B.

FIG. 6B is a detailed flow chart illustrating an exemplary embodiment of a method for reviewing the created work request of FIG. 6A.

FIG. 7A is a top-level flow chart illustrating still another exemplary embodiment of a multi-step method for receiving current source data via the global privacy and data protection framework method of FIG. 1, wherein a work request associated with a changed regulation is created, parsed and mapped.

FIG. 7B is a top-level flow chart illustrating an exemplary alternative embodiment of the multi-step method of FIG. 7A, wherein the created, parsed and mapped work request is reviewed.

FIG. 8 is a top-level flow chart illustrating an exemplary embodiment of a method for processing an initial work request associated with a predetermined regulation in accordance with the multi-step method of FIGS. 2A-B and for processing one or more subsequent work requests associated with respective changes to the predetermined regulation in accordance with the multi-step method of FIGS. 7A-B.

FIG. 9 is a top-level flow chart illustrating an exemplary embodiment of a method for perform framework versioning for a selected change to the predetermined regulation of FIG. 8.

FIGS. 10, 10A-1-10A-6, 10B-1-10B-8, 10C-1-10C-9, 10D-1-10D-9, 10E-1-10E-9, 10E-1-10E-7 and 10G-1-10G-9 are a detailed flow chart illustrating an exemplary embodiment of a data versioning method for the global privacy and data protection framework method of FIG. 1.

FIGS. 11, 11A-1-11A-3, 11B-1-11B-4 and 11C-1-11C-4 are a detailed flow chart illustrating an exemplary embodiment of a database versioning method for the global privacy and data protection framework method of FIG. 1.

FIG. 12A is a detail drawing illustrating a table illustrating an exemplary control framework of the global privacy and data protection framework method of FIG. 1 as source data received from selected data source systems changes over time.

FIG. 12B is a detail drawing illustrating a table illustrating comparisons between selected versions of the exemplary control framework of FIG. 12A.

FIG. 13 is a detail drawing illustrating an exemplary impact analysis report generated by the global privacy and data protection framework method of FIG. 1.

FIG. 14 is a top-level flow chart illustrating an exemplary embodiment of a tagging method for creating a hierarchy of tags for the global privacy and data protection framework method of FIG. 1.

FIG. 15A is a detail drawing illustrating an exemplary organization of categories and subcategories for business rules for the tagging method of FIG. 14.

FIG. 15B is a detail drawing illustrating an exemplary user interface for applying custom tags via a research system the tagging method of FIG. 14.

FIG. 16 is a top-level block diagram illustrating an exemplary embodiment of a global privacy and data protection framework system.

FIG. 17A is a top-level block diagram illustrating an exemplary alternative embodiment of the global privacy and data protection framework system of FIG. 16, wherein the global privacy and data protection framework system includes a deployment system and a report generation system.

FIG. 17B is a top-level block diagram illustrating another exemplary alternative embodiment of the global privacy and data protection framework system of FIG. 16, wherein the global privacy and data protection framework system includes a frontend system and a backend system.

FIG. 18 is a detail drawing illustrating still another exemplary alternative embodiment of the global privacy and data protection framework system of FIG. 16.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

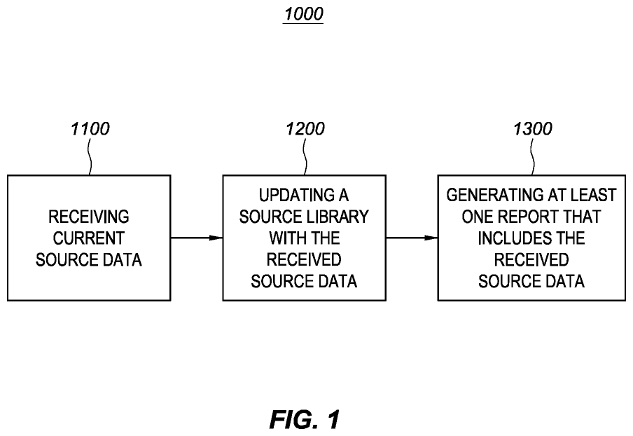

Since currently-available global privacy and data protection analysis systems and methods require analysis of different authoritative text written in different languages for multiple countries, a global privacy and data protection framework system and method for analyzing multiple authoritative sources of global privacy and data protection regulations can prove desirable and provide a basis for a wide range of applications, such as facilitating analysis of multiple authoritative sources of global privacy and data protection regulations to identify and mitigate risk. This result can be achieved, according to one embodiment disclosed herein, by a global privacy and data protection framework method 1000 as illustrated in FIG. 1.

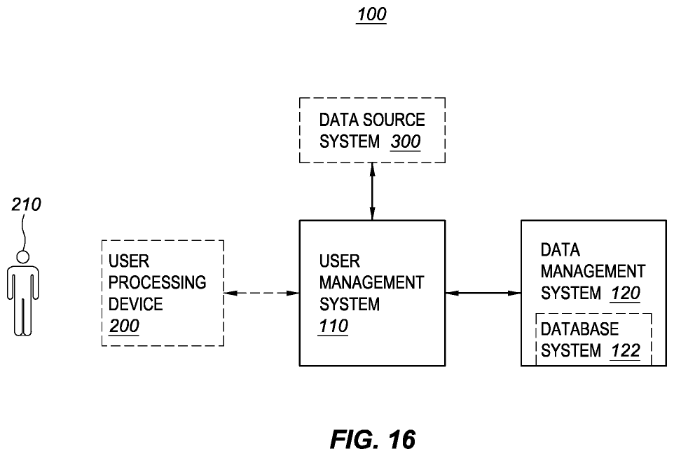

Turning to FIG. 1, the global privacy and data protection framework method 1000 can include, at 1100, receiving current regulatory or other source data. A new regulation and/or a change in an existing regulation, for example, can be detected or otherwise identified, and the global privacy and data protection framework method 1000 can enable at least one system operator and/or other user, collectively user 210 (shown in FIG. 16), to enter the new and/or changed regulation as the current source data. Additionally and/or alternatively, the current source data can be provided via one or more remote or otherwise external data source systems (or circuits) 300 (shown in FIG. 16).

A source library can be updated, at 1200, to include the received current source data. The updated source library with the received current source data, for example, can be stored as a new version of the source library. In other words, the received current source data, for example, can be stored as an initial version of the source library if the received current source data is associated with a new regulation; whereas, the received current source data associated with a changed regulation can be stored as an updated version of the source library. In selected embodiments, the source library can be updated to include a new version of the changed existing regulation while maintaining one or more older versions of the existing regulation.

The global privacy and data protection framework method 1000 advantageously can permit the user 210 to enter the received current source data and to interact with the generated reports that show the current and/or past versions of the source data. Database versioning and impact analysis reports, for example, can enable the user 210 to understand how a regulation changes over time and then drive insights necessary for a functional compliance program based on the available data. Stated somewhat differently, the global privacy and data protection framework method 1000 advantageously can support database versioning, impact analysis, source data mapping, and/or flexible hierarchy visualization of the current and/or past versions of the source data.

In selected embodiments, the external data source systems 300 upon which the user 210 relies for understanding compliance obligations may be static and/or may dynamically change over time. The global privacy and data protection framework method 1000 thereby can provide a control framework that is configured to group the external data source systems 300 to include the external data source systems 300 that are relevant to the user 210 and/or the compliance obligations of the user 210 at a given point in time. As the external data source systems 300 change, requirements contained in the control framework also can change. The user 210, for example, can manually modify the control framework over time, creating a new version of the control framework to understand the compliance obligations under a current state or conditions.

The global privacy and data protection framework method 1000 can be configured to store one or more versions of the control framework. The versions of the control framework include the compliance obligations of the user 210 are respective points in time. Thereby, if an existing regulation changes, the global privacy and data protection framework method 1000 can present current regulatory requirements and/or historic regulatory requirements at a given point in time for the user 210. Additionally and/or alternatively, the global privacy and data protection framework method 1000 can present a different between two versions of the regulatory requirements and/or the control framework.

At 1300, the global privacy and data protection framework method 1000 can generate one or more reports based upon the received current source data. Stated somewhat differently, the received current source data and/or the updated source library can percolate through the global privacy and data protection framework method 1000 and/or through the reports. The global privacy and data protection framework method 1000, for example, can generate at least one library dashboard and/or at least one regulation report via the control framework for enabling the user 210 to understand a current state of the source data, a current state of the regulation associated with the source data, and/or a current state of the control framework, without limitation.

Additionally and/or alternatively, the global privacy and data protection framework method 1000 can generate at least one library dashboard, at least one regulation report, at least one impact analysis and/or at least one history report via the control framework for permitting the user 210 to understand a historic (or prior) state of the source data, a historic (or prior) state of the regulation associated with the source data, and/or a historic (or prior) state of the control framework, without limitation. The global privacy and data protection framework method 1000 optionally can generate at least one impact analysis for enabling the user 210 to understand a first difference between a historic (or prior) state of the source data and a current state of the source data and/or a second difference between a historic (or prior) state of the regulation associated with the source data and a current state of the regulation associated with the source data, without limitation. One or more of the reports can comprise interactive reports for permitting the user 210 to interact with the reports to facilitate understanding.

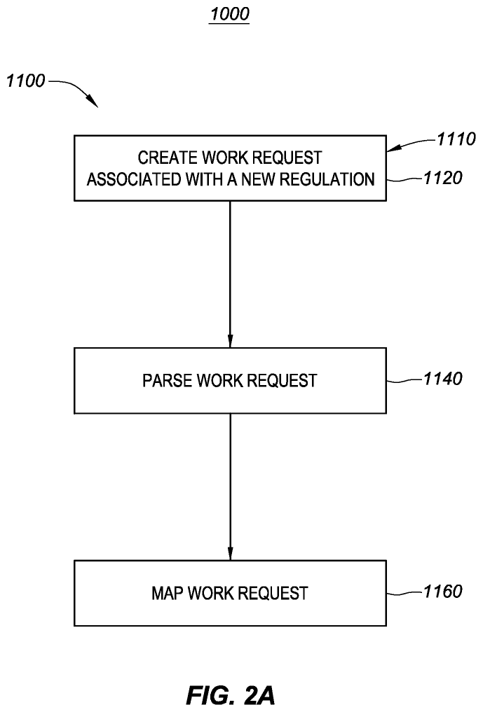

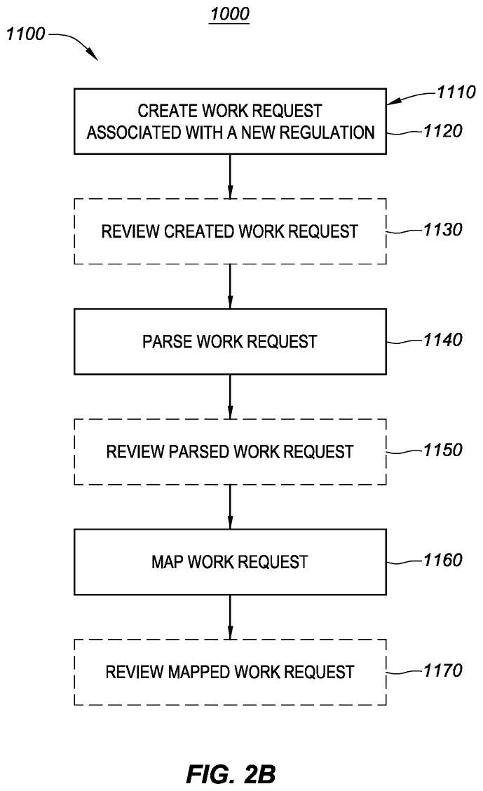

In selected embodiments, the global privacy and data protection framework method 1000 can receive the source data, at 1100, via a single-step process or a multi-step workflow process 1110 as illustrated in FIGS. 2A-B. The global privacy and data protection framework method 1000, for example, can permit the user 210 (shown in FIG. 16) to create a new source data entry and/or to update an existing source data entry via the multi-step workflow process 1110. The source data thereby can be created and maintained for enabling genesis of the regulatory requirements and/or the control framework as the source library is updated, at 1200 (shown in FIG. 1), and subsequent evaluation during generation of the reports, at 1300 (shown in FIG. 1). Upon receiving the source data, at 1100, the global privacy and data protection framework method 1000 can permit the source data to be edited and/or published for presentation to the user 210.

Turning to FIG. 2A, the multi-step workflow process 1110 is shown as comprising creating a work request associated with a new regulation, at 1120. The created work request can be parsed, at 1140, and/or mapped, at 1160, via the multi-step workflow process 1110. The multi-step workflow process 1110 optionally can include reviewing the work request after being created, at 1120, parsed, at 1140, and/or mapped, at 1160. FIG. 2B, for example, shows an embodiment of the multi-step workflow process 1110 that includes reviewing the created work request, at 1130, reviewing the parsed work request, at 1150, and/or reviewing the mapped work request, at 1170.

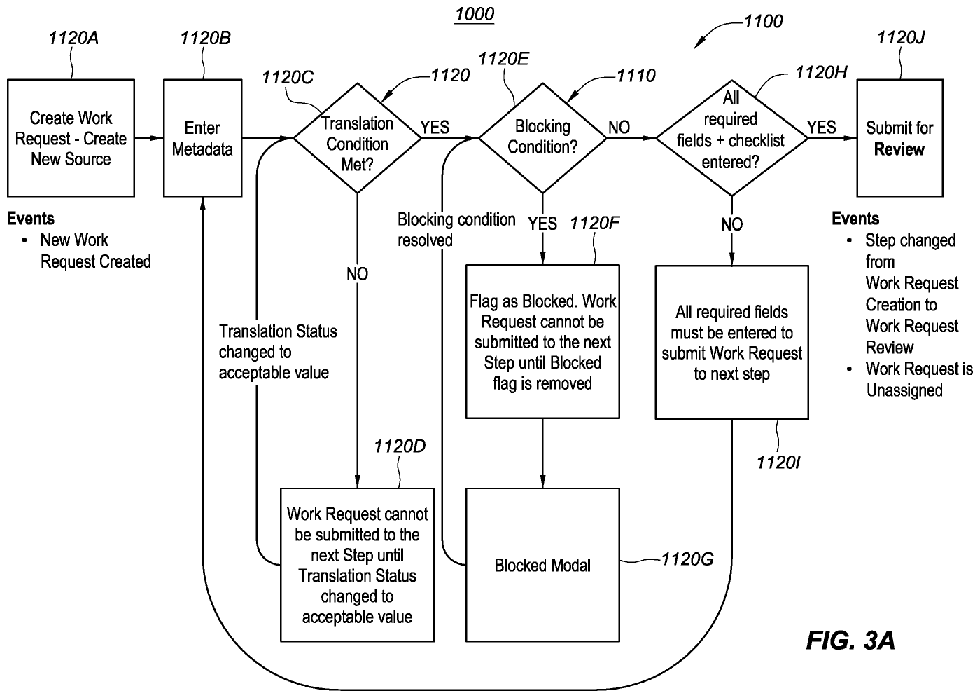

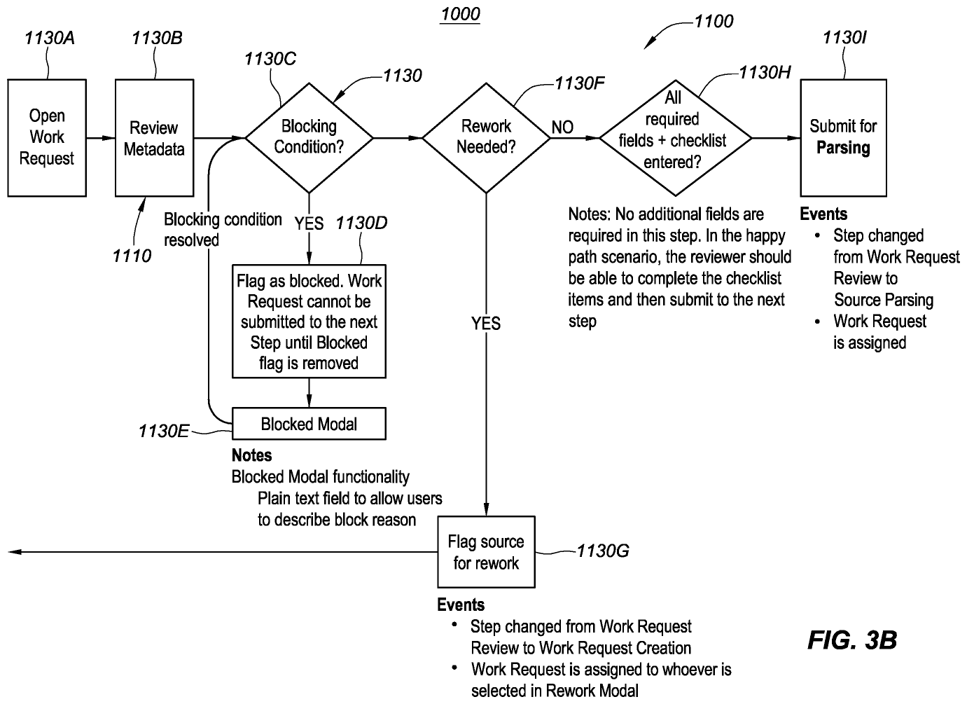

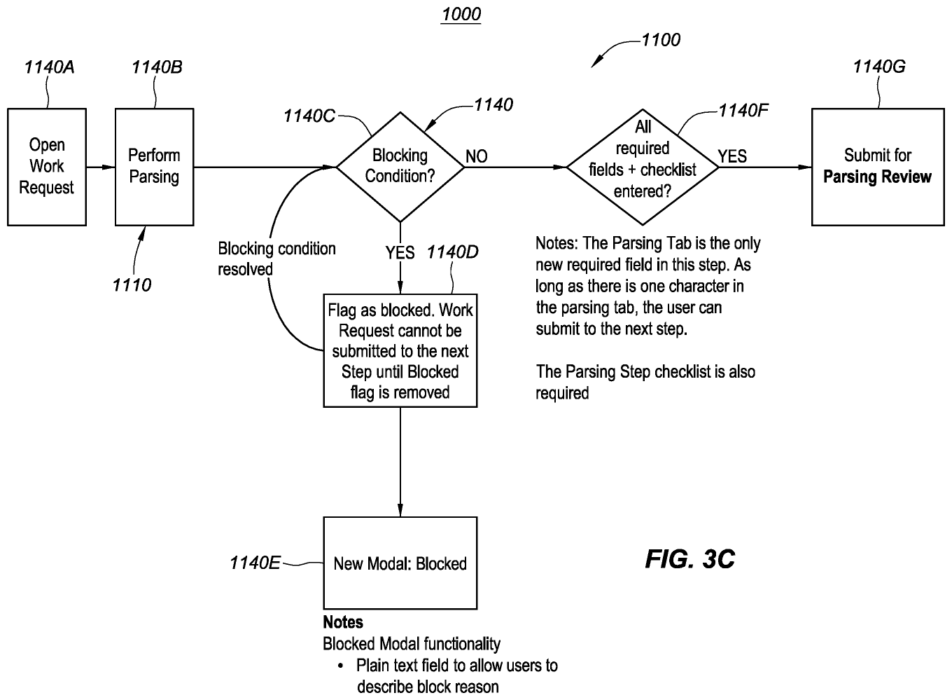

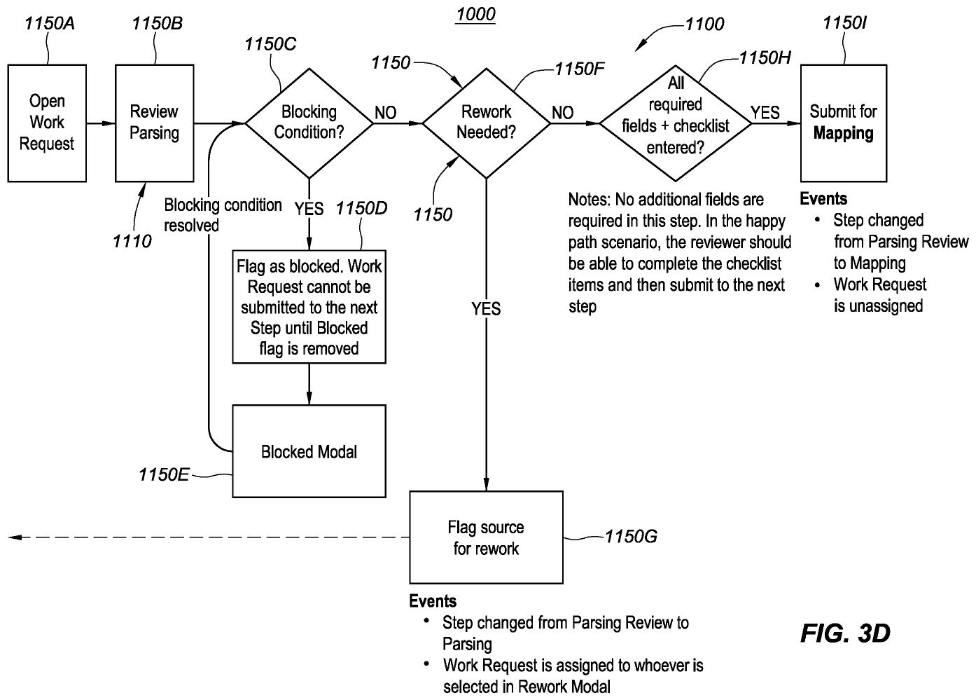

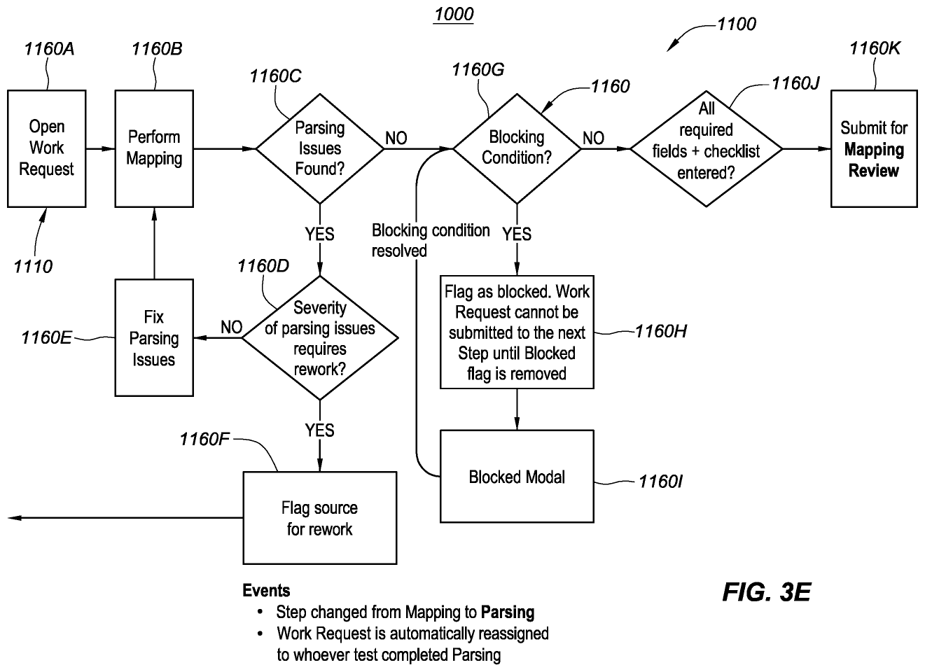

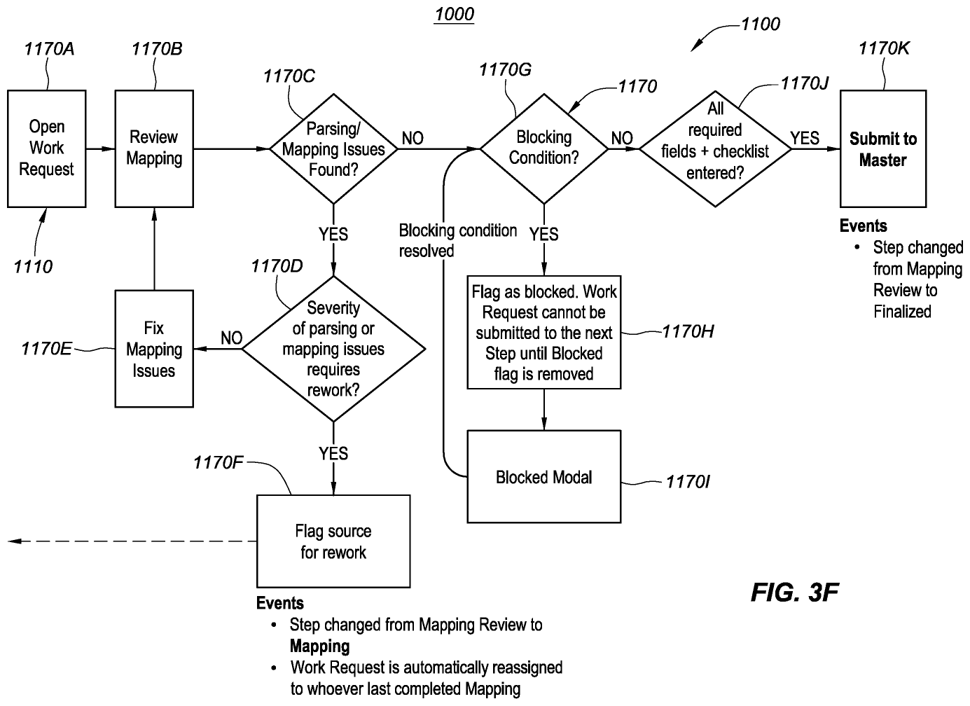

The multi-step workflow process 1110 can create the work request associated with the new regulation, at 1120, in any suitable manner. An exemplary embodiment of creating the work request, at 1120, is illustrated in FIG. 3A. As shown in FIG. 3A, the multi-step workflow process 1110 is initiated, at 1120A, by creating the work request for the new regulation (or a new external data source system 300). Metadata associated with the new regulation can be entered, at 1120B, and whether a translation condition has been met can be determined, at 1120C. If the translation condition is not met, the work request cannot be further processed, at 1120D, via the multi-step workflow process 1110 unless a translation status of the work request is changed to an acceptable value.

Once the translation condition is met, the multi-step workflow process 1110 can determine whether a blocking condition exists for the work request, at 1120E. If a blocking condition exists, the work request can be flagged as being blocked, at 1120F. The work request cannot be further processed, at 1120G, via the multi-step workflow process 1110 until the blocking condition is resolved and/or the work request can be flagged as not being blocked. Upon resolution of any blocking condition, the multi-step workflow process 1110 can determine whether each required field and/or a checklist have been entered for the work request, at 1120H. At 1120I, the work request cannot be further processed via the multi-step workflow process 1110 if at least one required field and/or the checklist have been not entered. The multi-step workflow process 1110, for example, can permit additional metadata associated with the new regulation to be entered, at 1120B, as illustrated in FIG. 3A. The work request, at 1120I, can proceed to a next step of the multi-step workflow process 1110 once each required field and/or a checklist have been entered.

In the manner set forth above with reference to FIGS. 2A-B, the created work request can be reviewed, at 1130, or can be parsed, at 1140. If the created work request is to be reviewed, at 1130, the created work request can be reviewed in any suitable manner. An exemplary embodiment of reviewing the created work request, at 1130, is illustrated in FIG. 3B. Turning to FIG. 3B, the multi-step workflow process 1110 is initiated, at 1130A, by opening the work request for the new regulation (or a new external data source system 300). Metadata associated with the new regulation can be reviewed, at 1130B, and the multi-step workflow process 1110 can determine whether a blocking condition exists for the work request, at 1130C. If a blocking condition exists, the work request can be flagged as being blocked, at 1130D. The work request cannot be further processed, at 1130E, via the multi-step workflow process 1110 until the blocking condition is resolved and/or the work request can be flagged as not being blocked.

Upon resolution of any blocking condition, the multi-step workflow process 1110 can determine whether any rework is needed for the work request, at 1130F. If the work request requires any reworking, the multi-step workflow process 1110 can flag the work request for rework, at 1130G, and return the work request to the step of creating a work request associated with a new regulation, at 1120. If the work request does not require any reworking, the multi-step workflow process 1110 can determine whether each required field and/or a checklist have been entered for the work request, at 1130H. In selected embodiments, the work request cannot be further processed via the multi-step workflow process 1110 if at least one required field and/or the checklist have been not entered in the manner set forth above with reference to FIG. 3A. At 11301, the work request can be submitted for parsing, at 1140, once each required field and/or a checklist have been entered.

In selected embodiments, the multi-step workflow process 1110 can parse the work request, at 1140, in the manner shown in FIG. 3C. Turning to FIG. 3C, parsing the work request, at 1140, can be initiated by opening the work request, at 1140A. The opened work request can be parsed, at 1140B. Once the opened work request has been parsed, the multi-step workflow process 1110 can determine, at 1140C, whether a blocking condition exists for the parsed work request. If a blocking condition exists, the parsed work request can be flagged as being blocked, at 1140D.

The parsed work request cannot be further processed, at 1140E, via the multi-step workflow process 1110 until the blocking condition is resolved and/or the parsed work request can be flagged as not being blocked. Upon resolution of any blocking condition, the multi-step workflow process 1110 can determine whether each required field and/or a checklist have been entered for the parsed work request, at 1140F. In selected embodiments, the parsed work request cannot be further processed via the multi-step workflow process 1110 if at least one required field and/or the checklist have been not entered in the manner set forth above with reference to FIG. 3A. The parsed work request, at 1140G, can proceed to a next step of the multi-step workflow process 1110 once each required field and/or a checklist have been entered.

In the manner set forth above with reference to FIGS. 2A-B, the parsed work request can be reviewed, at 1150, or can be mapped, at 1160. If the parsed work request is to be reviewed, at 1150, the parsed work request can be reviewed in any suitable manner. An exemplary embodiment of reviewing the parsed work request, at 1150, is illustrated in FIG. 3D. Turning to FIG. 3D, the work request can be opened, at 1150A, and the parsing of the work request can be reviewed, at 1150B. The multi-step workflow process 1110 can determine whether a blocking condition exists for the work request, at 1150C. If a blocking condition exists, the work request can be flagged as being blocked, at 1150D. The work request cannot be further processed, at 1150E, via the multi-step workflow process 1110 until the blocking condition is resolved and/or the work request can be flagged as not being blocked.

Upon resolution of any blocking condition, the multi-step workflow process 1110 can determine whether any rework is needed for the work request, at 1150F. If the work request requires any reworking, the multi-step workflow process 1110 can flag the work request for rework, at 1150G, and return the work request to the step of parsing a work request associated with a new regulation, at 1140. If the work request does not require any reworking, the multi-step workflow process 1110 can determine whether each required field and/or a checklist have been entered for the work request, at 1150H, in the manner discussed in more detail above with reference to FIG. 3B. In selected embodiments, the work request cannot be further processed via the multi-step workflow process 1110 if at least one required field and/or the checklist have been not entered in the manner set forth above with reference to FIG. 3B. At 11501, the work request can be submitted, at 1150I, for mapping once each required field and/or a checklist have been entered.

In selected embodiments, the multi-step workflow process 1110 can map the work request, at 1160, in the manner shown in FIG. 3E. Turning to FIG. 3E, mapping the work request, at 1160, can be initiated by opening the work request, at 1160A, and mapping the opened work request, at 1160B. Once the opened work request has been mapped, the multi-step workflow process 1110 can determine, at 1160C, whether any parsing issues exist in the mapped work request. If parsing issues exist in the mapped work request, a severity of the parsing issues can be evaluated, at 1160D. If not sufficiently severe as to require rework, the parsing issues in the mapped work request can be fixed, at 1160E, and the fixed work request can be mapped, at 1160B. Alternatively, the work request can be flagged for rework, at 1160F, if parsing issues exist in the mapped work request and are sufficiently severe as to require rework.

Once any parsing issues in the mapped work request have been resolved, the multi-step workflow process 1110 can determine whether a blocking condition exists for the work request, at 1160G. If a blocking condition exists, the work request can be flagged as being blocked, at 1160H. The work request cannot be further processed, at 11601, via the multi-step workflow process 1110 until the blocking condition is resolved and/or the work request can be flagged as not being blocked. Upon resolution of any blocking condition, the multi-step workflow process 1110 can determine whether each required field and/or a checklist have been entered for the parsed work request, at 1160J. In selected embodiments, the parsed work request cannot be further processed via the multi-step workflow process 1110 if at least one required field and/or the checklist have been not entered in the manner set forth above with reference to FIG. 3A. Once each required field and/or a checklist have been entered, the multi-step workflow process 1110 for the mapped work request can be deemed complete, or the mapped work request can proceed, at 1160K, to an optional review of the mapped work request, at 1170.

If the mapped work request is to be reviewed, at 1170, the mapped work request can be reviewed in any suitable manner. An exemplary embodiment of reviewing the mapped work request, at 1170, is illustrated in FIG. 3F. Turning to FIG. 3F, the work request can be opened, at 1170A, and the mapping of the work request can be reviewed, at 1170B. Once the mapping of the work request has been reviewed, the multi-step workflow process 1110 can determine, at 1170C, whether any parsing issues and/or any mapping issues exist in the mapped work request. If any parsing or mapping issues exist in the mapped work request, a severity of the parsing or mapping issues can be evaluated, at 1170D. If not sufficiently severe as to require rework, the parsing or mapping issues in the mapped work request can be fixed, at 1170E, and the mapping of the fixed work request can be reviewed, at 1170B. Alternatively, the work request can be flagged for rework, at 1170F, if parsing or mapping issues exist in the mapped work request and are sufficiently severe as to require rework.

Once any parsing or mapping issues in the mapped work request have been resolved, the multi-step workflow process 1110 can determine whether a blocking condition exists for the work request, at 1170G. If a blocking condition exists, the work request can be flagged as being blocked, at 1170H. The work request cannot be further processed, at 11701, via the multi-step workflow process 1110 until the blocking condition is resolved and/or the work request can be flagged as not being blocked. Upon resolution of any blocking condition, the multi-step workflow process 1110 can determine whether each required field and/or a checklist have been entered for the parsed work request, at 11701 In selected embodiments, the parsed work request cannot be further processed via the multi-step workflow process 1110 if at least one required field and/or the checklist have been not entered in the manner set forth above with reference to FIG. 3A. Once each required field and/or a checklist have been entered, the multi-step workflow process 1110 for the work request associated with the new regulation can be deemed complete and/or, at 1170K, prepared for submission.

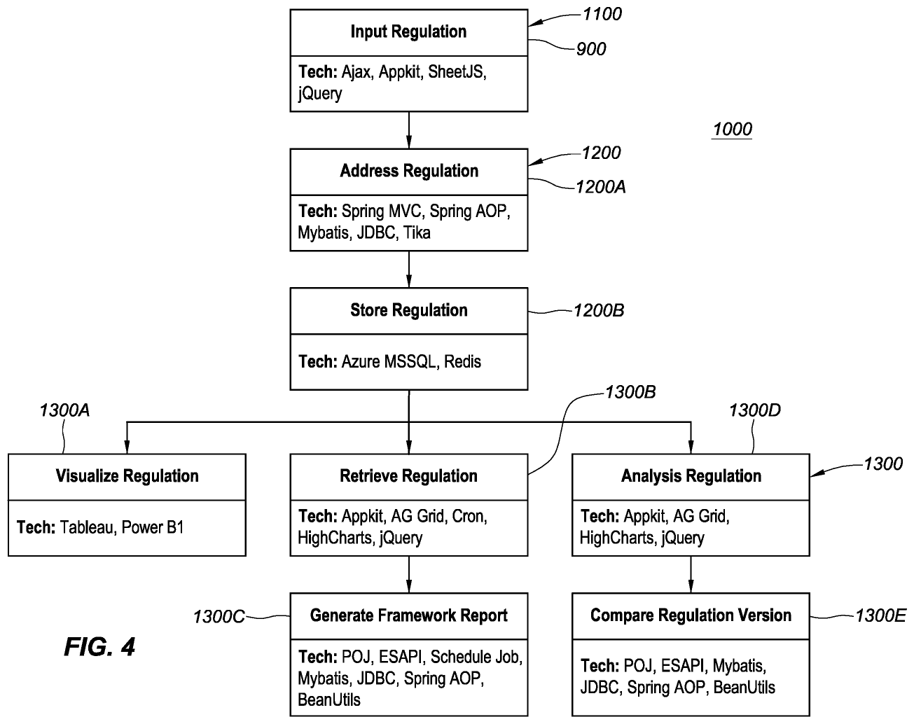

FIG. 4 illustrates another exemplary alternative embodiment of the global privacy and data protection framework method 1000. As shown in FIG. 4, receiving the source data, at 1100, can be preceded by (and/or can include) enabling the user 210 (shown in FIG. 16) to provide current source data for a regulation, at 900. The user 210 thereby can be enabled to provide metadata, regulatory text and other information related to the regulation. The user 210, for example, can be permitted, at 900, to enter the current source data for the regulation. The global privacy and data protection framework method 1000 advantageously can help ensure data integrity of the current source data so the current source data can be properly stored in a database system (or circuit) 122 (shown in FIG. 16), such as a central database system.

FIG. 4 illustrates that the user 210 optionally can be enabled to update the database system 122, at 1200, by addressing the current source data for the regulation, at 1200A, and/or initiating storage of the current source data for the regulation, at 1200B. In selected embodiments, the current source data for the regulation can be stored, at 1200B, in the database system 122 (shown in FIG. 16). Addressing and storing the regulation, in selected embodiments, can governs how and where the current source data for the regulation is stored in the database system 122.

The global privacy and data protection framework method 1000 likewise can receive a query from the user 210 about the regulation. In response to the user query, the global privacy and data protection framework method 1000 can retrieve the stored source data and/or other information related to the regulation from the database system 122 and present the retrieved regulation information to the user 210. In selected embodiments, the global privacy and data protection framework method 1000, at 1300, can respond to the user query by generating one or more reports regarding the regulation based upon the stored source data for presentation to the user 210.

The global privacy and data protection framework method 1000, for example, can enable the user 210 to visualize the regulation, at 1300A. In selected embodiments, the regulation can be visualized, at 1300A, via at least one library dashboard, at least one regulation report, at least one impact analysis and/or at least one history report for permitting the user 210 to understand a historic (or prior) state of the source data, a historic (or prior) state of the regulation associated with the source data, and/or a historic (or prior) state of the control framework, without limitation. Stated somewhat differently, the regulation can be visualized, at 1300A, by generating one or more reports based upon the received current source data in the manner discussed in more detail with reference to FIG. 1.

Additionally and/or alternatively, the global privacy and data protection framework method 1000 can retrieve the stored regulation information, at 1300B, and generate a framework report from the retrieved regulation information, at 1300C. The global privacy and data protection framework method 1000 optionally can perform an analysis of the stored regulation information, at 1300D, and/or perform a comparison between the stored regulation information associated with two or more versions of the regulation, at 1300E. In selected embodiments, the global privacy and data protection framework method 1000 advantageously can use the same system (or circuit) components for retrieving the regulation information and presenting the retrieved regulation information to the user 210.

Additionally and/or alternatively, the global privacy and data protection framework method 1000 can receive, at 1100 (shown in FIG. 1), current source data associated with a changed regulation. Stated somewhat differently, the global privacy and data protection framework method 1000 can process, at 1100, a work request for a change in an existing regulation, wherein the existing regulation was a subject of a work request previously processed by the global privacy and data protection framework method 1000. The global privacy and data protection framework method 1000 thereby can permit the user 210 (shown in FIG. 16) to update an existing source data entry.

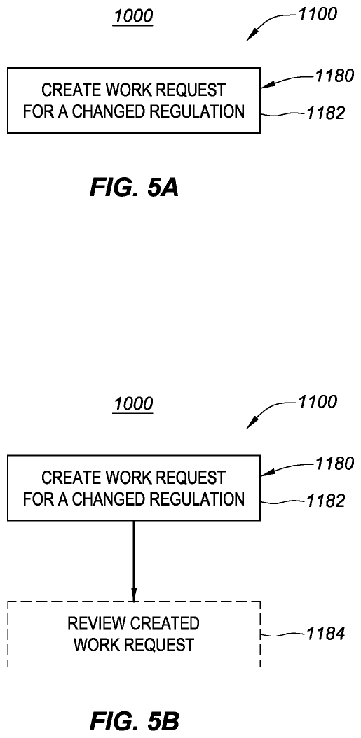

Turning to FIG. 5A, the global privacy and data protection framework method 1000 is shown as including a workflow process 1180 that comprises creating a work request for a changed regulation, at 1182. The workflow process 1180 optionally can include reviewing the work request after being created. FIG. 5B, for example, shows an embodiment of the workflow process 1180 that includes reviewing the created work request, at 1184. As the external data source systems 300 change, requirements contained in the control framework also can change in the manner discussed above. The workflow process 1180 advantageously can enable the user 210 (shown in FIG. 16) to manually modify the control framework over time, creating a new version of the control framework to understand the compliance obligations under a current state or conditions as one or more regulations change.

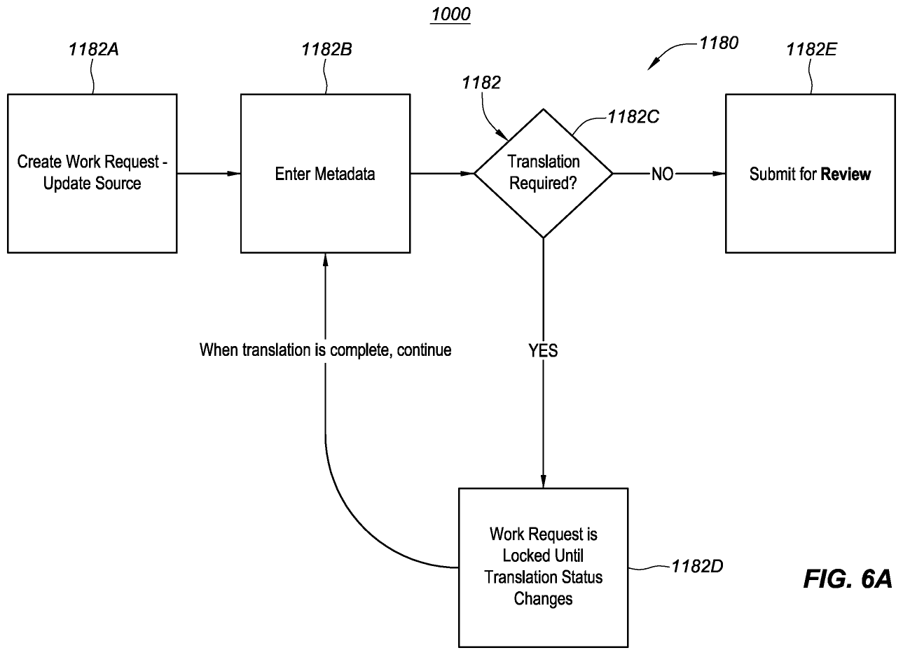

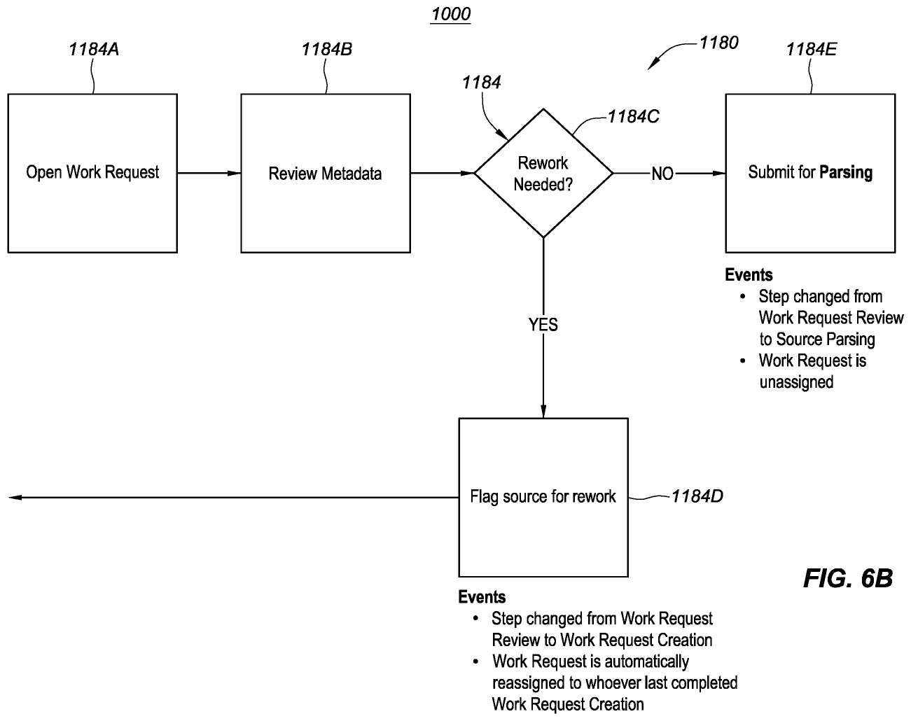

The workflow process 1180 can create the work request associated with the changed regulation, at 1182, in any suitable manner. An exemplary embodiment of creating the work request, at 1182, is illustrated in FIG. 6A. As shown in FIG. 6A, the workflow process 1180 is initiated, at 1182A, by creating the work request for the changed regulation (or a new or different external data source system 300). Metadata associated with the changed regulation can be entered, at 1182B, and whether a translation condition has been met can be determined, at 1182C. If the translation condition is not met, the work request cannot be further processed, at 1182D, via the workflow process 1180 unless a translation status of the work request is changed to an acceptable value. Once the translation condition is met, the workflow process 1180 can be deemed complete, or the created work request, at 1182E, can proceed to an optional review of the mapped work request, at 1184.

In the manner set forth above with reference to FIG. 5B, the created work request can be reviewed, at 1184. If the created work request is to be reviewed, at 1184, the created work request can be reviewed in any suitable manner. An exemplary embodiment of reviewing the created work request, at 1184, is illustrated in FIG. 6B. Turning to FIG. 6B, the workflow process 1180 is initiated, at 1184A, by opening the work request for the changed regulation (or a new or different external data source system 300). Metadata associated with the changed regulation can be reviewed, at 1184B, and the workflow process 1180 can determine whether rework is needed for the work request, at 1184C. If the work request requires any reworking, the workflow process 1180 can flag the work request for rework, at 1184D, and return the work request to the step of creating a work request associated with a changed regulation, at 1182. If the work request does not require any reworking, the workflow process 1180 can be deemed complete, or the created work request, at 1184E, can be submitted for further processing, at 1184E, such as parsing via the workflow process 1180.

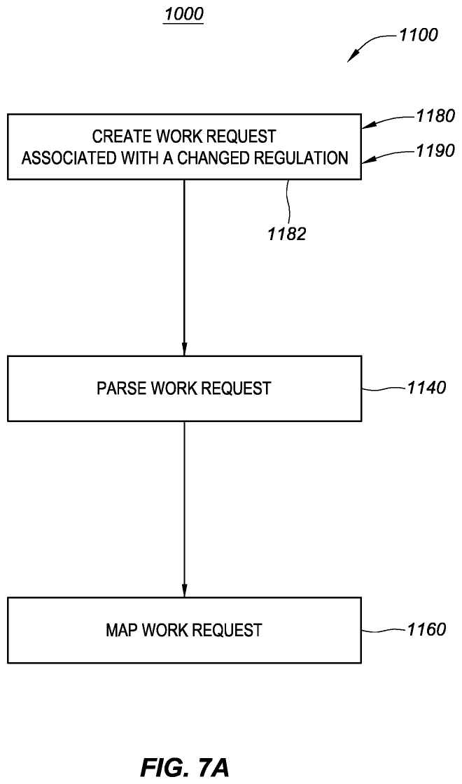

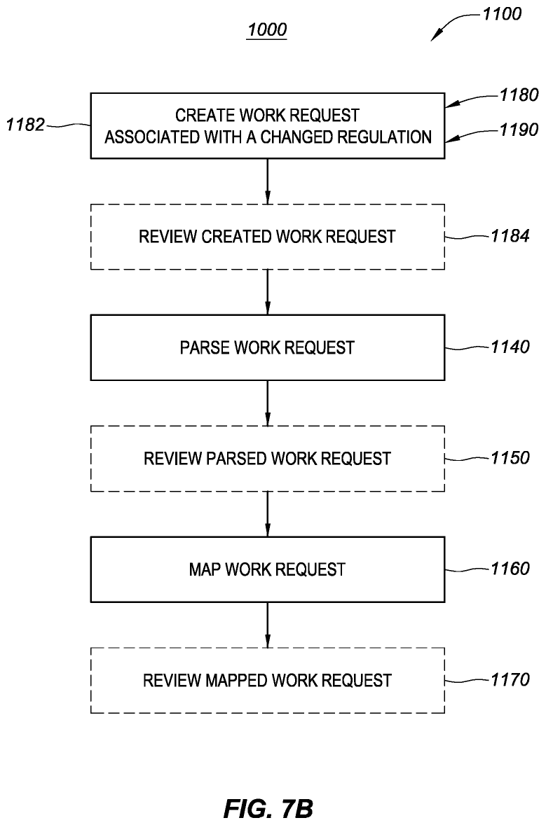

In selected embodiments, the workflow process 1180 can comprise a multi-step workflow process 1190 as illustrated in FIGS. 7A-B. Turning to FIG. 7A, for example, the multi-step workflow process 1190 can be initiated by creating a work request for a changed regulation, at 1182, in the manner discussed in more detail above with reference to FIG. 5A. The multi-step workflow process 1190 of FIG. 7A shows that the created work request can be parsed, at 1140, in the manner discussed in more detail herein with reference to FIGS. 2A-B and 3C and/or can be mapped, at 1160, in the manner discussed in more detail herein with reference to FIGS. 2A-B and 3E.

The multi-step workflow process 1190 optionally can include reviewing the work request after being created, at 1184, parsed, at 1140, and/or mapped, at 1160. FIG. 7B, for example, shows an embodiment of the multi-step workflow process 1190 that includes reviewing the created work request, at 1184, reviewing the parsed work request, at 1150, and/or reviewing the mapped work request, at 1170. In selected embodiments, the parsed work request can be reviewed, at 1150, in the manner discussed in more detail herein with reference to FIGS. 2B and 3D, and/or the mapped work request can be reviewed, at 1170, in the manner discussed in more detail herein with reference to FIGS. 2B and 3F.

Accordingly, the global privacy and data protection framework method 1000 can initially receive and process first source data associated with a predetermined regulation and subsequently receive and process second source data also associated with the predetermined regulation. The multi-step workflow process 1110, in other words, can govern how the source data is received, reviewed and/or edited, such as before the received source data is acceptable by the user 210 (shown in FIG. 16). In selected embodiments, the first and second source data can be received via respective work requests in the manner discussed in more detail above with regard to the work requests of FIGS. 2A-B and 7A-B. The global privacy and data protection framework method 1000 thereby can create a new version of the source data and/or the predetermined regulation for each work request.

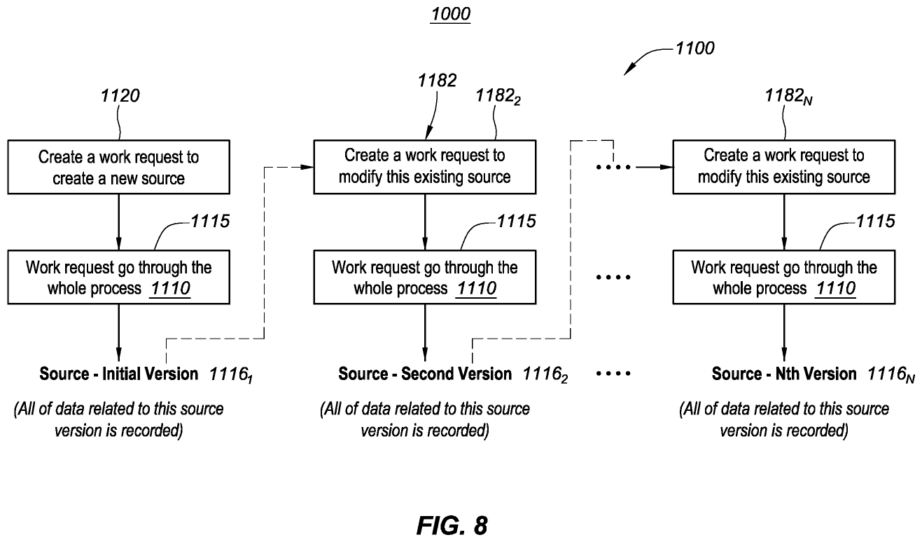

An exemplary method for sequentially receiving the source data, at 1100, as the predetermined regulation changes over time is illustrated in FIG. 8. Turning to FIG. 8, the global privacy and data protection framework method 1000 can create a work request, at 1120, for the source data associated with the predetermined regulation in the manner discussed in more detail above with reference to FIGS. 2A-B and 3A-B. At 1115, the global privacy and data protection framework method 1000 then can process the created work request in accordance with the multi-step workflow process 1110 as set forth in more detail above with reference to FIGS. 2A-B and 3C-F. The global privacy and data protection framework method 1000 thereby can provide an initial version 1116₁ of the source data and/or the predetermined regulation in a manner that can be accessible by the user 210 (shown in FIG. 16) such as via one or more of the reports discussed herein.

If the predetermined regulations changes, the global privacy and data protection framework method 1000 can create a second work request, at 1182₂, for second source data associated with the changed predetermined regulation in the manner discussed in more detail above with reference to FIGS. 5A-B, 6A-B and 7A-B. At 1115, for example, the global privacy and data protection framework method 1000 can process the second work request in accordance with the multi-step workflow process 1110 as set forth in more detail above with reference to FIGS. 3C-F, 5A-B, 7A-B. The global privacy and data protection framework method 1000 thereby can provide a second version 11162 of the second source data and/or the changed predetermined regulation in a manner that can be accessible by the user 210 (shown in FIG. 16) such as via one or more of the reports discussed herein.

The global privacy and data protection framework method 1000 can continue to create additional work requests for subsequent source data associated with further changes to the predetermined regulation. For example, if the predetermined regulations further changes N times, the global privacy and data protection framework method 1000 can create an N^{th} work request, at 1182_{N}, for the N^{th} source data associated with the further-changed predetermined regulation in the manner discussed in more detail above with reference to FIGS. 5A-B, 6A-B and 7A-B. At 1115, for example, the global privacy and data protection framework method 1000 can process the N^{th} work request in accordance with the multi-step workflow process 1110 as set forth in more detail above with reference to FIGS. 3C-F, 5A-B, 7A-B. The global privacy and data protection framework method 1000 thereby can provide a N^{th} version 1116_{N} of the second source data and/or the changed predetermined regulation in a manner that can be accessible by the user 210 (shown in FIG. 16) such as via one or more of the reports discussed herein.

In selected embodiments, the global privacy and data protection framework method 1000 can create and/or refresh the versions of the control framework if the source data and/or the regulation associated with the source data is updated or otherwise changes. The versions of the control framework can be updated automatically and/or manually. Stated somewhat differently, the global privacy and data protection framework method 1000 can include an automatic refresh mode and/or a manual refresh mode.

In the automatic refresh mode, the global privacy and data protection framework method 1000 can automatically create a new version of the control framework and/or refresh an existing version of the control framework upon detecting that the source data and/or the regulation associated with the source data has changed and/or in accordance with a predetermined time schedule, such as periodically. Alternatively, in the manual refresh mode, the global privacy and data protection framework method 1000 can the new version of the control framework can be created and/or the existing version of the control framework can be refreshed manually, such as by initiation by the user 210.

If an exemplary control framework comprises one hundred regulations and one of the regulations of the control framework changes, the global privacy and data protection framework method 1000 can create a new version of the control framework. The global privacy and data protection framework method 1000 can create a new version of the control framework automatically in the automatic refresh mode and/or manually in the manual refresh mode. Thereby, the global privacy and data protection framework method 1000 advantageously can be continuously updated with the latest regulatory requirements.

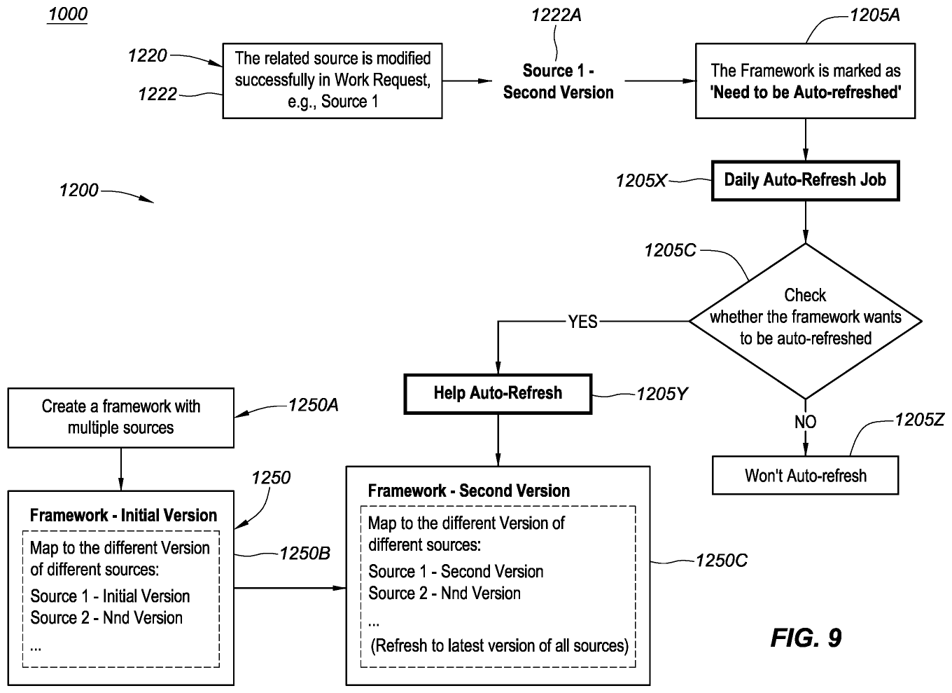

Turning to FIG. 9, for example, the global privacy and data protection framework method 1000 can be configured to update the database system 122 (shown in FIG. 16), at 1200, by refreshing a first version of a control framework if the source data and/or the regulation associated with the source data has changed. The first version of the control framework can be created with one or more source data associated with one or more data source systems 300, at 1250A. The source data can be associated with respective regulations in the manner discussed in more detail herein. As shown in FIG. 9, the first version of the control framework, at 1250B, can include an initial (or first) version of first source data associated with a first data source system 300 and an Nth version of second source data associated with a second data source system 300. The first source data, for example, can be associated with a first regulation; whereas, the second source data can be associated with a second regulation.

If a second version of the first source data associated with a change to the first regulation becomes available, a second version of the control framework, at 1250C, can be created with the second version of the first source data associated with the first data source system 300. The second version of the control framework, at 1250C, can maintain the Nth version of the second source data since the second source data did not change in this example. A work request associated with the changed first regulation can be processed, at 1222, updating an existing source data entry for an existing data source system 300. The updated source data entry can be included as a second version of the control framework, at 1222A.

As shown in FIG. 9, the control framework, at 1205A, can be in the automatic refresh mode or in the manual refresh mode. The automatic refresh mode can enable the control framework to be refreshed in accordance with a predetermined time schedule, such as daily, at 1205X. At 1205C, a determination of whether the control framework in the automatic refresh mode can be made. If the control framework is in the automatic refresh mode, the control framework, at 1205Y, will be automatically refreshed with the second version of the control framework with the changed first regulation. The control framework, at 1205Z, will not be automatically refreshed with the second version of the control framework with the changed first regulation if the control framework is not in the automatic refresh mode. The control framework thus will need to be manually refreshed to include the second version of the control framework.

In the manner discussed above with reference to FIG. 1, the global privacy and data protection framework method 1000 can update the source library, at 1200, to include the received current source data. The source library, for example, can be updated to include a new version of the changed existing regulation while maintaining one or more older versions of the existing regulation in the database system (or circuit) 122 (shown in FIG. 16). The global privacy and data protection framework method 1000, in other words, advantageously can support database versioning for enabling regulatory change management. The database system 122, for example, can include a versioning table (not shown) for maintaining a record of the versions of each relevant regulation. In selected embodiments, the global privacy and data protection framework method 1000 can store the new version of the changed existing regulation when the received source data indicates a change to the source data and/or a change to the regulation associated with the source data.

If the received source data indicates a change to the source data and/or a change to the regulation associated with the source data, the new version of the changed existing regulation can be stored with all details and related data as a snapshot with a specific version number defined in the database system 122. The records in the version object thereby can be used throughout the global privacy and data protection framework method 1000 to perform an impact analysis between two selected versions of the control framework, two selected versions of the source data and/or two selected versions of the regulation associated with the source data. The resultant impact analysis can present how the control framework, the source data and/or the regulation associated with the source data has changed over time. A flag in the versioning table of the database system 122 can track the status of each relevant regulation and/or the status of each relevant external data source system 300. The flag, for example, can indicate that a relevant regulation and/or external data source system 300 is active for new and/or changed regulations, that the relevant external data source system 300 is inactive for deactivated data source systems 300 and/or that the relevant external data source system 300 is deleted for deleted data source systems 300.

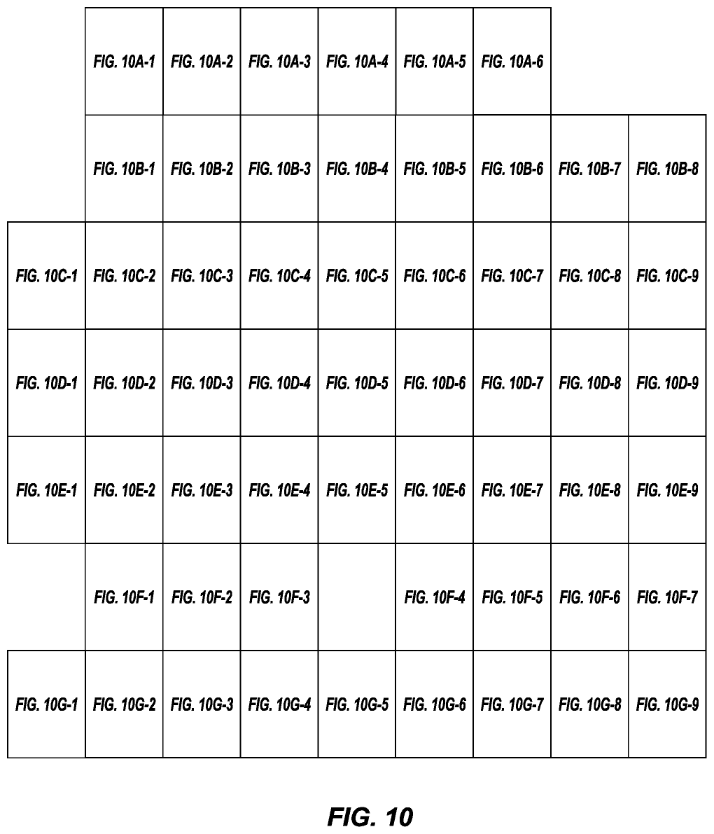

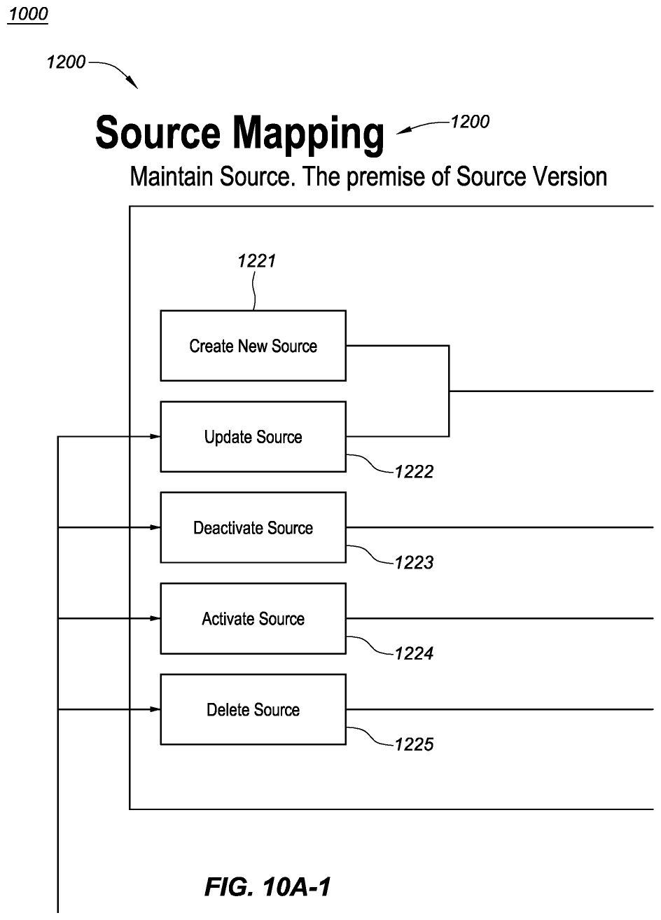

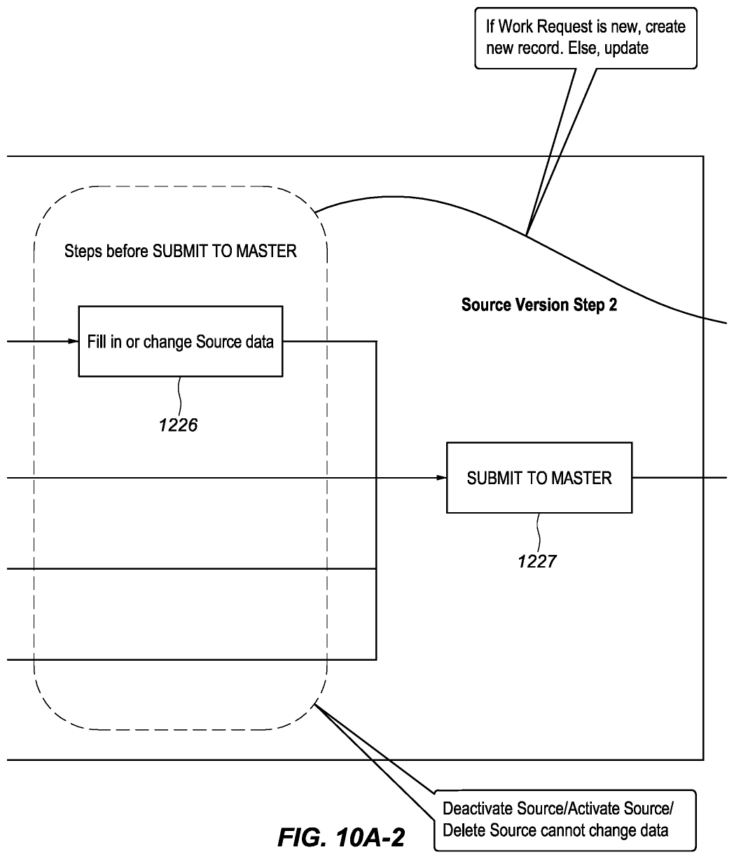

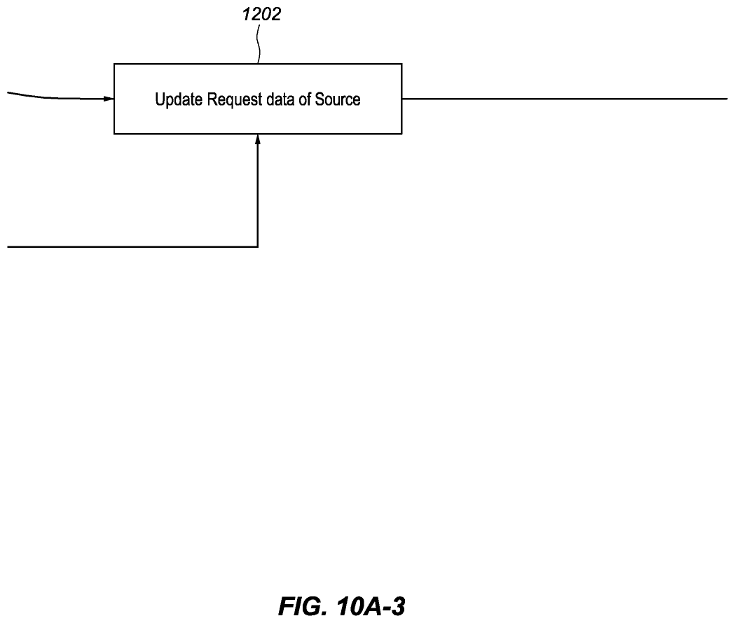

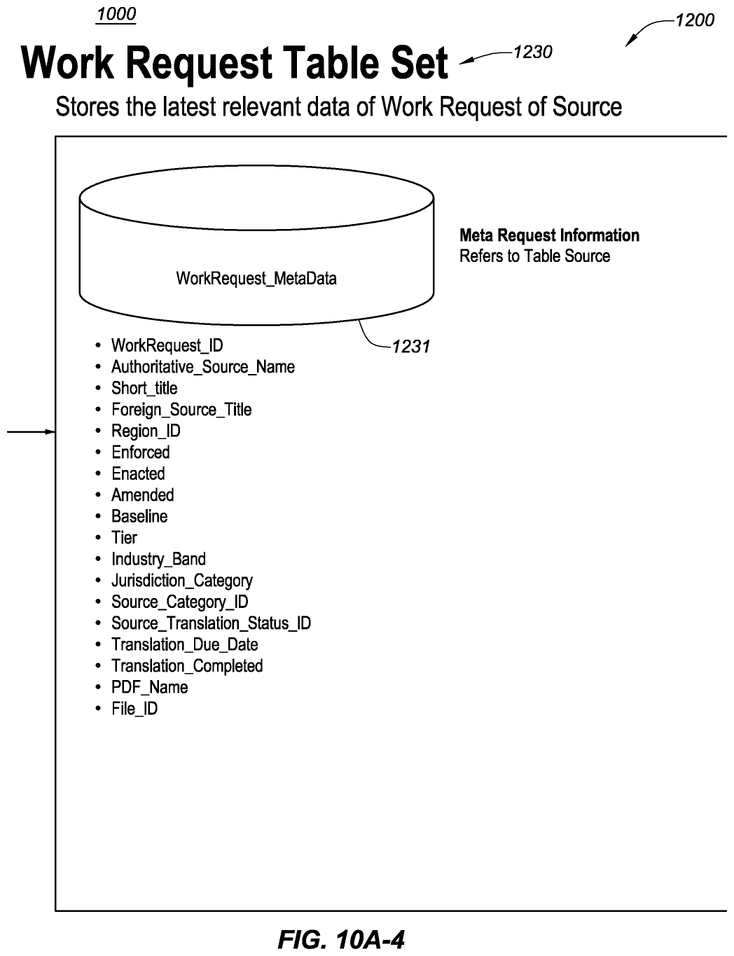

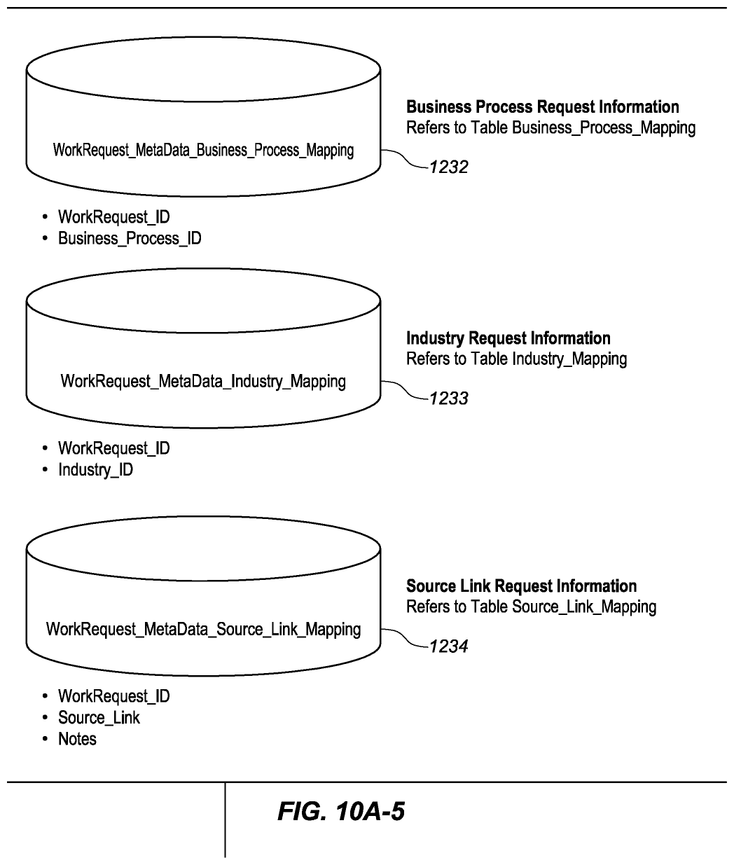

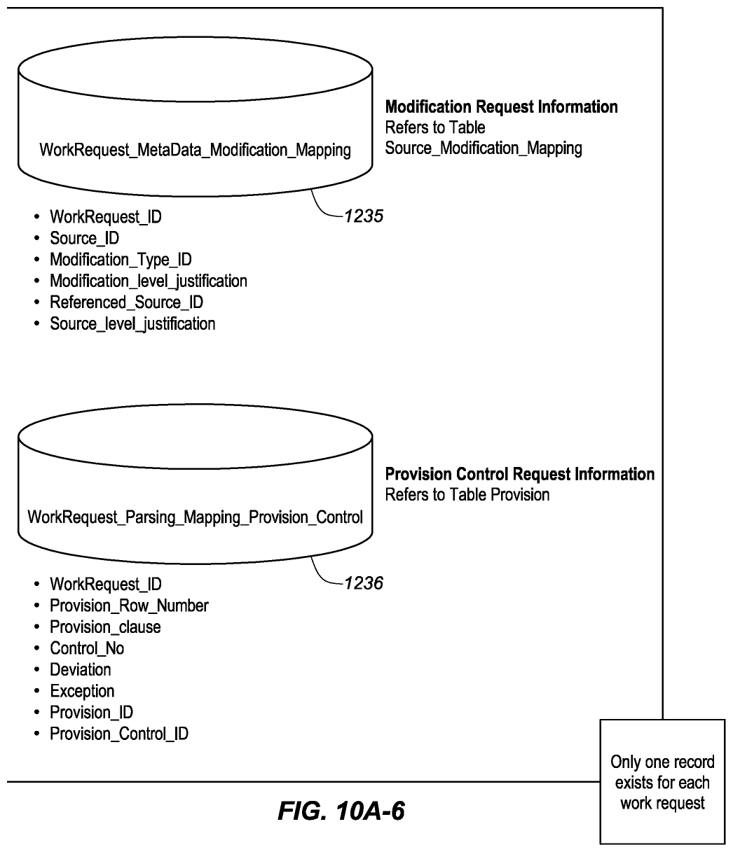

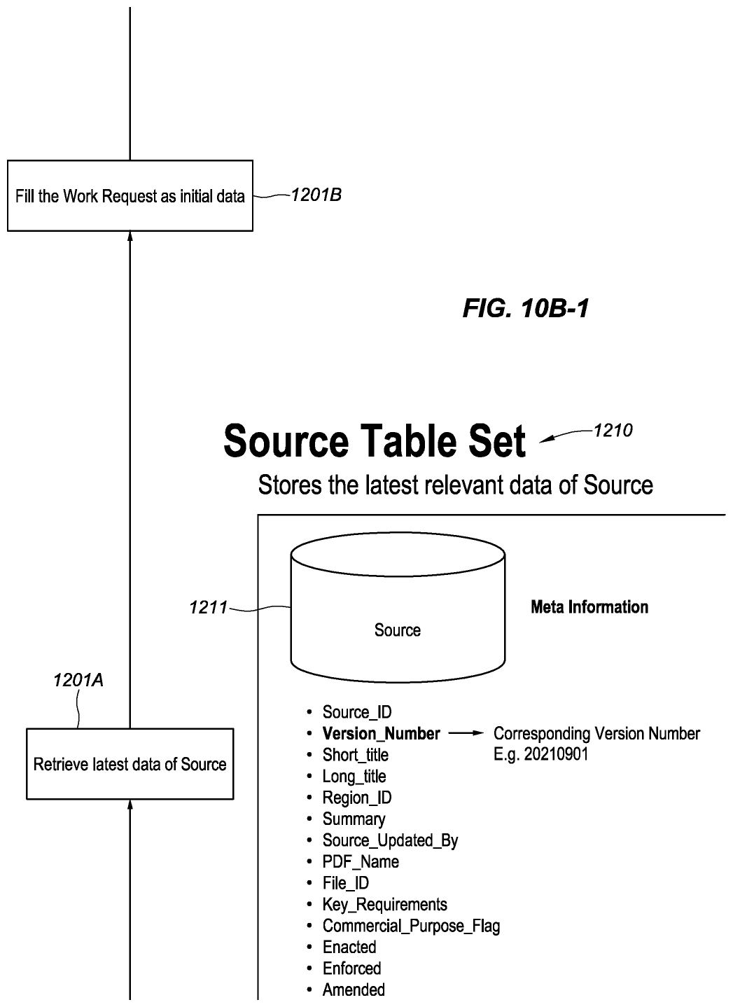

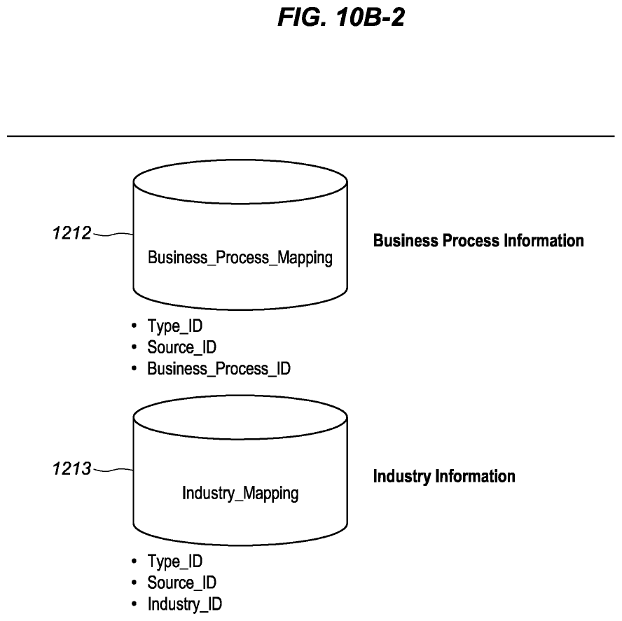

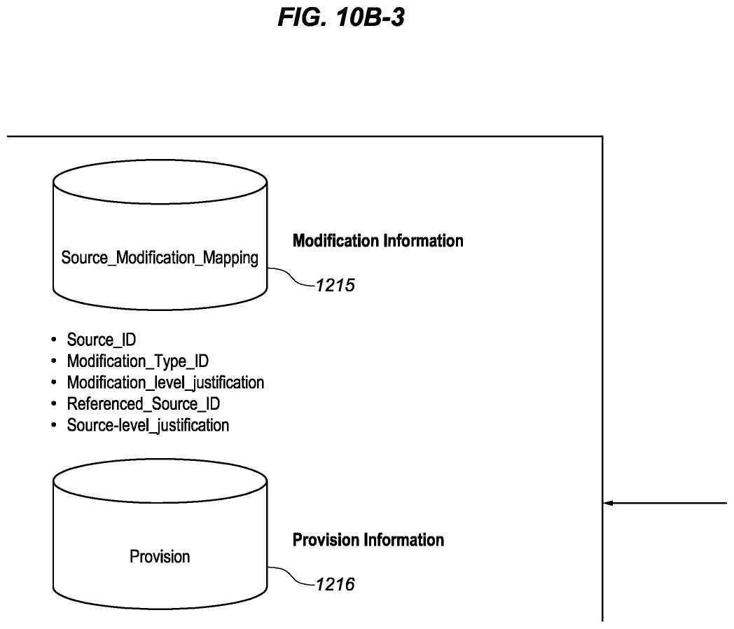

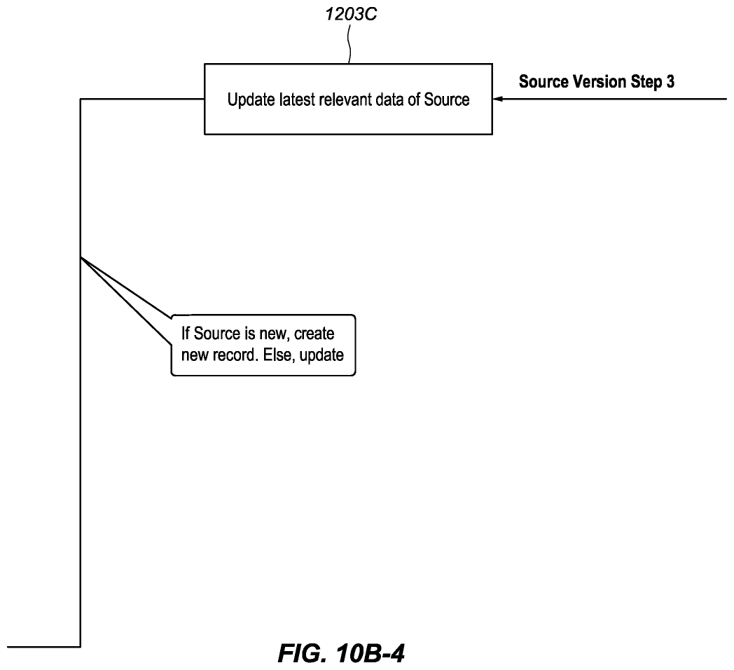

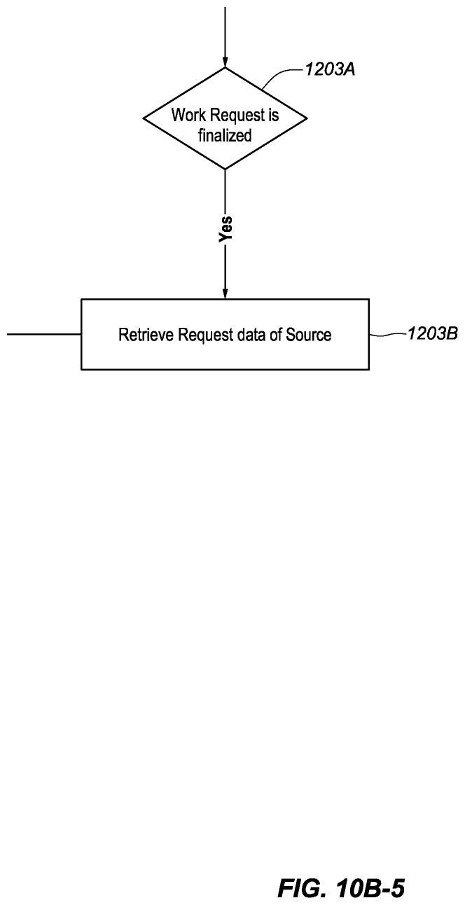

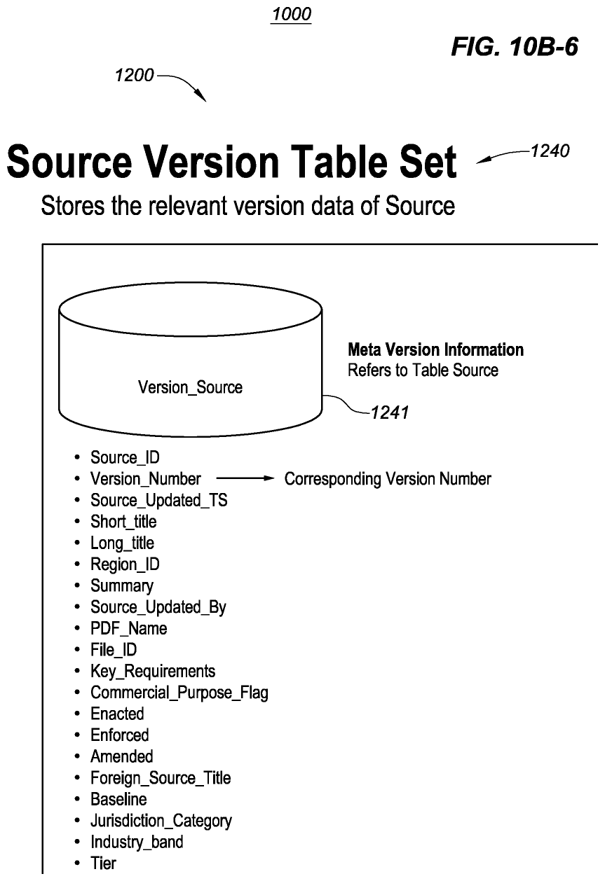

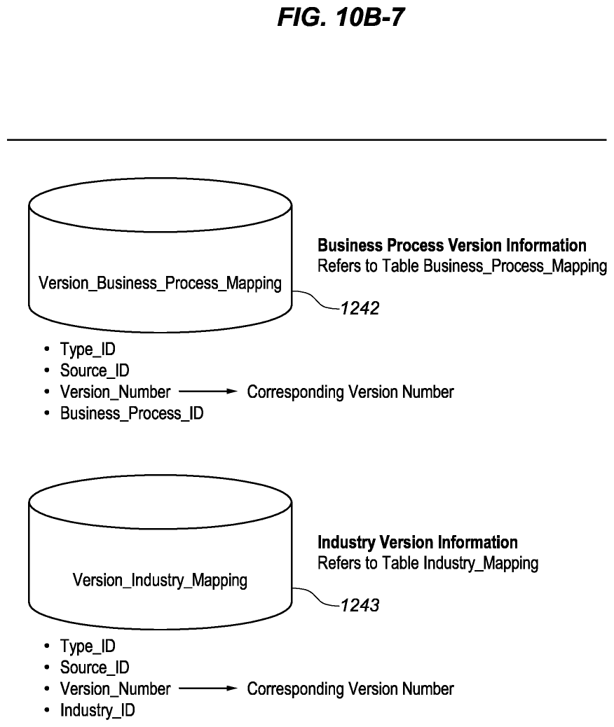

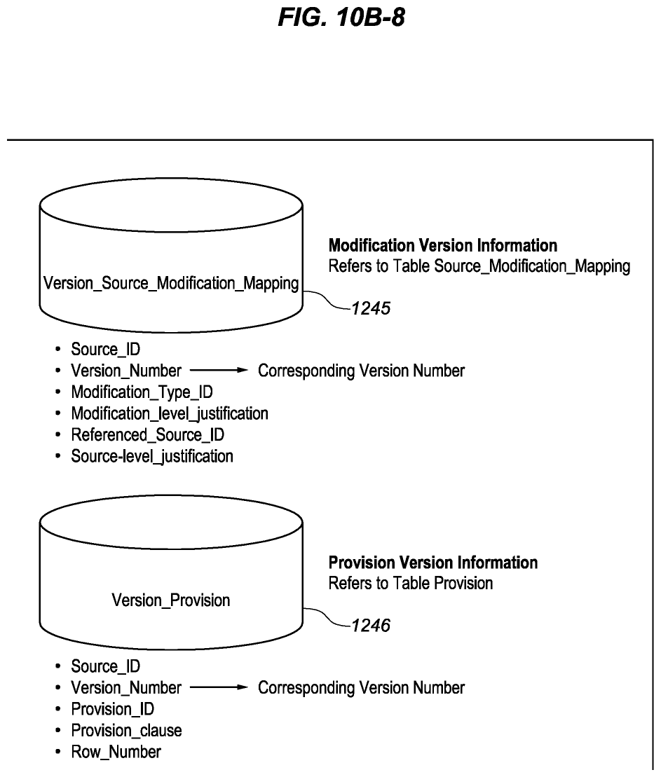

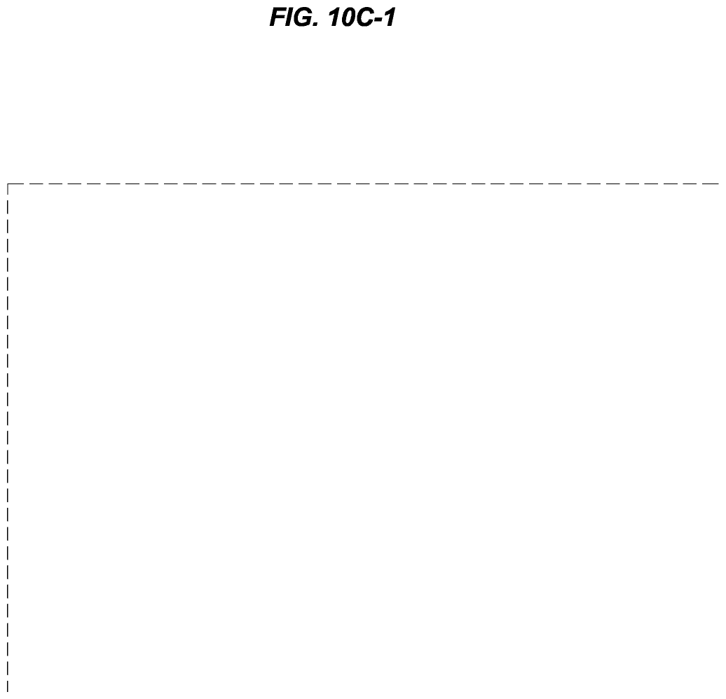

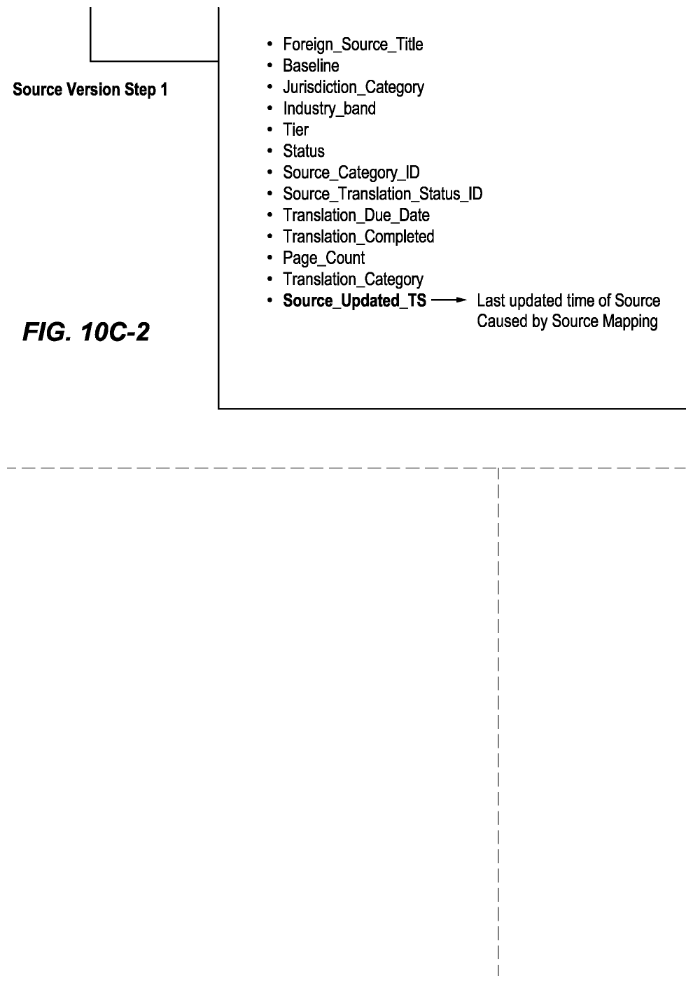

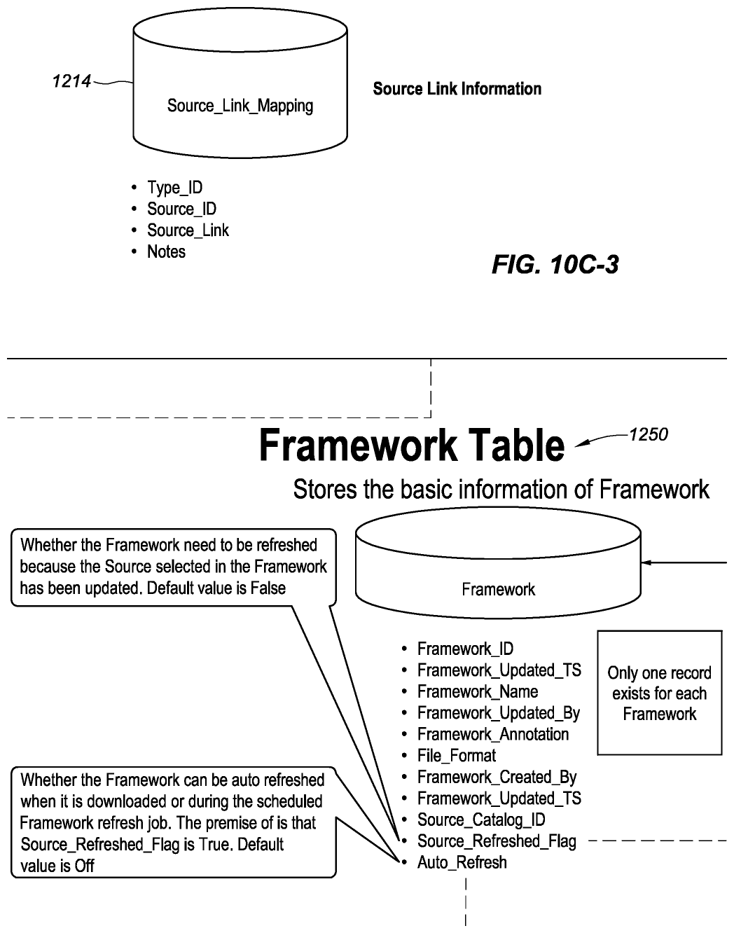

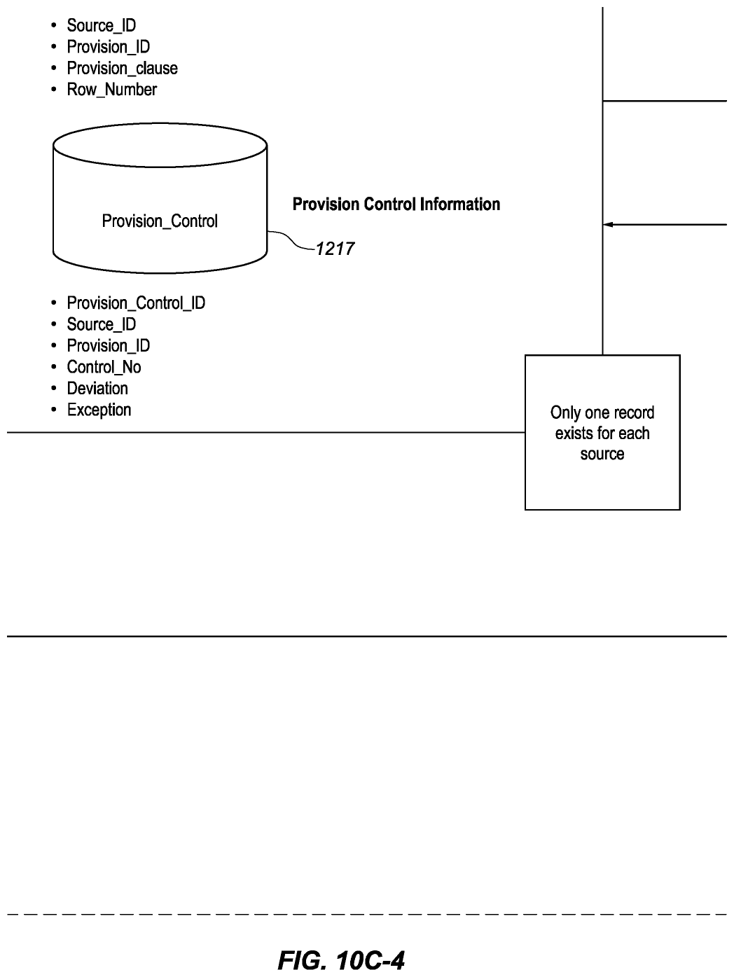

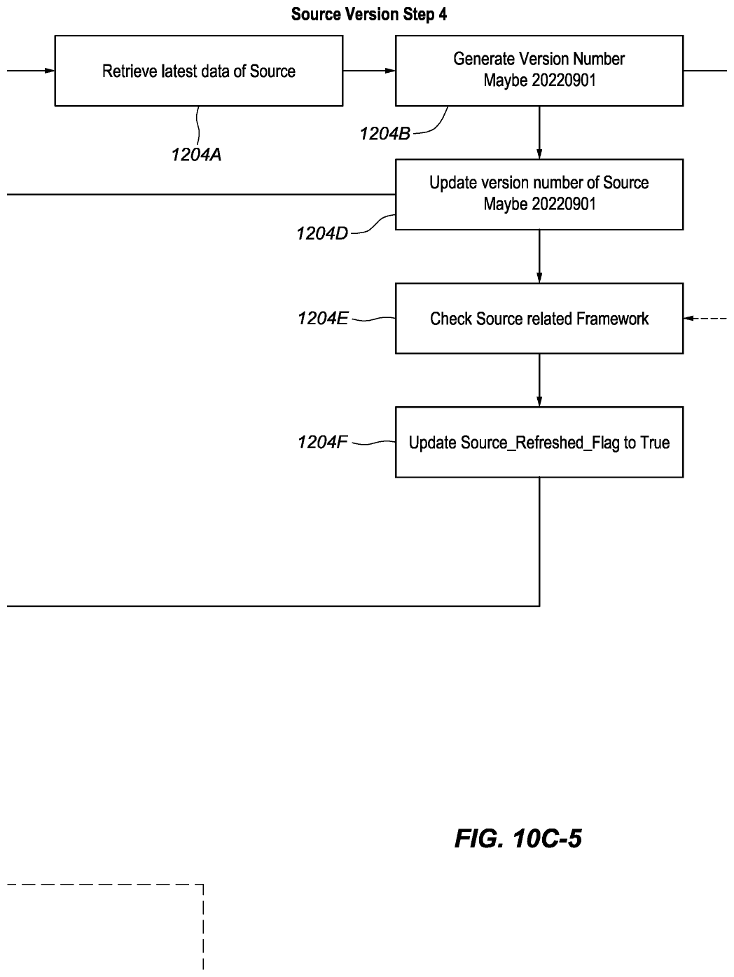

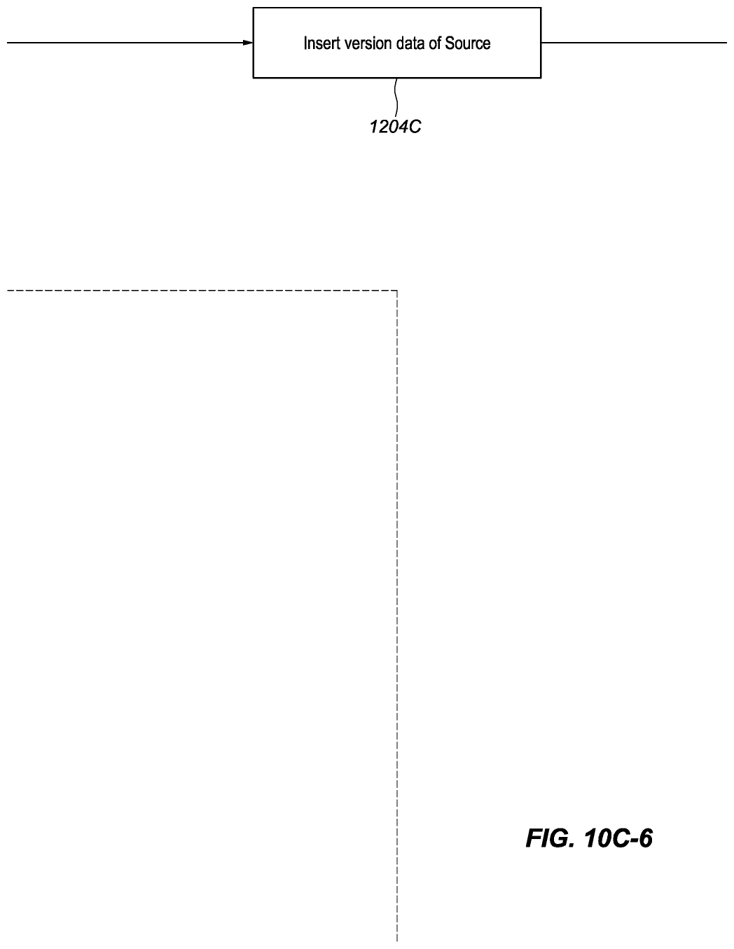

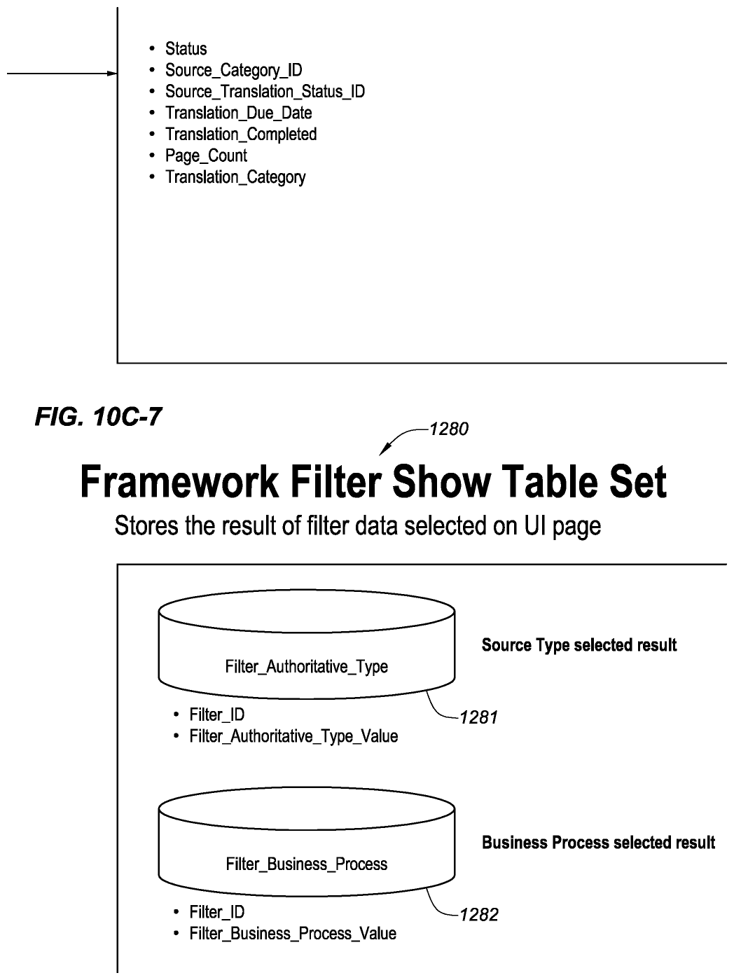

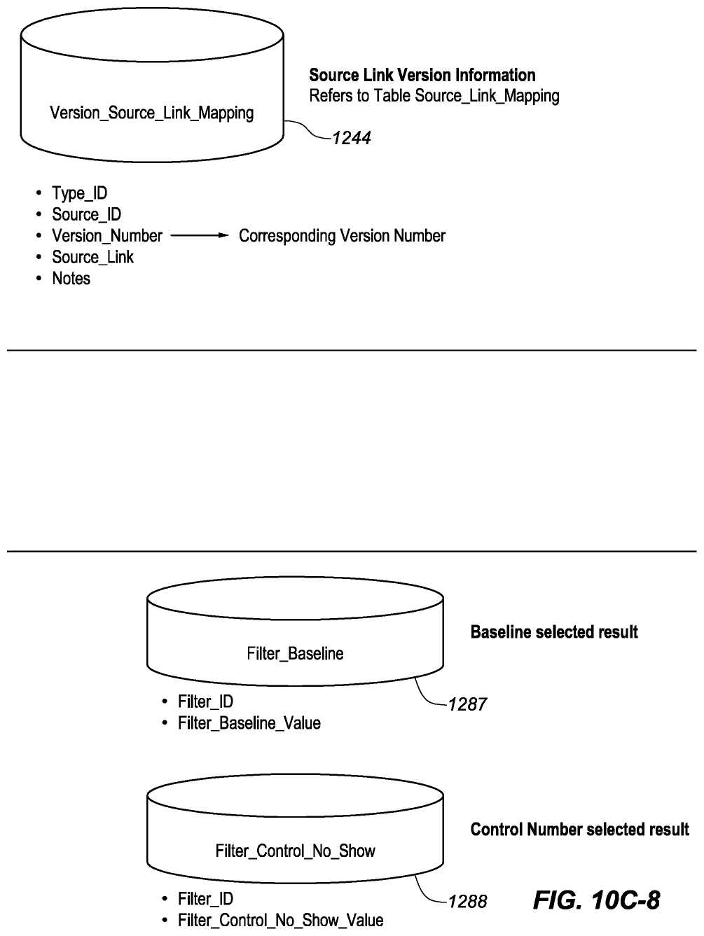

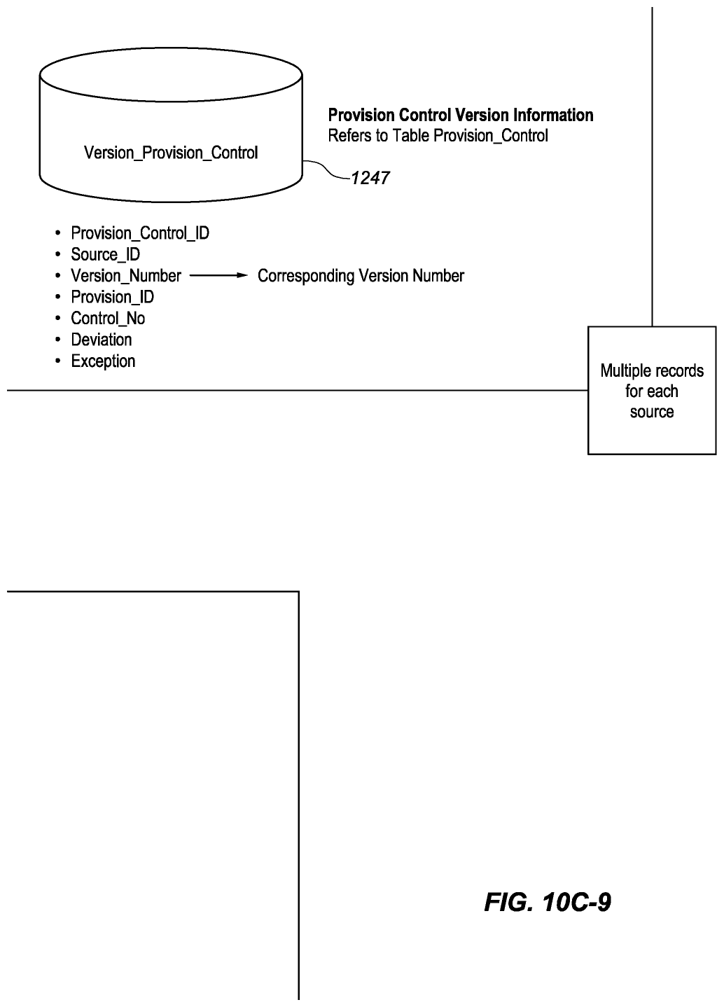

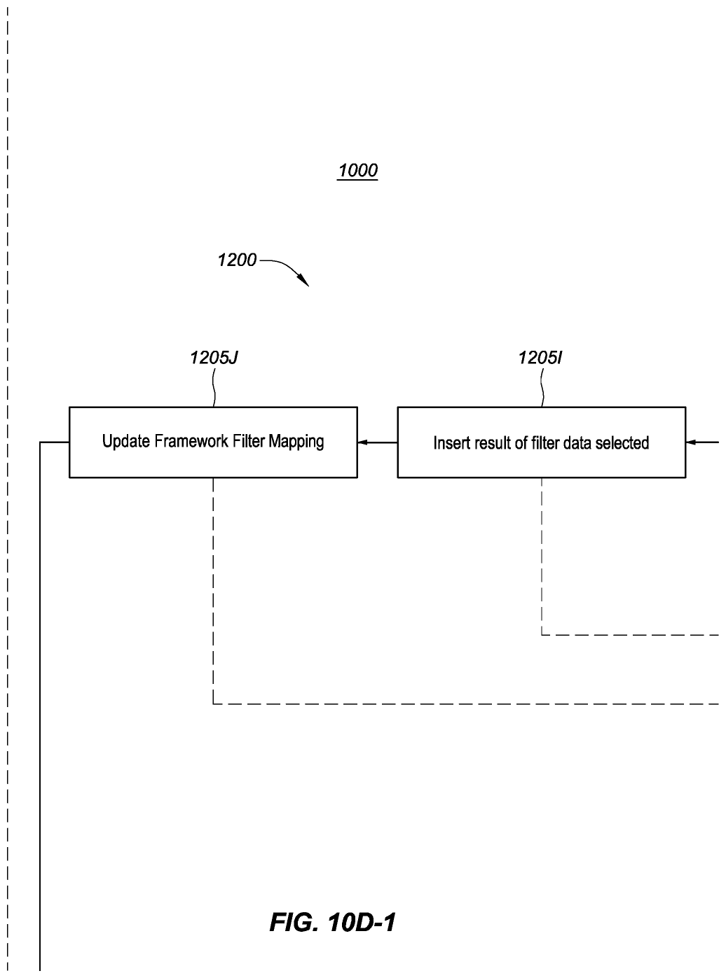

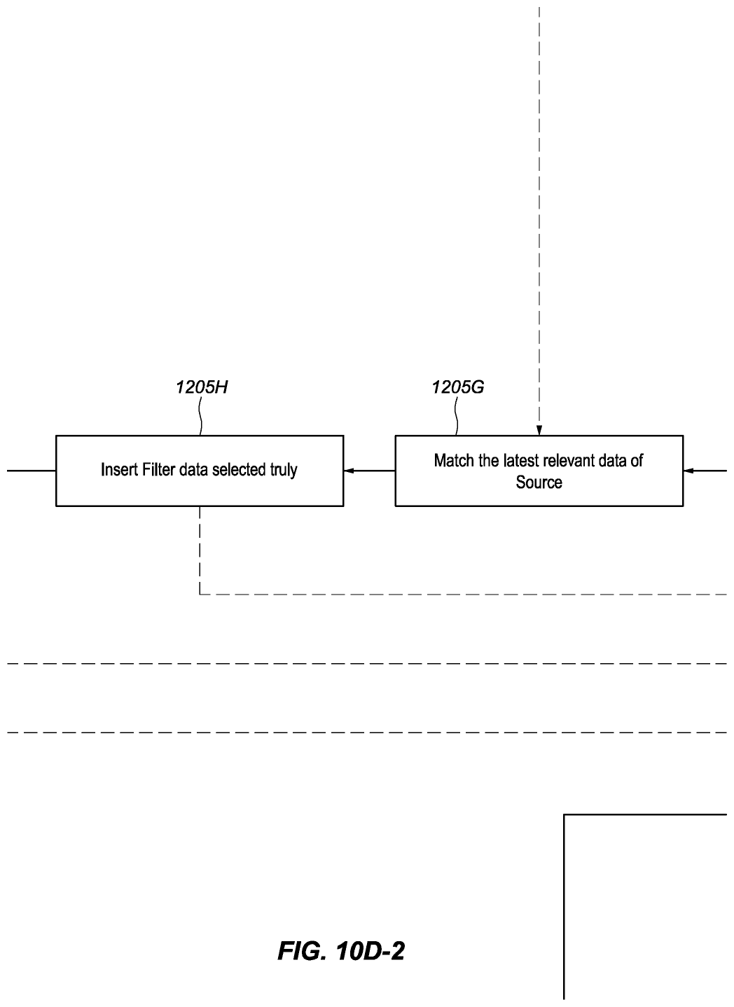

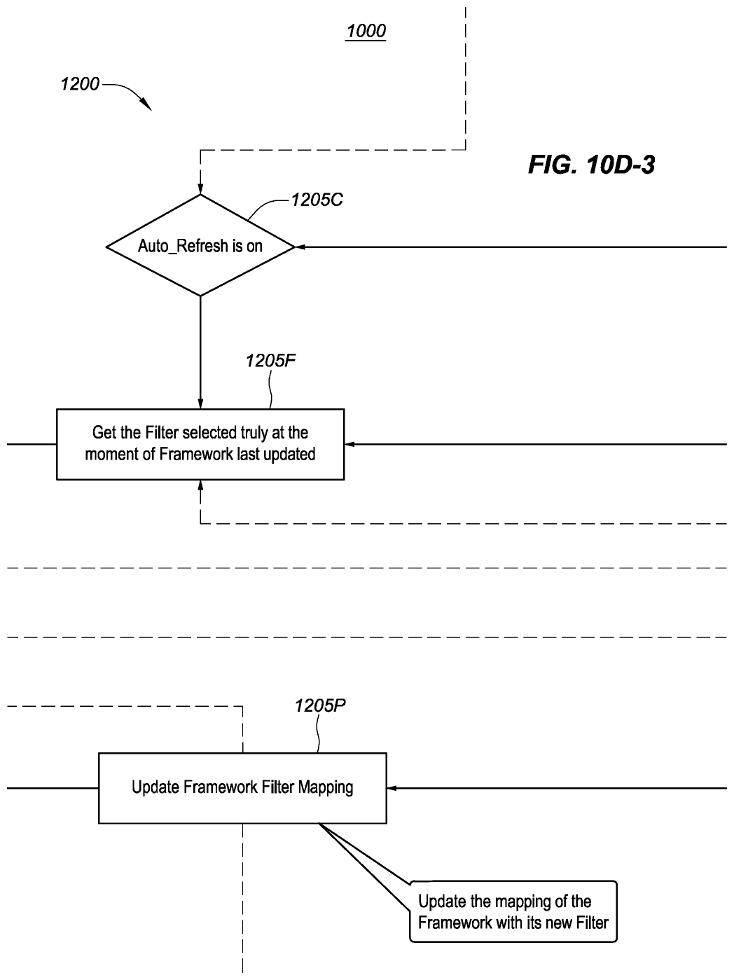

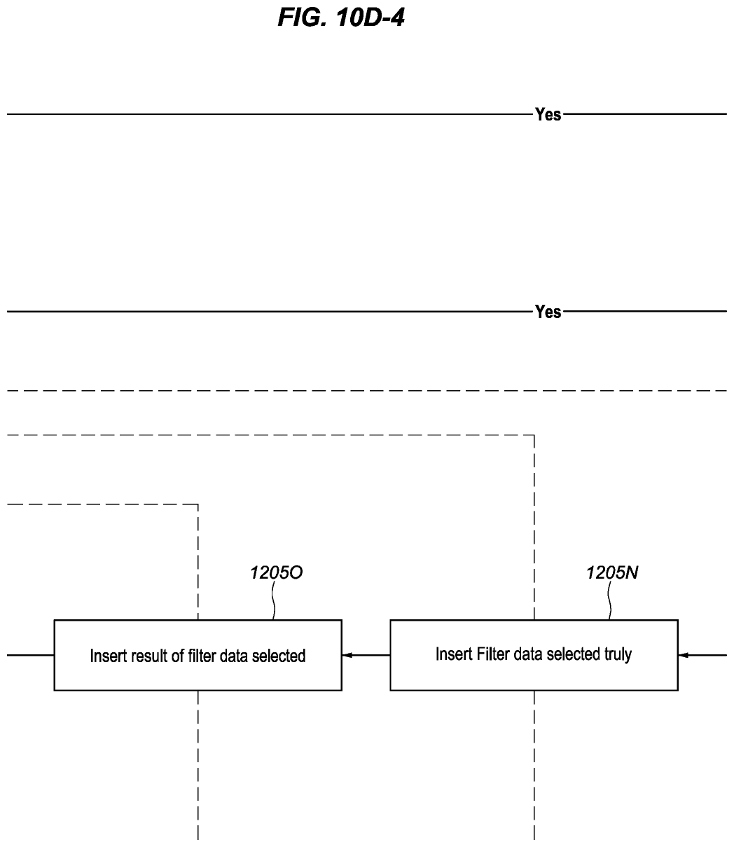

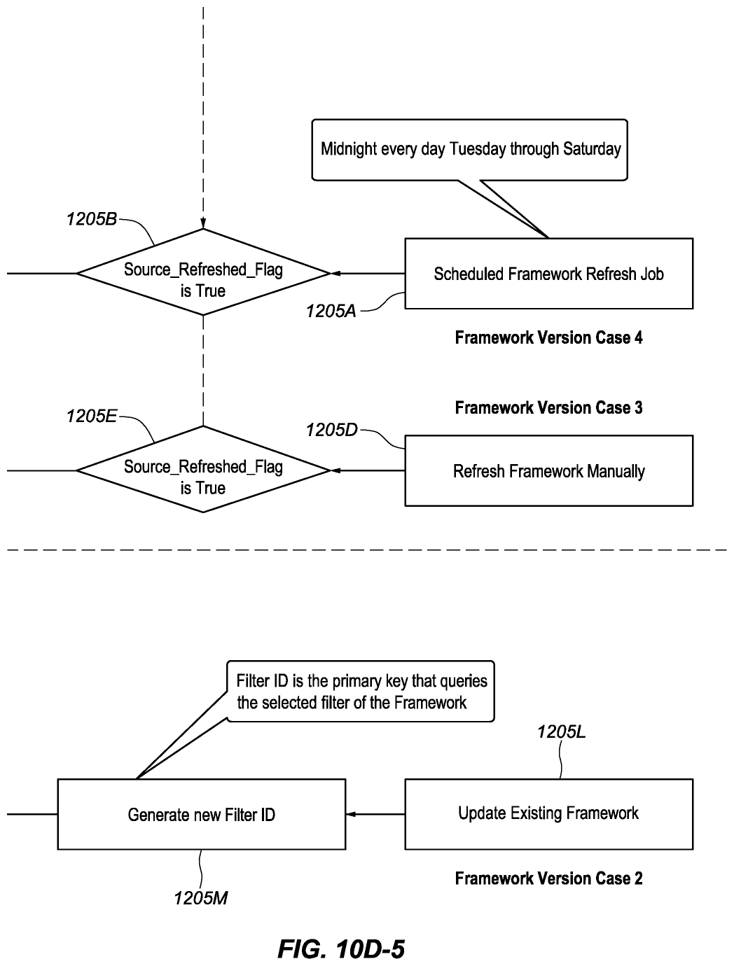

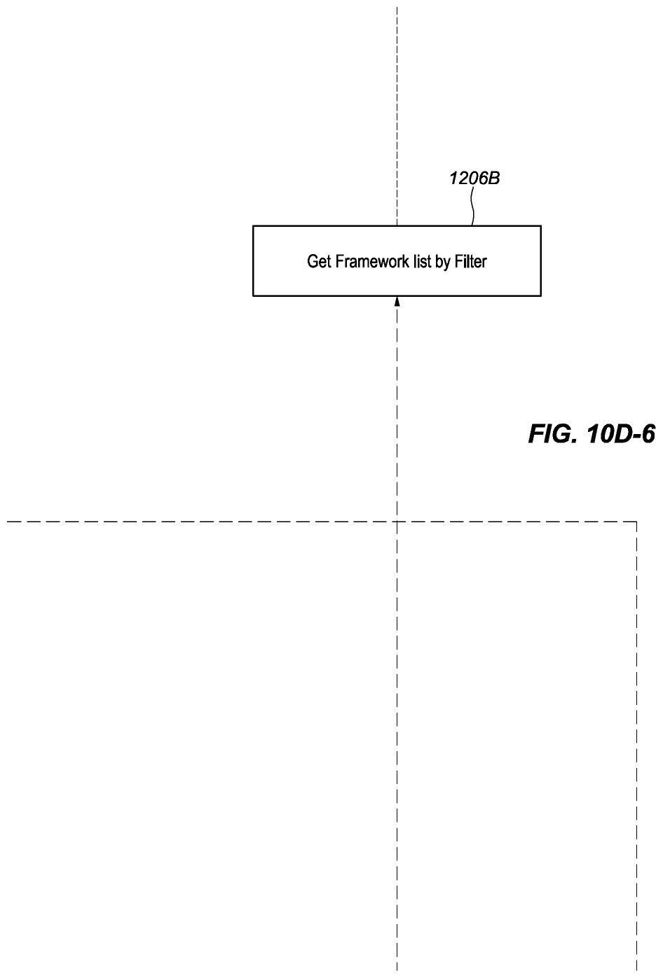

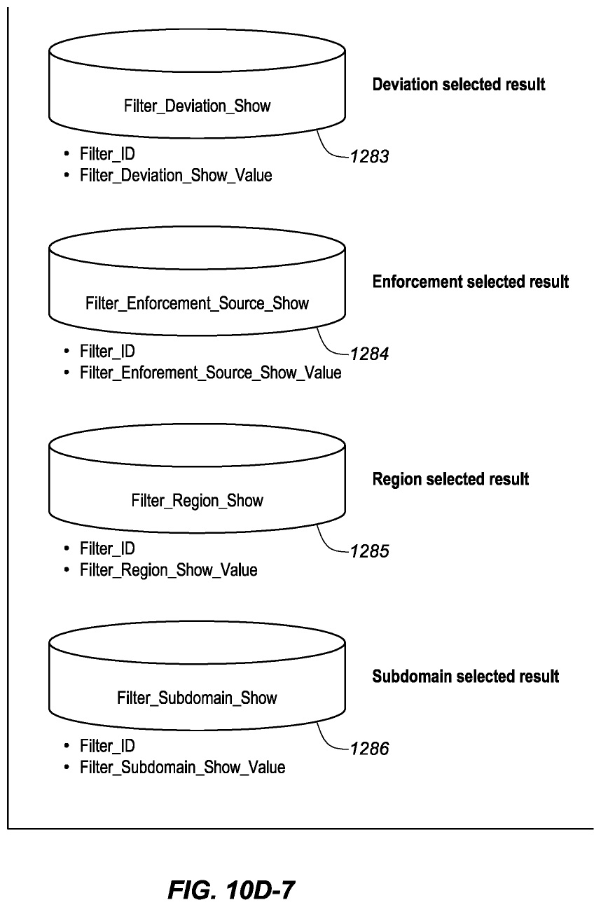

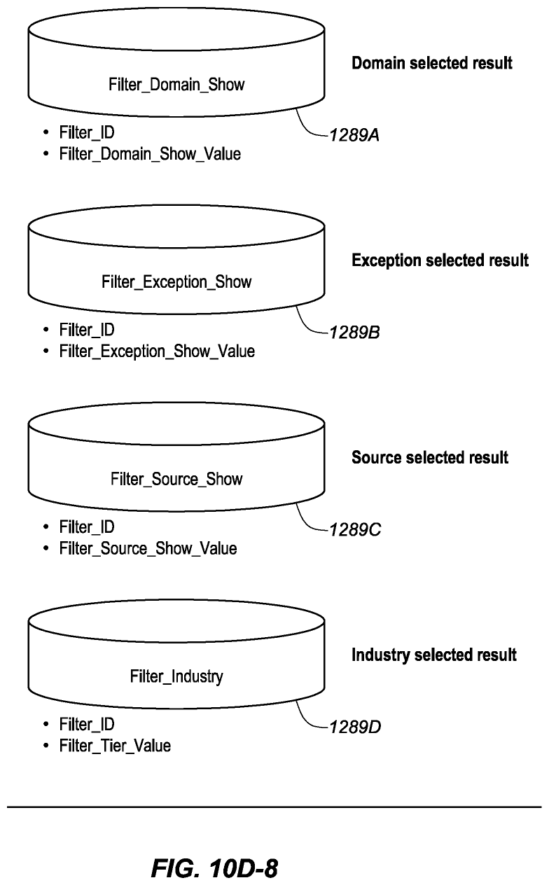

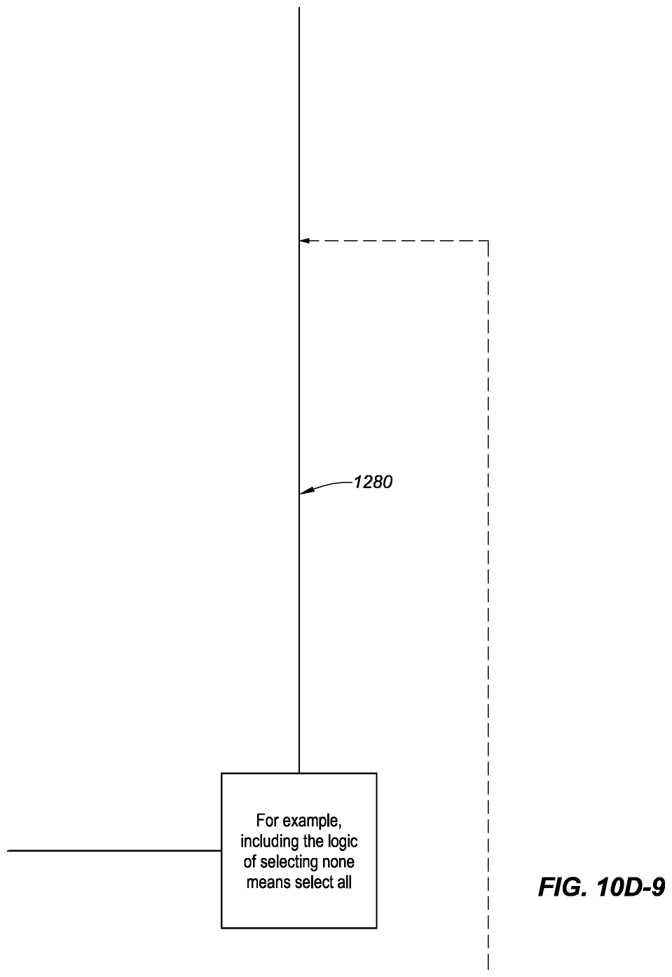

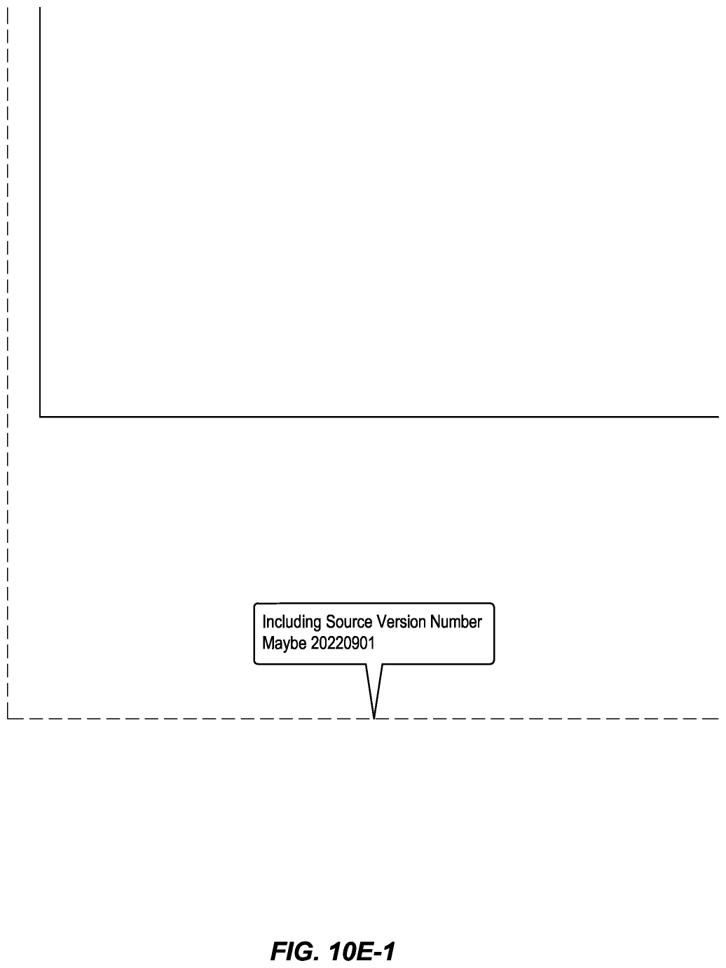

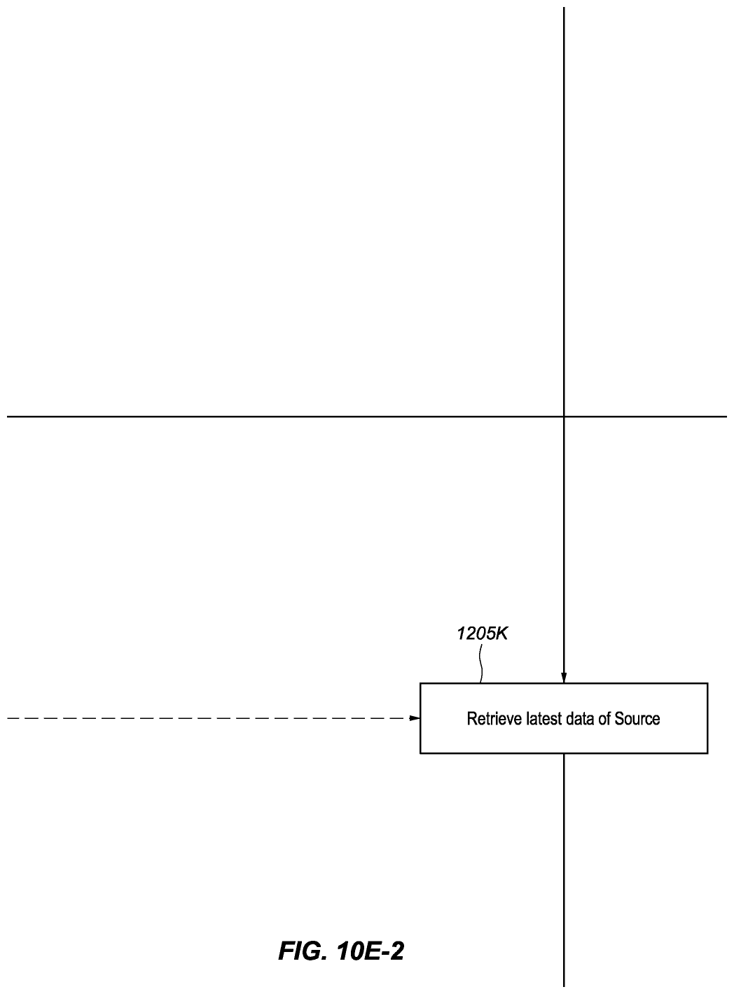

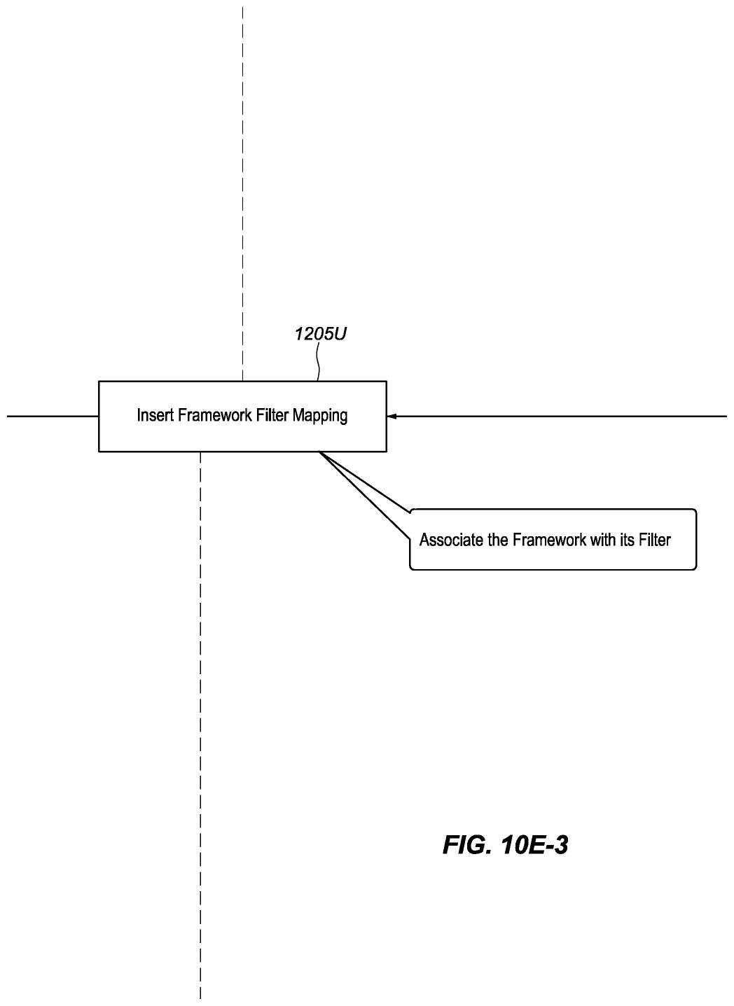

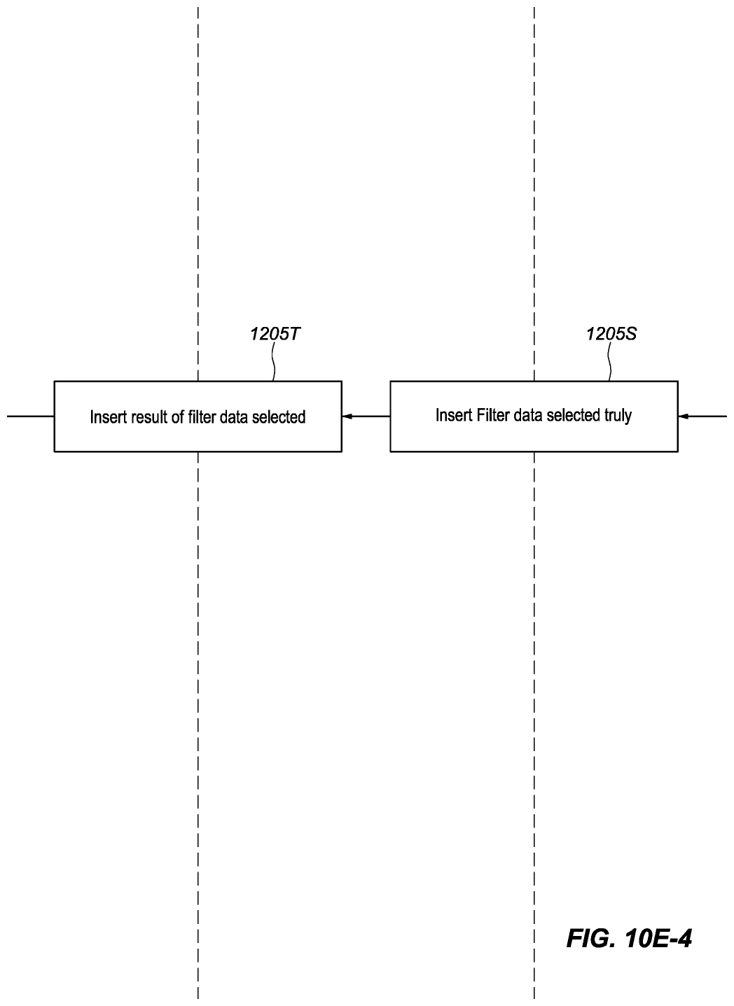

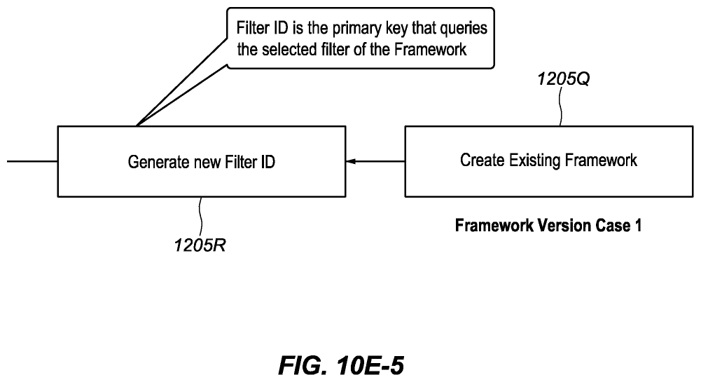

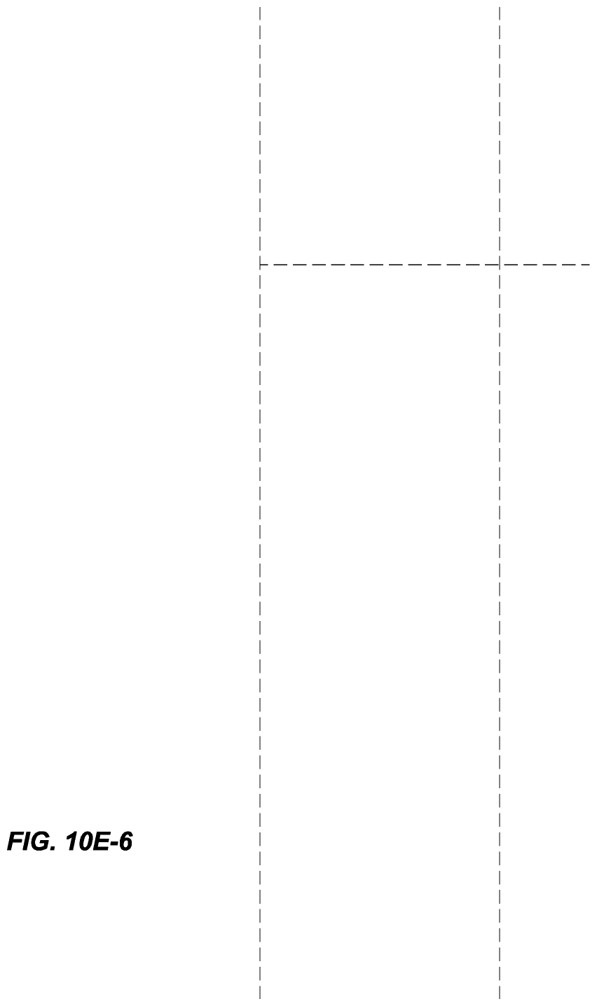

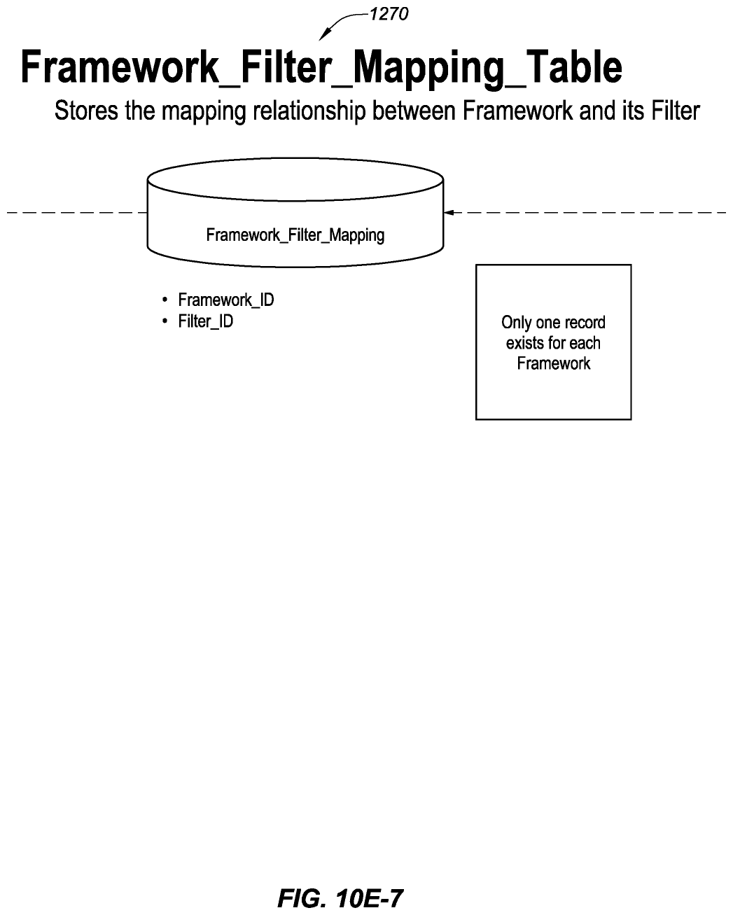

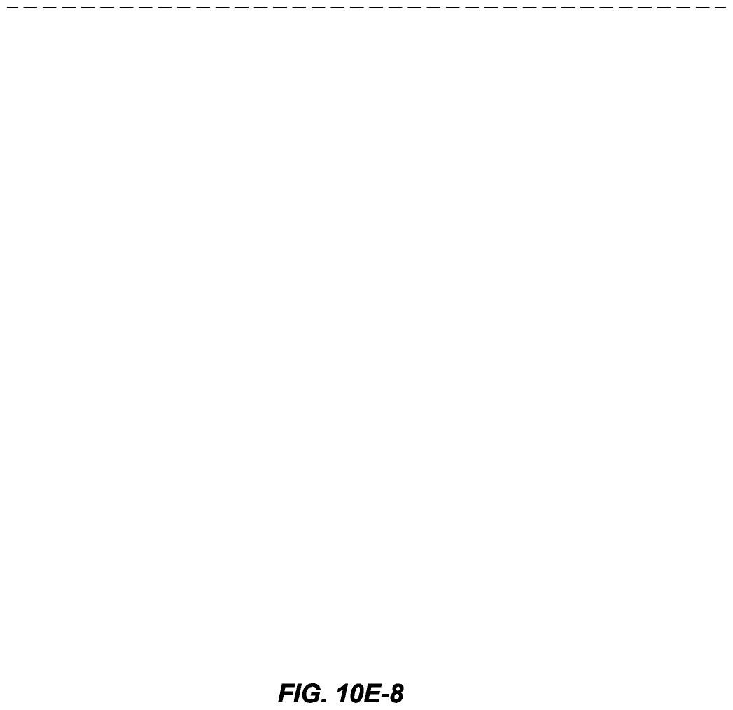

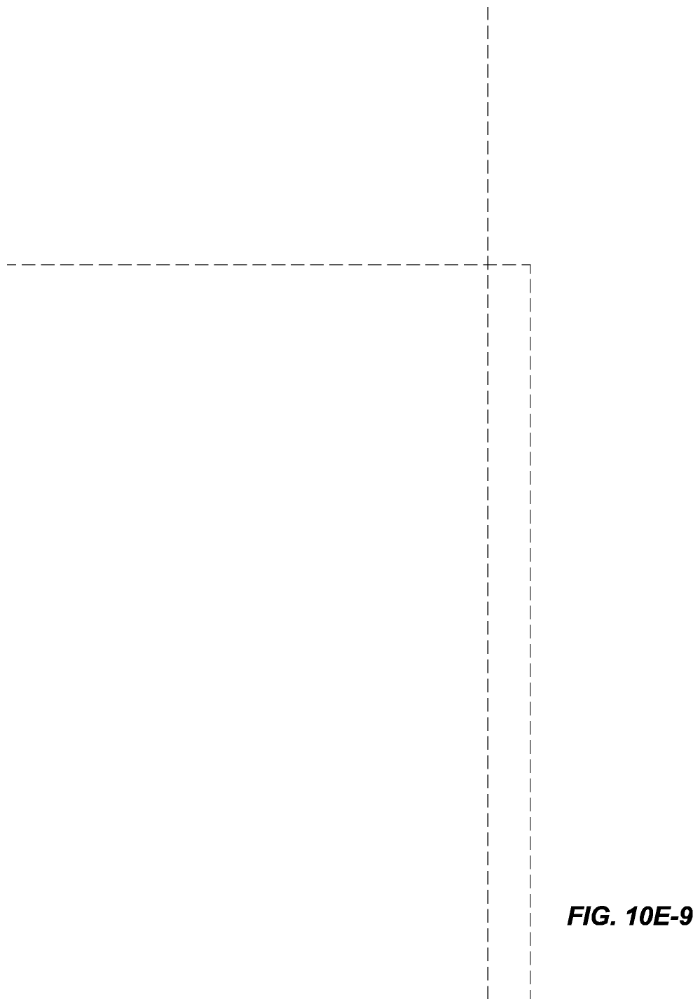

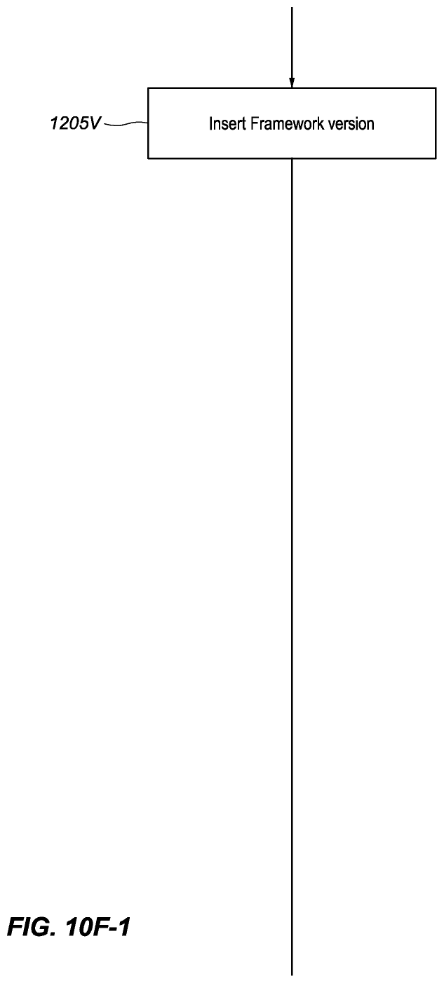

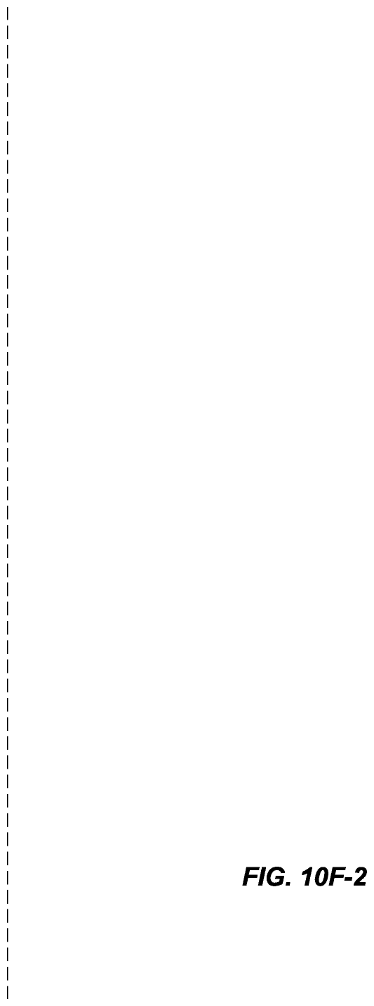

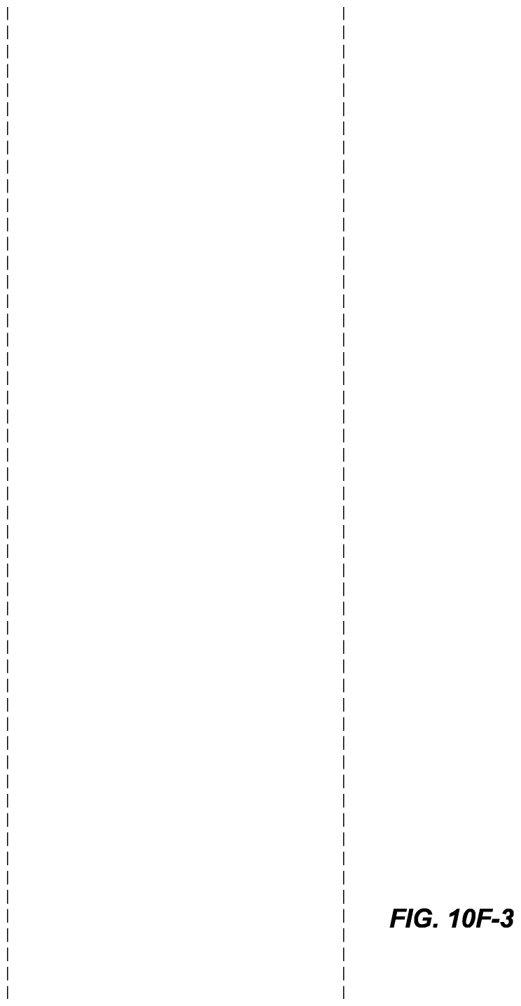

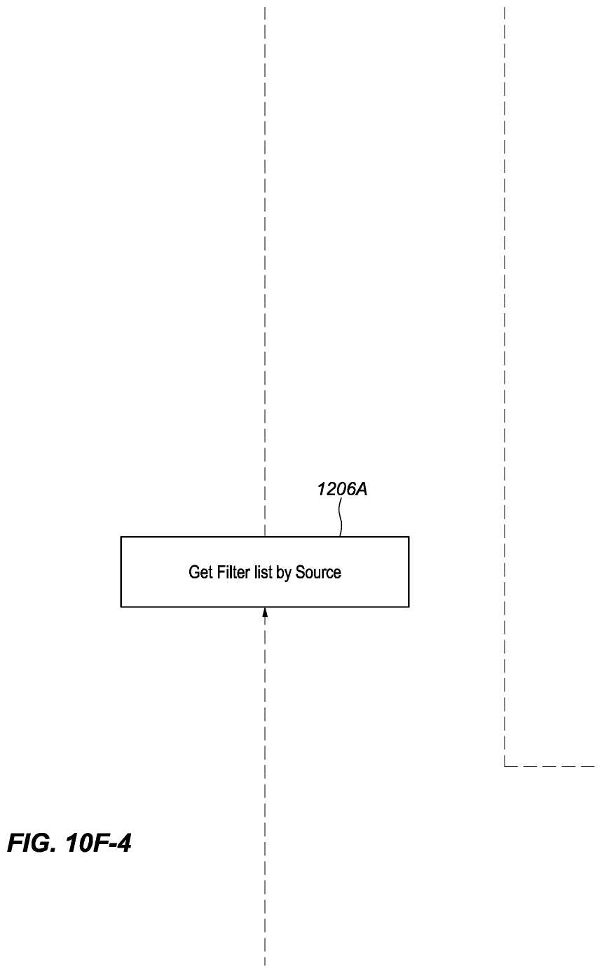

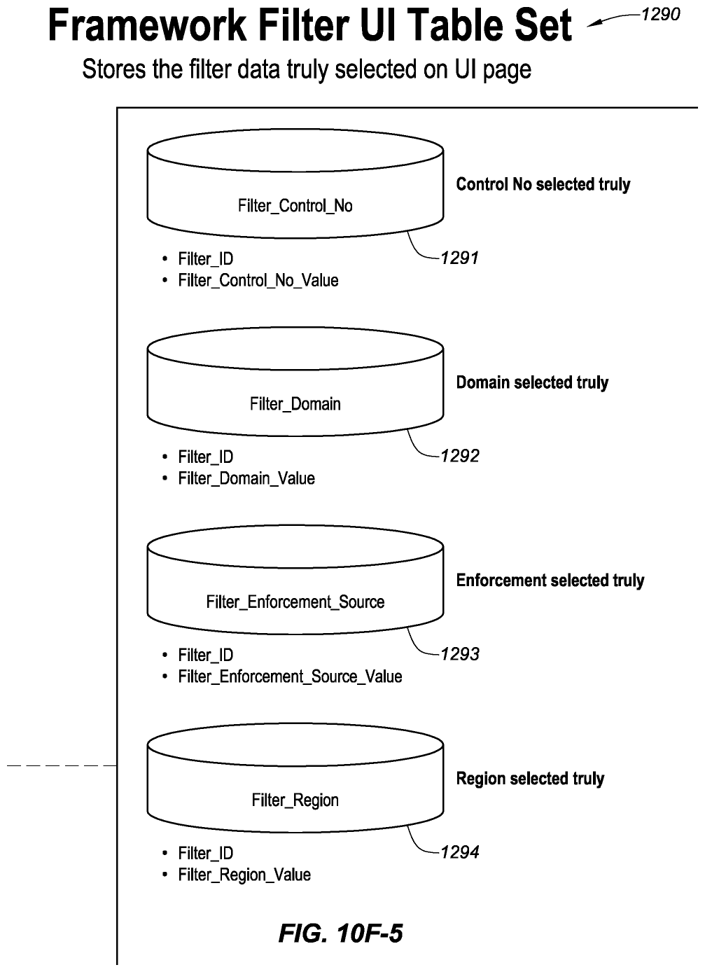

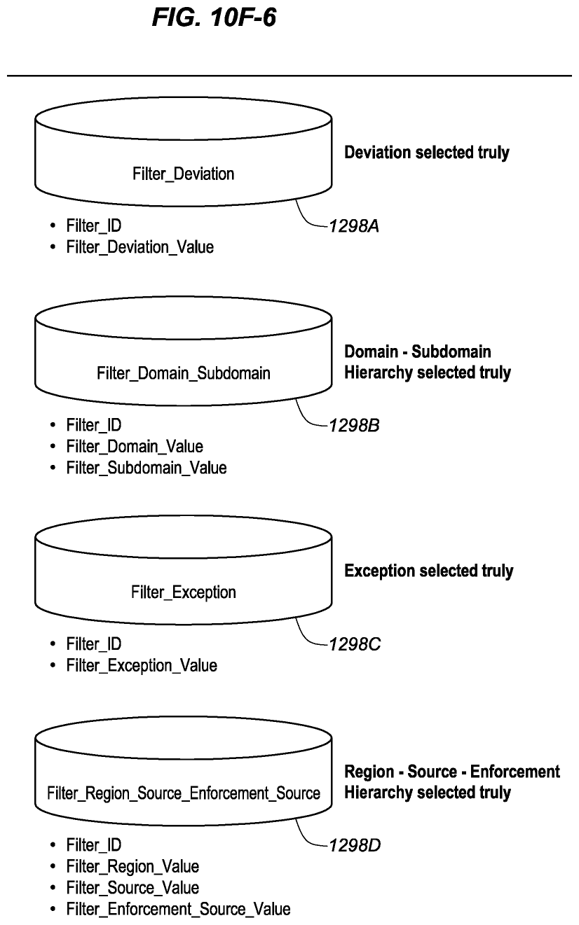

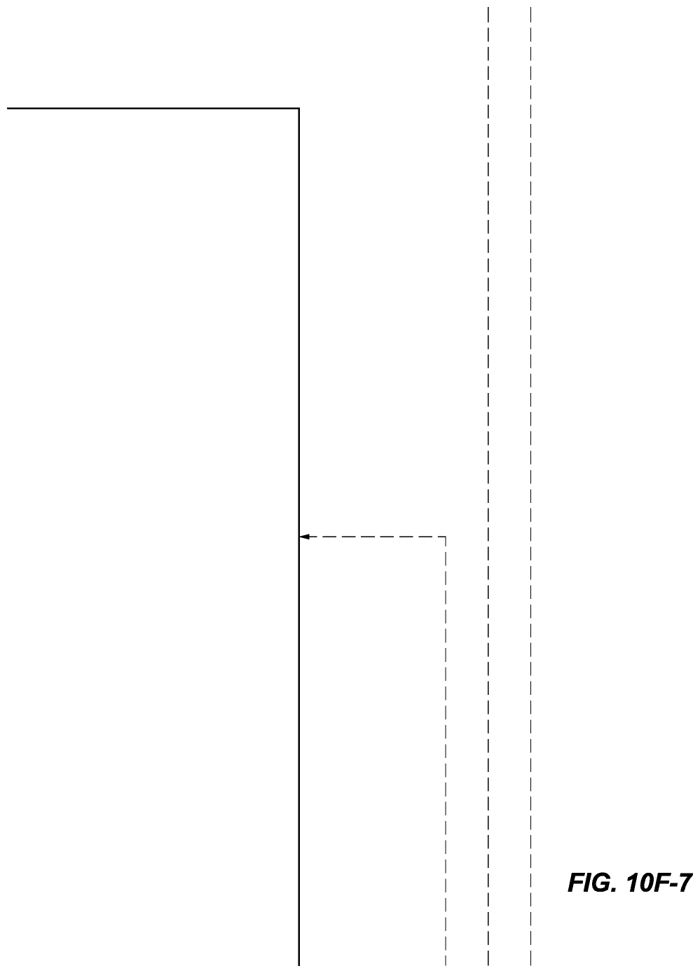

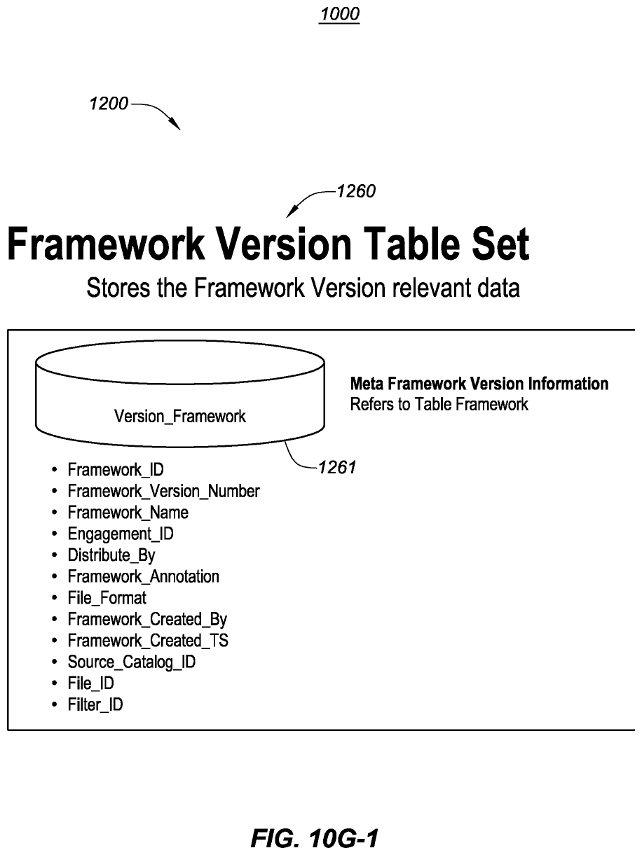

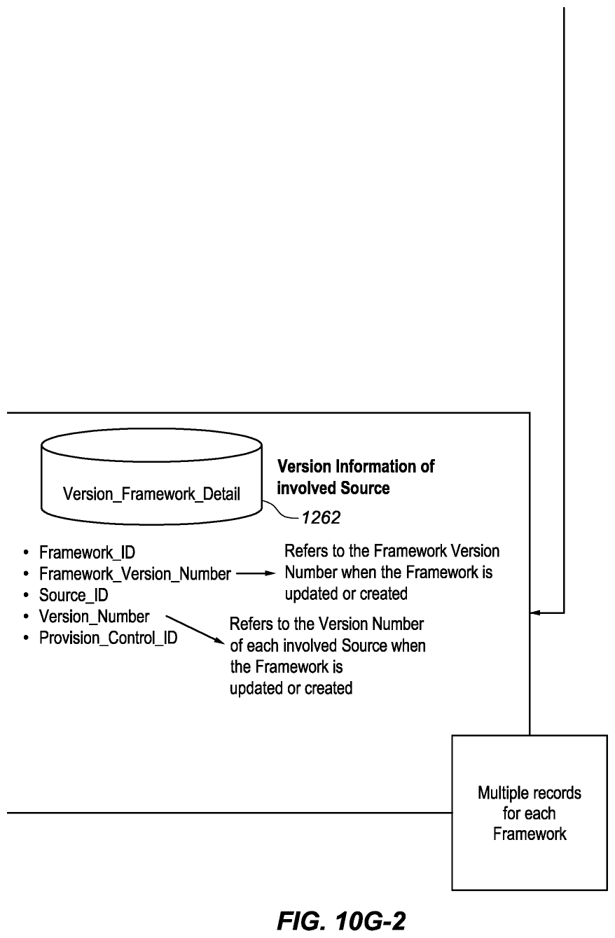

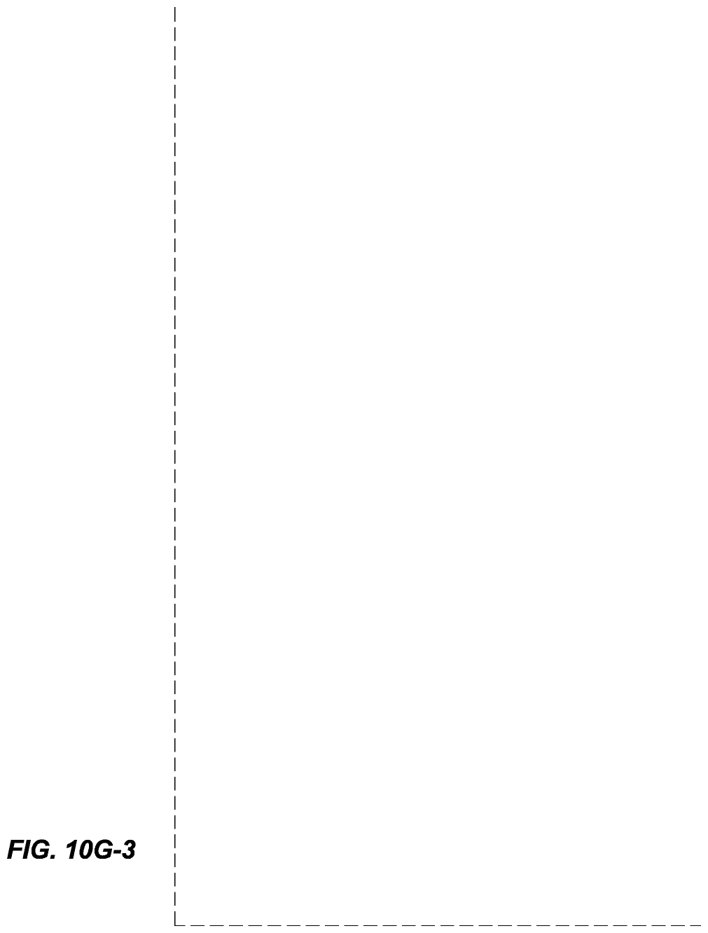

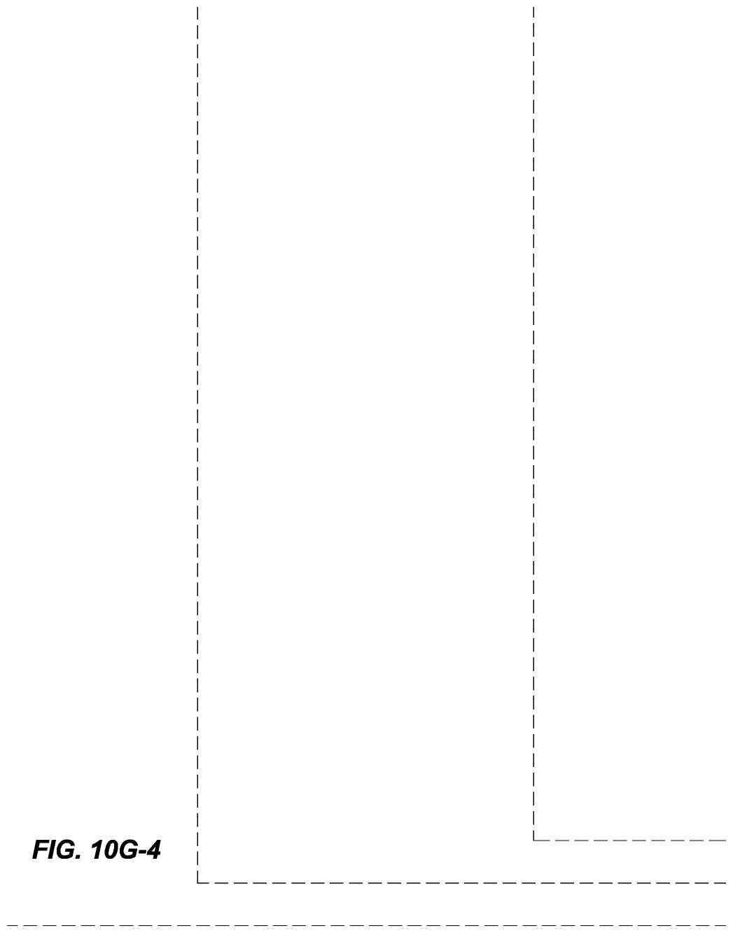

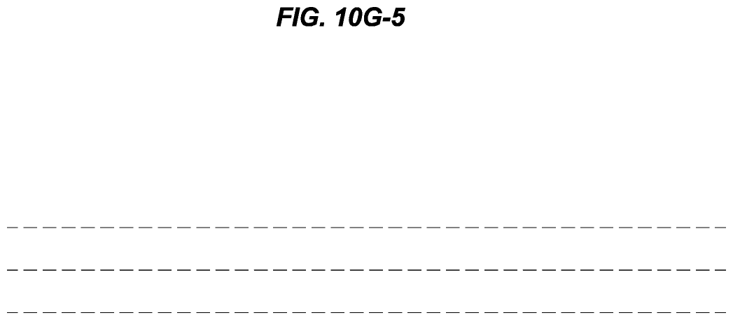

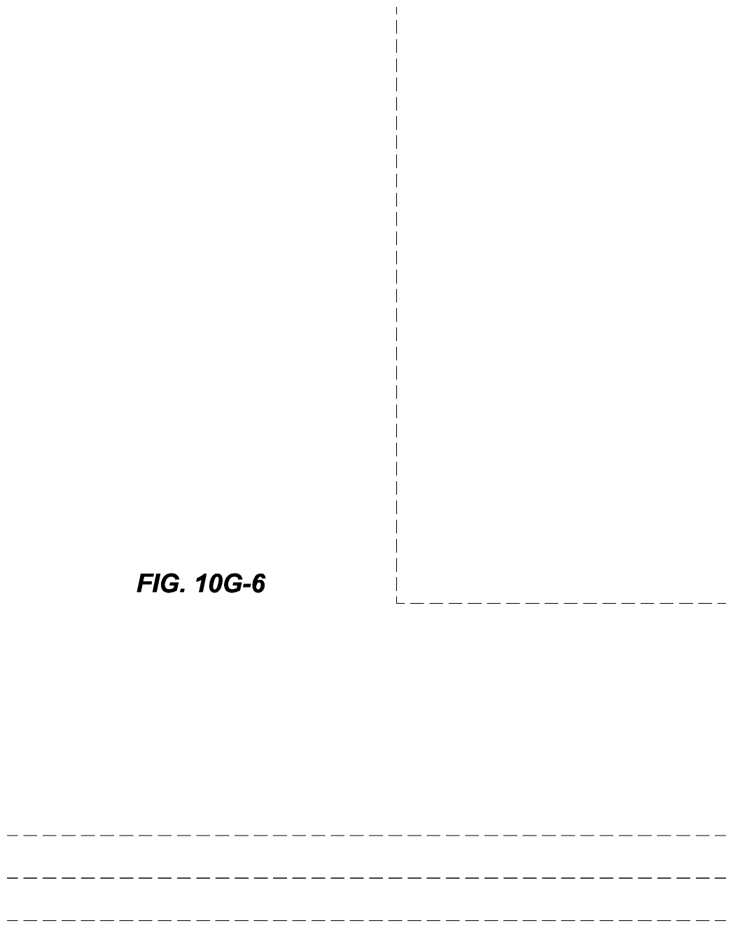

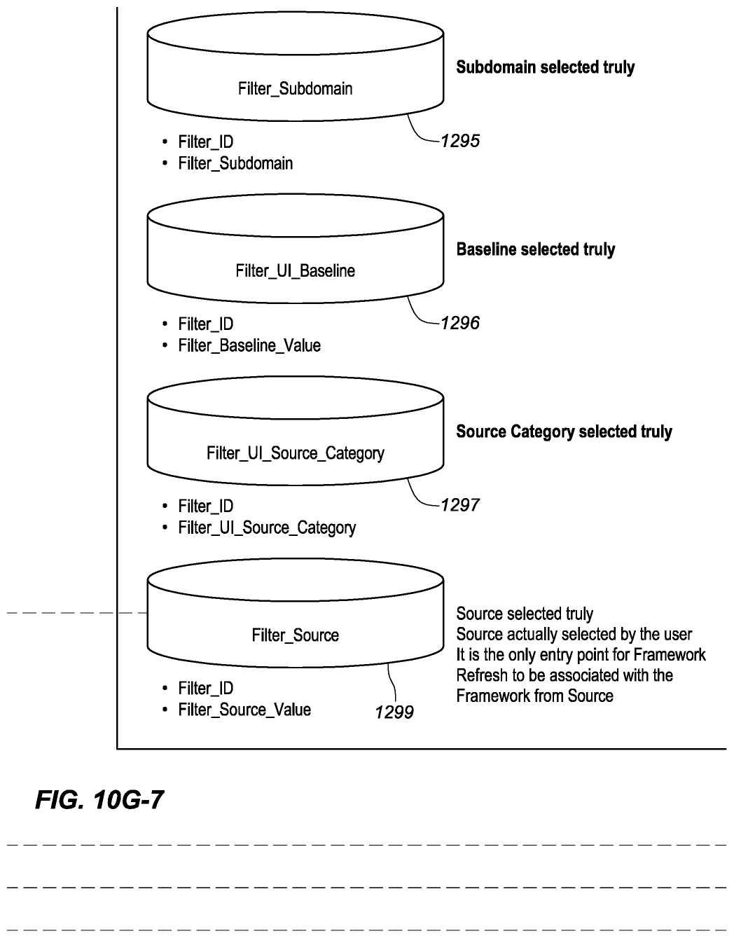

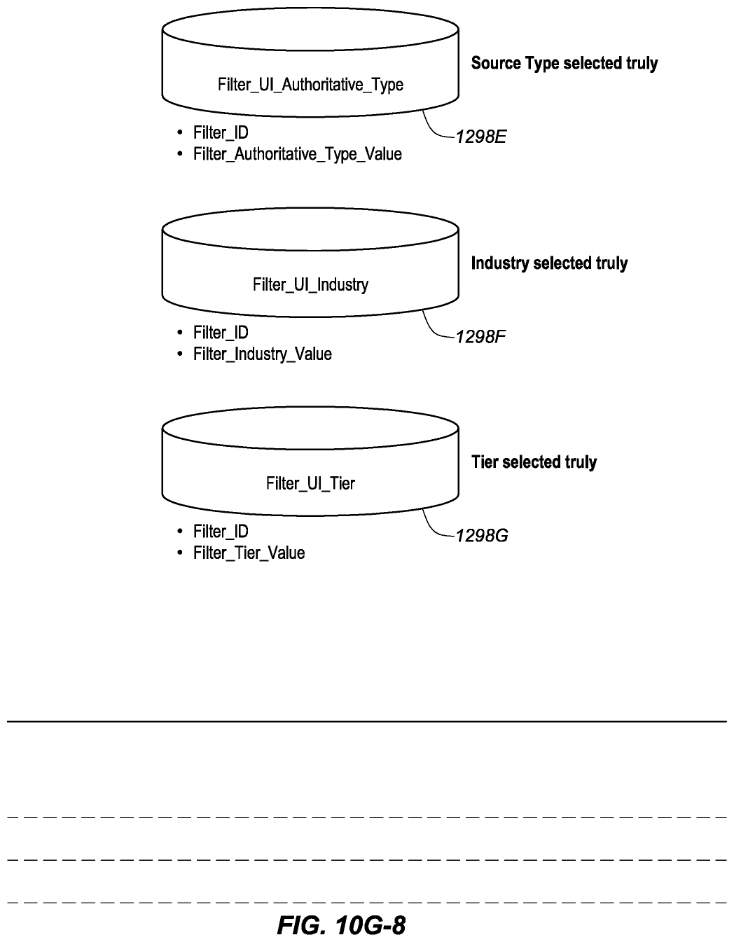

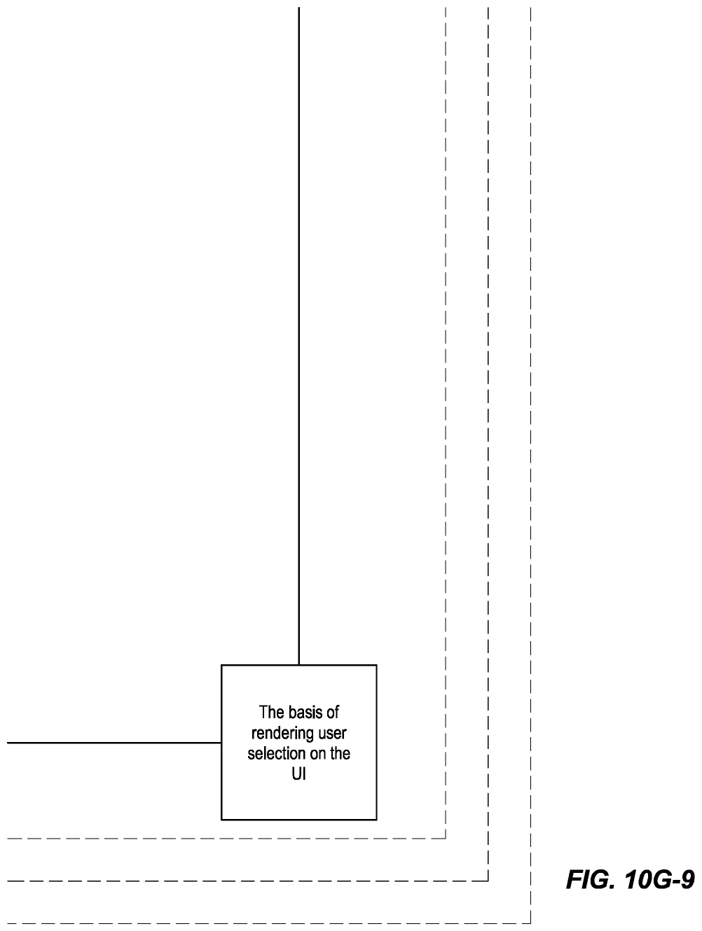

The database versioning can be performed in any suitable manner. An exemplary method for updating source library, at 1200, and otherwise performing database versioning is illustrated in FIG. 10. Turning to in FIG. 10, the method 1200 for performing database versioning is shown as including, at 1210, storing the current (or latest) versions of the source regulations in a source table set. The source table set, at 1210, preferably stores one record for each source regulation. As shown in FIG. 10, storing the current version of a relevant source regulation, at 1210, can include storing metadata information, at 1211, storing business process information, at 1212, storing industry information, at 1213, storing source link information, at 1214, storing modification information, at 1215, storing provision information, at 1216 and/or storing provision control information, at 1217.

Storing the metadata information, at 1211, is shown in FIG. 10 as including, but not limited to, storing source identifier information, version number information, short title information, long title information, region identifier information, summary information, a source updated by information, file name information, file identifier information, key requirement information, commercial purpose flag information, enacted information, enforced information, amended information, foreign source title information, baseline information, jurisdiction category information, industry band information, tier information, status information, source category identifier information, source translation status identifier information, translation due date information, translation completed information, page count information, translation category information and/or source updated time information for the relevant source regulation.

As illustrated in FIG. 10, storing the business process information, at 1212, can include storing identification information, source identification information, and/or business process identification information, without limitation, for the relevant source regulation; whereas, storing the industry information, at 1213, can include storing type identification information, source identification information and/or industry identification information, without limitation, for the relevant source regulation. Storing the source link information, at 1214, can include, but is not limited to, storing type identification information, source identification information, source link information and/or notes information for the relevant source regulation.

Storing the modification information, at 1215, can include, but is not limited to storing source identification information, modification type identification information, modification level justification information, referenced source identification information and/or source level justification information for the relevant source regulation. Storing the provision information, at 1216, for example, can include storing source identification information, provision identification information, provisional clause information and/or row number information, without limitation, for the relevant source regulation, and/or storing the provision control information, at 1217, can include, but is not limited to, storing provision control identification information, source identification information, provision identification information, control number information, deviation information and/or exception information for the relevant source regulation.

As shown in FIG. 10, the method 1200 can include retrieving the latest data for the relevant source regulation, at 1201A, and/or filing a work request as initial data, at 1201B. The work request can be provided for source mapping, at 1220. Providing the work request, at 1220, can include creating a new source data entry for a new data source system 300, at 1221, and/or updating an existing source data entry for an existing data source system 300, at 1222. In selected embodiments, providing the work request, at 1220, optionally can include deactivating an existing source data entry for an inactive data source system 300, at 1223, reactivating a deactivated source data entry for a reactivated data source system 300, at 1224, and/or deleting an existing source data entry for a deleted data source system 300, at 1225.

The created, updated, deactivated, reactivated and/or deleted source data entry can be further processed prior to submission. At 1226, for example, the created source data entry can be filled in with new data source system information and/or the updated source data entry can be filled in with changed data source system information. The created, updated, deactivated, reactivated and/or deleted source data entry can be submitted, at 1227. The method 1200, at 1202, can include updating request data of the relevant data source system 300.

The current (or latest) source data for the data source system 300 associated with the work request can be stored, at 1230, in a work request table set. The work request table set, at 1230, preferably stores one record for each work request. As shown in FIG. 10, storing the current source data for a relevant work request, at 1230, can include storing metadata request information, at 1231, storing business process request information, at 1232, storing industry request information, at 1233, storing source link request information, at 1234, storing modification request information, at 1235, and/or storing provision control request information, at 1236.

Storing the metadata request information, at 1231, is shown in FIG. 10 as including, but not limited to, storing work request identification information, authorization source name information, short title information, foreign source title information, region identification information, enforced information, enacted information, amended information, baseline information, tier information, industry band information, jurisdiction category information, source category identification information, source translation status identification information, translation due date information, translation completed information, file name information and/or file identification information, without limitation, for the relevant work request.

As illustrated in FIG. 10, storing the business process request information, at 1232, can include storing work request identification information and/or business process identification information, without limitation, for the relevant work request; whereas, storing the industry request information, at 1233, can include storing work request identification information and/or industry identification information, without limitation, for the relevant work request. Storing the source link request information, at 1234, can include, but is not limited to, storing work request identification information, source link information and/or notes information for the relevant work request.

Storing the modification request information, at 1235, can include, but is not limited to storing work request identification information, source identification information, modification type identification information, modification level justification information, referenced source identification information and/or source level justification information for the relevant work request. Storing the provision control request information, at 1236, can include storing work request identification information, provisional row number information, provisional clause information, control number information, deviation information, exception information, provision identification information and/or provision control identification information for the relevant work request, without limitation.

FIG. 10 illustrates that the work request can be finalized, at 1203A. At 1203B, the source data for the data source system 300 associated with the work request can be retrieved, and the latest source data for the data source system 300 associated with the work request can be updated, at 1203C. A latest (or relevant) version of the source data for one or more selected data source systems 300 can be retrieved, at 1204A. A version number for the source data of each selected data source system 300 can be generated, at 1204B, and version data for the selected data source system 300 can be inserted, at 1024C.

The relevant version of the source data for the selected data source systems 300 can be stored, at 1240, as a source version table set. The source version table set, at 1240, preferably stores one record for each of the selected data source systems 300. As shown in FIG. 10, storing the relevant version of the source data for the selected data source systems 300, at 1240, can include storing metadata version information, at 1241, storing business process version information, at 1242, storing industry version information, at 1243, storing source link version information, at 1244, storing modification version information, at 1245, storing provision version information, at 1246, and/or storing provision control version information, at 1247.

Storing the metadata version information, at 1241, is shown in FIG. 10 as including, but not limited to, storing a source identification information, version number information, source updated time information, short title nfo ation, long title information, region identification information, summary information, source updated by information, file name information, file identification information, key requirements information, commercial purpose flag information, enacted information, enforced information, amended information, foreign source file information, baseline information, jurisdiction category information, industry band information, tier nformation, status information, source category identification information,source translation status identification information, translation due date information, translation completed information, page count information, and/or translation category information, without limitation, for the selected data source system 300.

As illustrated in FIG. 10, storing the business process version information, at 1242, can include storing type identification information, source identification information, version number information and/or business process identification information, without limitation, for the selected data source system 300; whereas, storing the industry version information, at 1243, can include storing type identification information, source identification information, version number information and/or industry identification information, without limitation, for the selected data source system 300. Storing the source link version information, at 1244, can include, but is not limited to, storing type identification information, source identification information, version number information, source link information and/or notes information for the selected data source system 300.

Storing the modification version information, at 1245, can include, but is not limited to storing source identification information, version number information, modification type identification information, modification level justification information, referenced source identification information and/or source level justification information for the selected data source system 300. Storing the provision version information, at 1246, for example, can include storing source identification information, version number information, provision identification information, provisional clause information and/or row number information, without limitation, for the selected data source system 300, and/or storing the provision control version information, at 1247, can include, but is not limited to, storing provision control identification information, source identification information, version number information, provision identification information, control number information, deviation information and/or exception information for the selected data source system 300.

A version number can be generated for the source data of each selected data source system 300 can be generated, at 1204D, and/or each selected data source system 300 can be checked against the related control framework, at 1204E. At 1204F, a source refreshed flag for each selected data source system 300 can be updated to a true state. As shown in FIG. 10, basic information for the control frameworks can be stored, at 1250, in a framework table. The framework table, at 1250, preferably stores one record for each control framework. Storing the basic information for the control framework, at 1250, can include, but is not limited to, storing framework identification information, framework updated time information, framework name information, framework updated by information, framework annotation information, framework file format information, framework created by information and/or framework source catalogue information for the relevant control framework.

Additionally and/or alternatively, storing framework identification information, at 1250, can include setting a source refreshed flag for indicating whether the relevant control framework can be refreshed because one or more selected data source systems 300 associated with the control framework has been updated and/or setting an auto-refresh flag for indicating whether the control frame work can be automatically refreshed when downloaded and/or during a scheduled control framework refresh job. The source refreshed flag and the auto-refresh flag preferably default to an off or false value.

In selected embodiments, a framework refresh job can be scheduled for the relevant control framework, at 1205A. The framework refresh job, for example, can be scheduled to be performed once or repeatedly at a predetermined day and time. If the source refreshed flag is set, at 1205B, and the auto-refresh flag is set, at 12050, a framework filter selected at the moment that the relevant control framework was last updated can be retrieved, at 1205F. The relevant control framework optionally can be manually refreshed, at 1205D. If the source refreshed flag is set, at 1205E, the framework filter likewise selected at the moment that the relevant control framework was last updated can be retrieved, at 1205F.

The latest relevant source data of a selected data source system 300 can be matched, at 1205G. At 1205H, selected filter data can be inserted; whereas, at least one result of the selected filter data can be inserted, at 12051. The framework filter mapping for the relevant control framework can be updated, at 1205:1. At 1205K, the latest relevant source data of the selected data source system 300 associated with the relevant control framework can be retrieved.

As illustrated in FIG. 10, an existing control framework can be updated at 1205L. New filter identification information for the existing control framework can be created, at 1205M. At 1205N, selected filter data can be inserted based upon the new filter identification information; whereas, at least one result of the selected filter data can be inserted, at 12050. The framework filter mapping for the existing control framework can be updated, at 1205P. In other words, the mapping of the control framework, at 1205P, can be updated with the new filter. At 1205K, the latest relevant source data of the selected data source system 300 associated with the existing control framework can be retrieved.

Additionally and/or alternatively, a new control framework can be created at 1205Q, and new filter identification information for the new control framework can be created, at 1205R. At 1205S, selected filter data can be inserted based upon the new filter identification information; whereas, at least one result of the selected filter data can be inserted, at 1205T. The framework filter mapping for the new control framework can be inserted, at 1205U. Stated somewhat differently, the control framework, at 1205U, can be associated with the new filter. At 1205K, the latest relevant source data of the selected data source system 300 associated with the new control framework can be retrieved.

Once the latest relevant source data of the selected data source system 300 has been retrieved, the control framework version can be inserted, at 1205V. The relevant data of the control framework version can be stored, at 1260, in a framework version table set. The framework version table set, at 1260, preferably stores a plurality of records for each control framework. Storing the relevant data of the control framework version, at 1260, can include, but is not limited to, storing meta framework version information, at 1261, and/or storing version information of one or more involved data source systems 300, at 1262.

The stored meta framework version information, at 1261, can comprise framework identification information, framework version number information, framework name information, engagement identification information, distribute by information, framework annotation information, file formal information, framework created by information, framework created time information, source catalog identification information, file identification information and/or filter identification information, without limitation, for the control framework version. At 1262 the version information can include framework identification information, framework version number information, source identification information, version number information and/or provisional control identification information for the involved data source systems 300, without limitation.

A mapping relationship between a selected control framework and a filter associated with the selected control framework can be stored, at 1270, in a framework filter mapping table. The framework filter mapping table, at 1270, preferably stores one record for each of the control frameworks. As shown in FIG. 10, storing the mapping relationship can include, but is not limited to, storing framework identification information and/or filter identification information.

Filter data selected by the user 210 (shown in FIG. 16) via the global privacy and data protection framework method 1000 can be stored, at 1290, in a framework filter user interface (or UI) table set. As illustrated in FIG. 10, storing the selected filter data can include, but is not limited to, storing control number selected information, at 1291, domain selected information, at 1292, enforcement selected information, at 1293, region selected information, at 1294, subdomain selected information, at 1295, baseline selected information, at 1296, source category selected information, at 1297, deviation selected information, at 1298A, domain-subdomain hierarchy selected information, at 1298B, exception selected information, at 1298C, region-source enforcement hierarchy selected information, at 1298D, source type selected information, at 1298E, industry selected information, at 1298F, tier selected information, at 1298G, and/or source selected information, at 1299, for the selected control framework.

The control number selected information, at 1291, can comprise filter identification information and/or filter control number value information, without limitation. The domain selected information, at 1292, can include filter identification information and/or filter domain value information, without limitation, and/or the enforcement selected information, at 1293, can include filter identification information and/or filter enforcement source value information, without limitation. At 1294, the region selected information can include, but is not limited to, filter identification information and/or filter region value information; whereas, the subdomain selected information can include, but is not limited to, filter identification information and/or filter subdomain information, at 1285. The baseline selected information, at 1296, can include filter identification information and/or filter baseline value information, and/or the source category selected information, at 1297, can include filter identification information and/or filter user interface source category information, without limitation.

Additionally and/or alternatively, the deviation selected information, at 1298A, can include filter identification information and/or filter deviation value information, without limitation, and/or the domain-subdomain hierarchy selected information, at 1298B, can include filter identification information, filter domain value information and/or filter subdomain information, without limitation. The exception selected information, at 1298C, can comprise filter identification information and/or filter exception value information, without limitation. At 1298D, the region-source enforcement hierarchy selected information can include, but is not limited to, filter identification information, filter region value information, filter source value information, and/or filter enforcement source value information; whereas, the source type selected information can include, but is not limited to, filter identification information and/or filter authoritative type information, at 1298E.

The industry selected information, at 1298F, can include filter identification information and/or filter industry value information, without limitation. At 1298G, the tier selected information can include, but is not limited to, filter identification information and/or filter tier value information, and/or the source selected information can include, but is not limited to, filter identification information and/or filter source value information, at 1299. The source selected information, at 1299, can comprise an external data source system 300 that is selected by the user 210. In selected embodiments, the data source system 300 that is selected by the user 210 can be the only entry point for the framework refresh that is associated with the control framework from the data source system 300.

A result of the filter data selected by the user 210 can be stored, at 1270, in a framework filter show table set. As shown in FIG. 10, storing the result of the selected filter data can include, but is not limited to, storing source type selected result information, at 1281, business process selected result information, at 1282, deviation selected result information, at 1283, enforcement selected result information, at 1284, region selected result information, at 1285, subdomain selected result information, at 1286, baseline selected result information, at 1287, control number selected result information, at 1288, domain selected result information, at 1289A, exception selected result information, at 1289B, source selected result information, at 1289C, and/or industry selected result information, at 1289D.

The source type selected result information, at 1281, can comprise filter identification information and/or filter authoritative type value information, without limitation. The business process selected result information, at 1282, can include filter identification information and/or filter business process value information, without limitation, and/or the deviation selected result information, at 1283, can include filter identification information and/or filter deviation show value information, without limitation. At 1284, the enforcement selected result information can include, but is not limited to, filter identification information and/or filter enforcement source show value information; whereas, the enforcement selected result information can include, but is not limited to, filter identification information and/or filter region source show value information, at 1285. The subdomain selected result information, at 1286, can include filter identification information and/or filter subdomain show value information, without limitation.

Additionally and/or alternatively, the baseline selected result information, at 1287, can include filter identification information and/or filter baseline value information, without limitation, and/or the control number selected result information, at 1288, can include filter identification information and/or filter control number show value information, without limitation. The domain selected result information, at 1289A, can comprise filter identification information and/or filter domain show value information, without limitation. At 1289B, the exception selected result information can include, but is not limited to, filter identification information and/or filter exception show value information; whereas, the source selected result information can include, but is not limited to, filter identification information and/or filter source show value information, at 1289C. The industry selected result information, at 1289D, can include filter identification information and/or filter tier value information. A filter list by data source system 300 can be retrieved, at 1206A; whereas, a framework list by filter can be retrieved, at 1206B.

In the manner discussed above with reference to FIG. 1, the global privacy and data protection framework method 1000 can generate, at 1300, one or more reports based upon the received current source data. The global privacy and data protection framework method 1000, in selected embodiments, can compare versions of the source data and other stored data objects for a selected regulation and can identify one or more changes in the selected regulation over time. The changes in the selected regulation can include, but are not limited to, metadata, such as an amendment date of the source data, and control mappings. An exemplary control mapping can comprise a determination that some text in the selected regulation corresponds to a control objective for risk management.

For example, the global privacy and data protection framework method 1000 can receive a query from the user 210 (shown in FIG. 16) about a regulation. The global privacy and data protection framework method 1000 can identify a historic version of the control framework within a date range specified by the user query and compare the historic control framework version with a current (or latest) version of the control framework. The comparison can help identify one or more new data source systems 300, one or more removed data source systems 300 and/or one or more changed data source systems 300 in the control framework that provided source data to the global privacy and data protection framework method 1000 and the respective control impacts of these data source systems 300. Additionally and/or alternatively, the comparison can help identify one or more new jurisdictions, one or more removed jurisdictions and/or one or more changed jurisdictions in the control framework based upon the inclusion, exclusion, deletion and/or deactivation of one or more of the data source systems 300. The global privacy and data protection framework method 1000 thereby can evaluate change in a preselected country, territory or other geographic region over time by analyzing version records of the selected regulation based upon parameters defined in the user query and without requiring entry of the control framework with the user query.

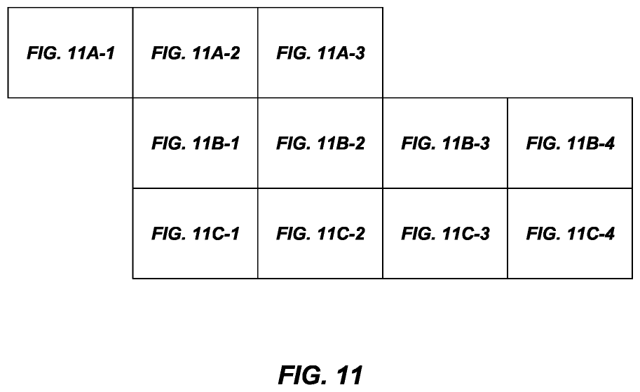

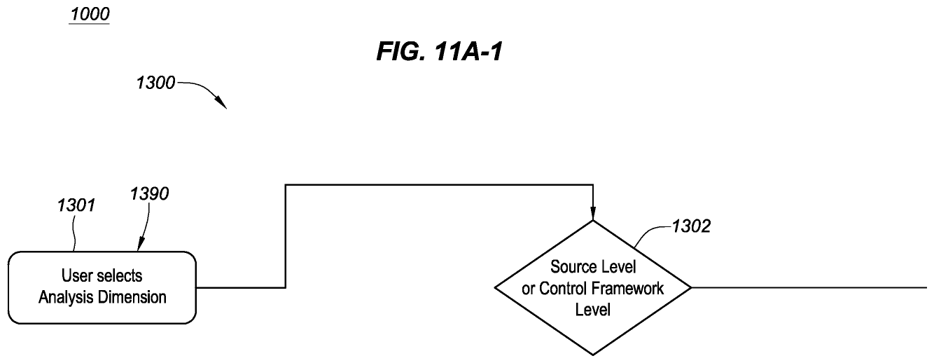

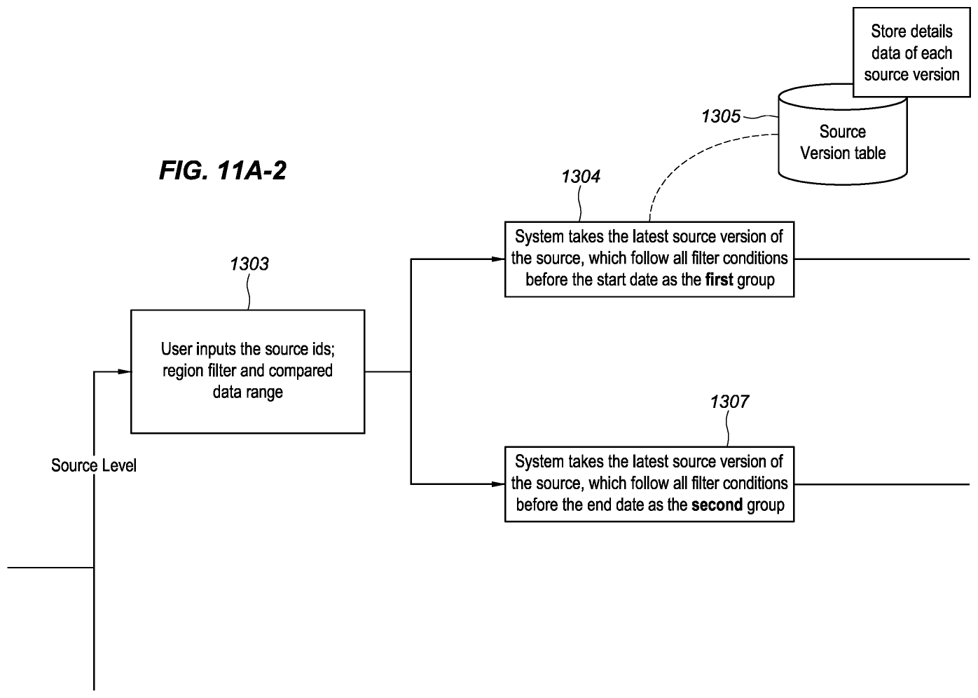

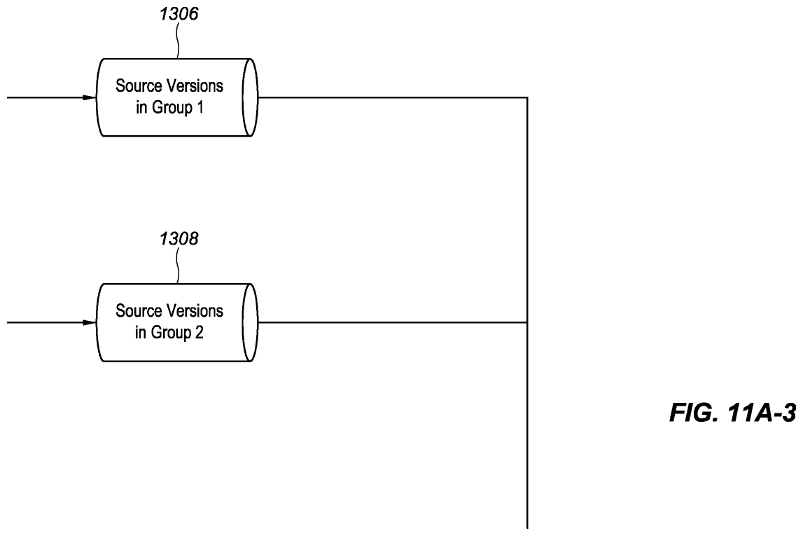

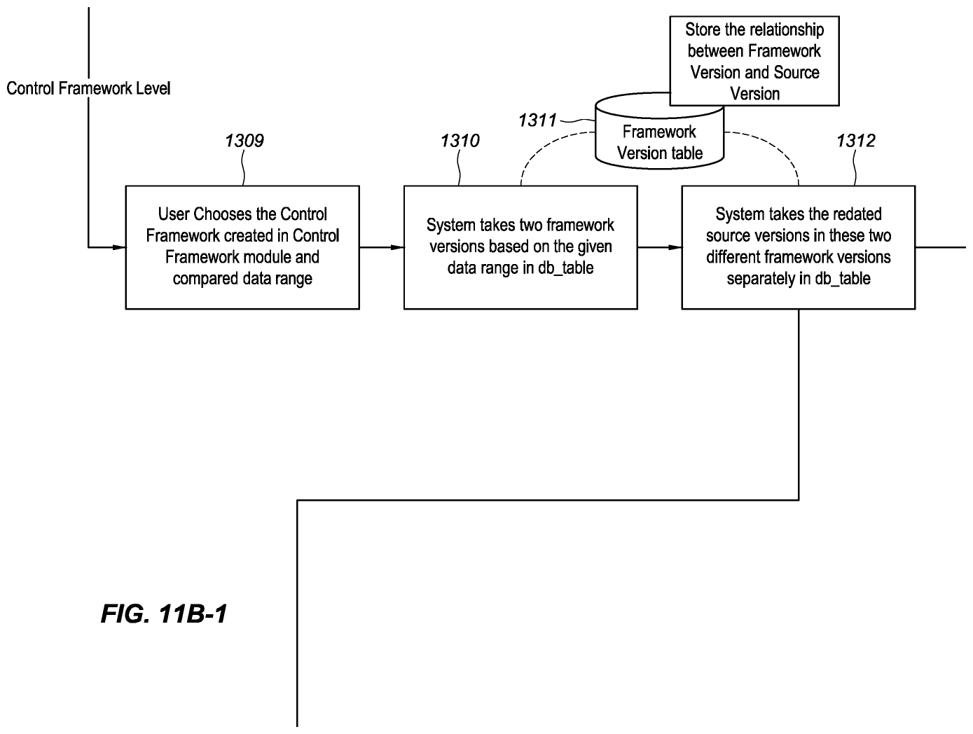

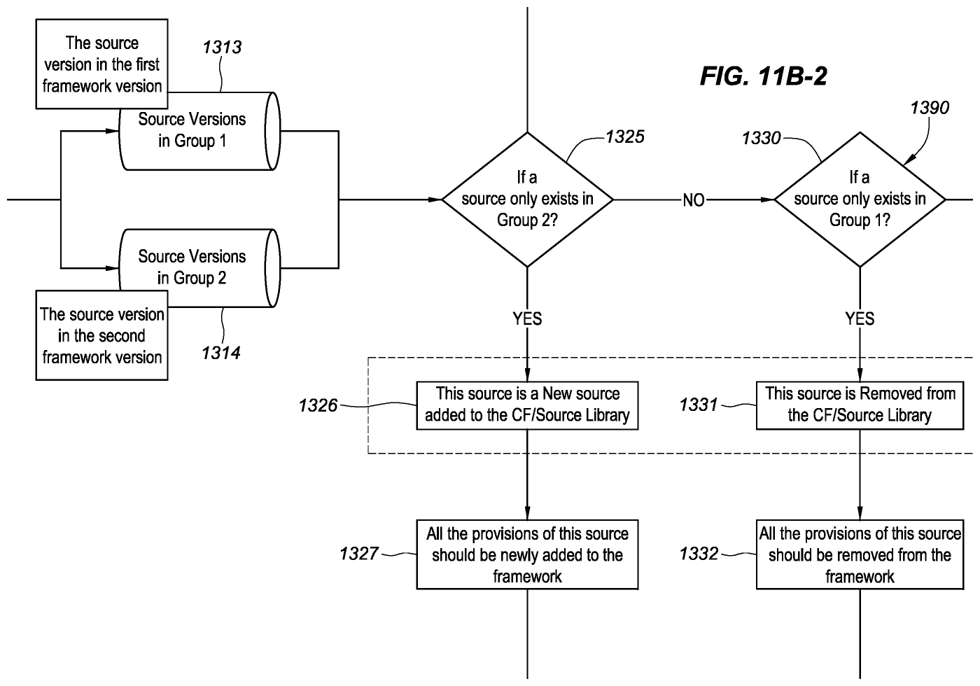

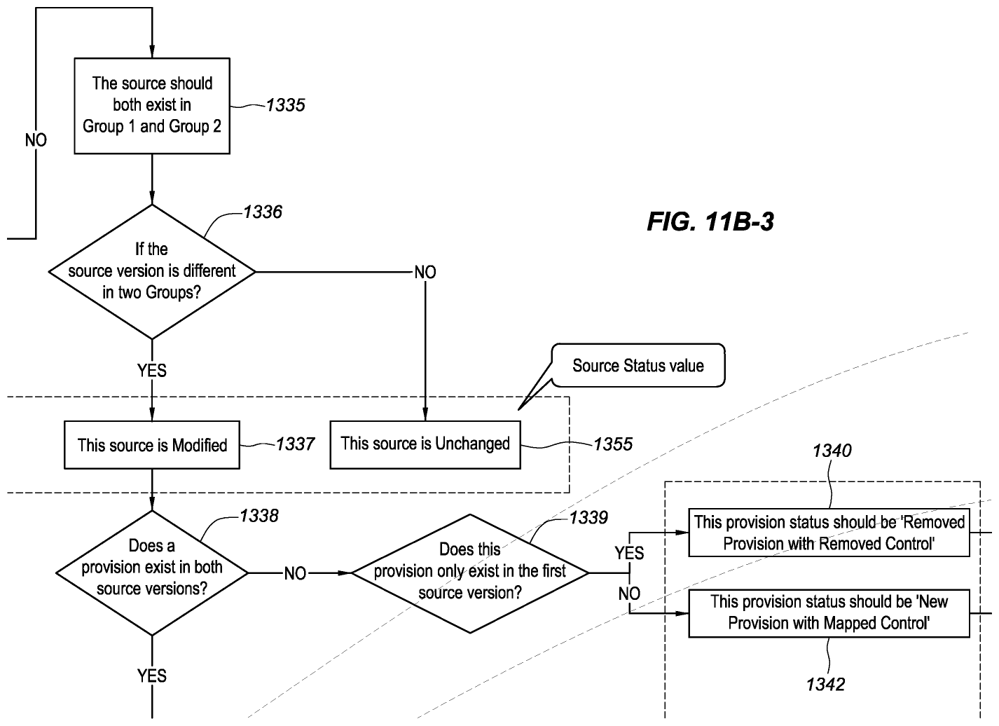

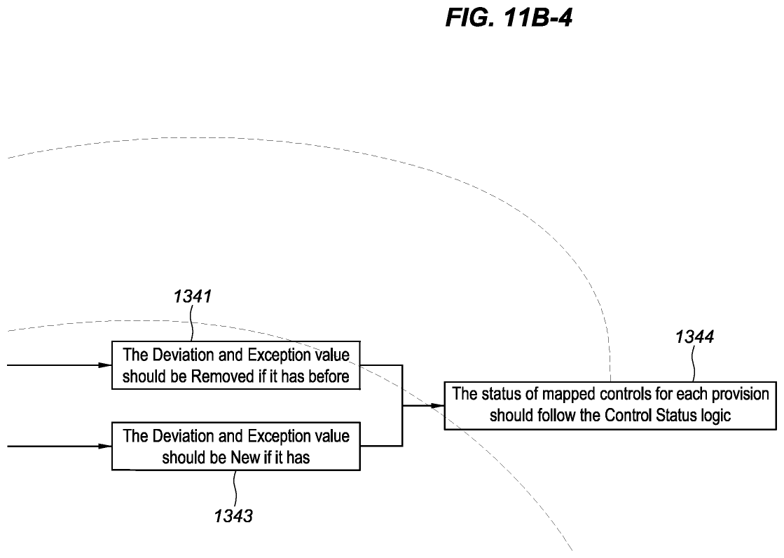

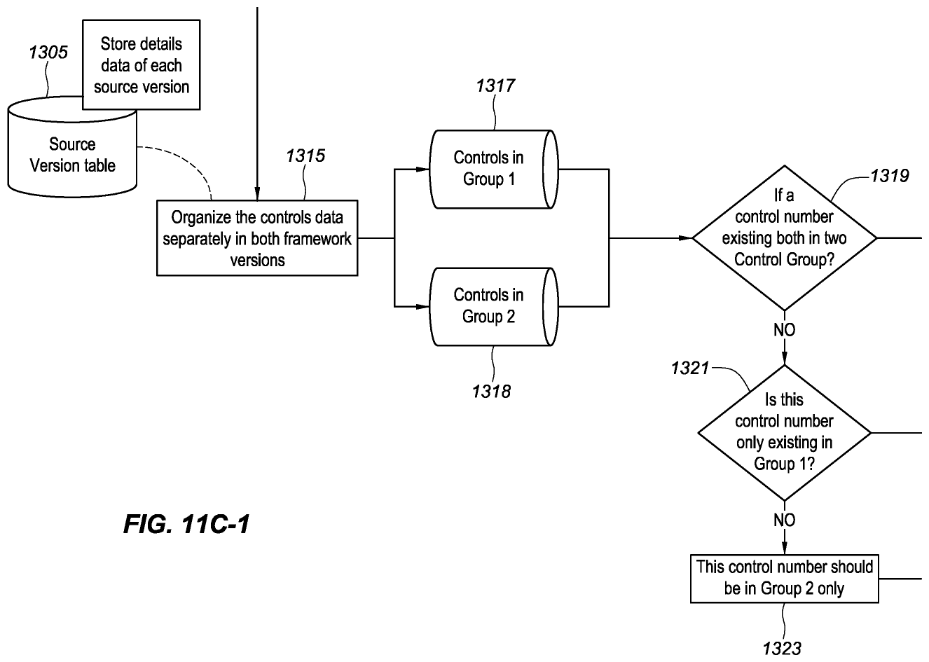

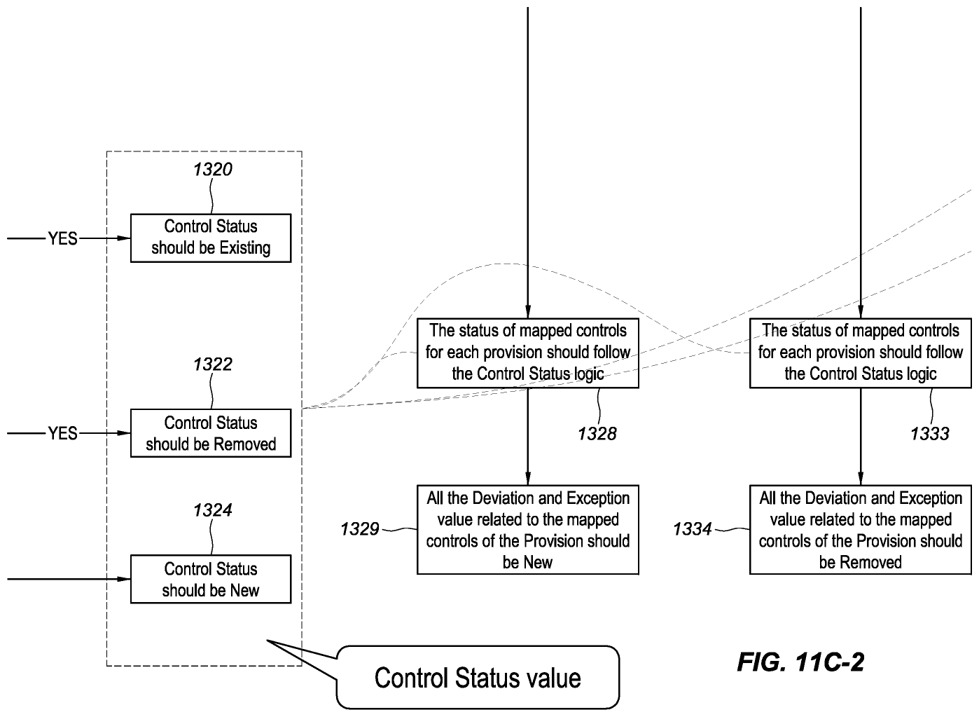

The global privacy and data protection framework method 1000 can maintain the version of the database system 122 (shown in FIG. 16) and perform impact analysis in any suitable manner. An exemplary database versioning and impact analysis method 1390 is illustrated in FIG. 11. Turning to in FIG. 11, the database versioning and impact analysis method 1390 is shown as including receiving a query from the user 210 (shown in FIG. 16), wherein the user query provides at least one analysis dimension, at 1301. The user query, at 1302, can comprise a source level user query or a control framework level user query.

For example, if the user query comprises a source level user query, the user query, at 1303, can include identification information for one or more data source systems 300, regional and other filter information and a comparison date range with a comparison start date and a comparison end date as shown in FIG. 11. The database versioning and impact analysis method 1390 can retrieve, at 1304, a first latest version of the identified data source systems 300 that satisfies the filter information before the comparison start date from a source version table system (or circuit) 1305 and, at 1306, can designate the first latest version of the identified data source systems 300 as a first group of source versions. The source version table system 1305 can store the detailed source data associated with each version of the identified data source systems 300. Additionally and/or alternatively, the database versioning and impact analysis method 1390 can retrieve, at 1307, a second latest version of the identified data source systems 300 that satisfies the filter information after the comparison end date from the source version table system 1305 and, at 1308, can designate the second latest version of the identified data source systems 300 as a second group of source versions.

FIG. 11 illustrates that the user query, at 1309, alternatively can include identification information for a control framework and a comparison date range if the user query comprises a control framework level user query. The database versioning and impact analysis method 1390 can retrieve, at 1310, first and second versions of the identified control framework from a framework version table system (or circuit) 1311 based upon the comparison date range. The framework version table system 1311 advantageously can store a replacing between the control framework version and the source version.

At 1312, a first source version associated with the first version of the identified control framework can be retrieved from the framework version table system 1311; whereas, a second source version associated with the second version of the identified control framework can be separately retrieved from the framework version table system 1311. The first source version associated with the first version of the identified control framework can be designated as a first group of source versions, at 1313, and the second source version associated with the second version of the identified control framework can be designated as a second group of source versions, at 1314.

In selected embodiments, the database versioning and impact analysis method 1390 can include, at 1315, retrieving first control data from the source version table system 1305 for the first version of the identified control framework, and retrieving second control data from the source version table system 1305 for the second version of the identified control framework. The first control data from associated with the first version of the identified control framework can be designated as a first group of control data, at 1317, and the second control data from associated with the second version of the identified control framework can be designated as a second group of control data, at 1318.

The first and second groups of control data optionally can be checked for a control number, at 1319, 1321 and 1323. If a control number exists for both the first and second groups of control data, for example, the control data can be assigned a control status value associated with existing control data, at 1320. At 1322, the control data can be assigned a control status value associated with removed control data if a control number exists only for the first group of control data; whereas, the control data can be assigned a control status value associated with new control data if a control number exists only for the second group of control data, at 1324.

Returning to the first group of source versions, at 1306, the second group of source versions, at 1308, the first group of source versions, at 1313, and the second group of source versions, at 1314, the database versioning and impact analysis method 1390 can determine, at 1325, whether only the second group of source versions, at 1308, or the second group of source versions, at 1314, exist. If only the second group of source versions, at 1308, or the second group of source versions, at 1314, exist, the identified data source system 300 or the data source system 300 associated with the identified control framework can be designed at as a new data source system, at 1326, and can be added to the control framework and/or data source library. The provisions of the data source system 300 can be newly added to the control framework, at 1327, a status of any mapped controls for each provision can be based upon the assigned control status value, at 1328, and/or any deviation and/or exception value related to the mapped controls of each provision can be set to a new status, at 1329.

The database versioning and impact analysis method 1390 alternatively can determine, at 1330, whether only the first group of source versions, at 1306, or the first group of source versions, at 1313, exist. If only the first group of source versions, at 1306, or the first group of source versions, at 1313, exist, the identified data source system 300 or the data source system 300 associated with the identified control framework can be designed at as a removed data source system, at 1331, and can be removed from the control framework and/or data source library. The provisions of the data source system 300 can be removed from the control framework, at 1332, a status of any mapped controls for each provision can be based upon the assigned control status value, and/or any deviation and/or exception value related to the mapped controls of each provision can be set to a removed status, at 1334.

The identified data source system 300 or the data source system 300 associated with the identified control framework otherwise can be deemed, at 1335, to exist in both the first group of source versions, at 1306, or the first group of source versions, at 1313, and the second group of source versions, at 1308, or the second group of source versions, at 1314, as illustrated in FIG. 11. The database versioning and impact analysis method 1390, at 1336, can determine whether a first source version associated with the first group of source versions, at 1306, or the first group of source versions, at 1313, is different from a second source version associated with the second group of source versions, at 1308, or the second group of source versions, at 1314. If the first source version and the second source version are not different, the data source system 300 can be deemed to be unchanged, at 1355.

The database versioning and impact analysis method 1390, at 1337, can deem the data source system 300 to have unchanged if the first source version and the second source version are different. At 1338, the database versioning and impact analysis method 1390 can determine whether a first provision exists in the first group of source versions, at 1306, or the first group of source versions, at 1313, and whether a second provision exists in the second group of source versions, at 1308, or the second group of source versions, at 1314. If only the first provision exists, at 1339, a status of the first provision can be set to a removed status with removed control, at 1340, and/or a deviation and/or exception value can be set to a removed status, at 1341. A status of the first provision and a status of the second provision can be set to a new status with mapped control, at 1342, and/or a deviation and/or exception value can be set to a new status, at 1343. A status of any mapped controls for each provision can be based upon the assigned control status value, at 1344.

At 1345, the database versioning and impact analysis method 1390 can determine whether a control number has been new added to, and/or removed from, the first or second provision. Based upon a determination that the control number has been new added to the first or second provision, at 1346, a status of the first provision and a status of the second provision can be set to an existing status with new mapped control, at 1347, and/or a deviation and/or exception value can be set to a new status, at 1348. A status of the first provision and a status of the second provision can be set to an existing status with removed mapped control, at 1349, and/or a deviation and/or exception value can be set to a removed status, at 1350, based upon a determination that the control number has been new added to the first or second provision, at 1346. A status of any mapped controls for each provision can be based upon the assigned control status value, at 1351.

The database versioning and impact analysis method 1390 can determine, at 1352, whether the deviation and/or exception value for the control number associated with the first or second provision has changed. If the deviation and/or exception value for the control number associated with the first or second provision has changed, the first provision and the second provision can be assigned a control status value associated with existing control data, at 1353, and/or a deviation and/or exception can be added to, and/or removed from, the control number of the provision. The first or second provision been deemed as being unchanged, at 1354, if the deviation and/or exception value for the control number associated with the first or second provision has not changed.

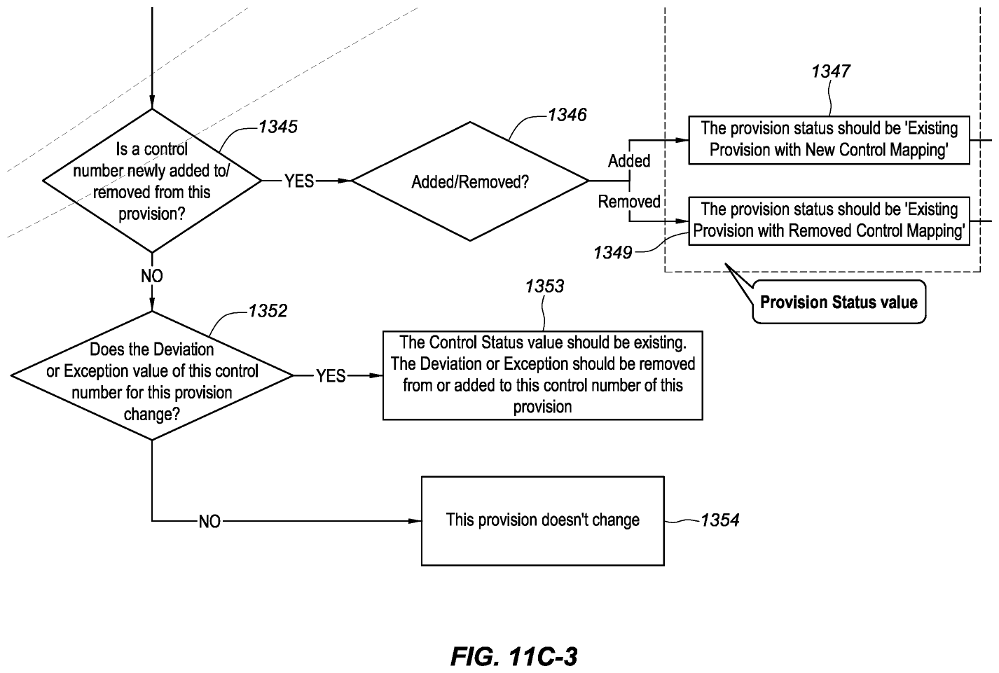

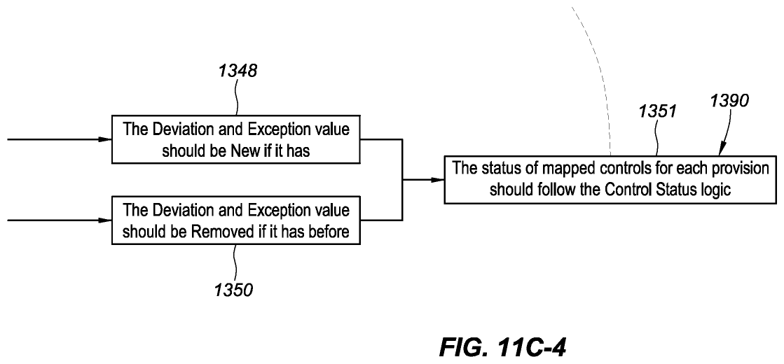

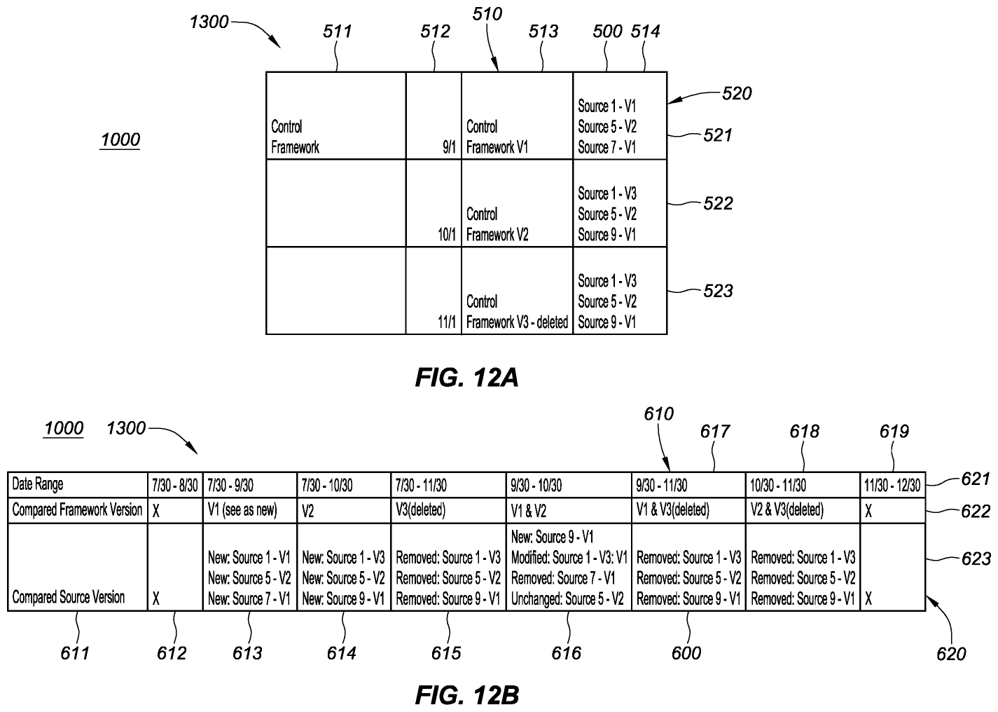

FIG. 12A is a table 500 with an exemplary control framework of the global privacy and data protection framework method 1000 as source data received from selected data source systems 300 changes over time. As shown in FIG. 12A, the table 500 can include a plurality of columns 510 and a plurality of rows 520. Column 511, for instance, identifies the relevant control framework. A version number of the relevant control framework is set forth in column 513; whereas, column 512 provides a date of the control framework version. The data source systems 300 and the versions of the source data associated with respective regulations provided by each source system is shown in column 514.

As illustrated in row 521 of the table 500, a first version of the relevant control framework was created on September 1 and includes a first version of source data from a first data source system 300, a second version of source data from a fifth data source system 300 and a first version of source data from a seventh data source system 300. Row 522 of the table 500 shows that the relevant control framework was updated to include a third version of source data from the first data source system 300, the second version of source data from the fifth data source system 300 and a first version of source data from a ninth data source system 300 on October 1. On November 1, the relevant control framework was deleted as shown in row 523. At the time of deletion, the relevant control framework included the third version of source data from the first data source system 300, the second version of source data from the fifth data source system 300 and the first version of source data from the ninth data source system 300.

Turning to FIG. 12B, table 600 shows comparisons between selected versions of the exemplary control framework set forth in the table 500 of FIG. 12A. The table 600 can include a plurality of columns 610 and a plurality of rows 620. Column 611, for instance, identifies the contents of the relevant row 620; whereas, the remaining columns 610 set forth respective dates or ranges of dates as set forth in row 621. As shown in FIG. 12B, column 612 can be associated with a first date range between July 30 and August 30, column 613 can be associated with a second date range between July 30 and September 30, column 614 can be associated with a third date range between July 30 and October 30 and column 615 can be associated with a fourth date range between July 30 and November 30.

A fifth date range between September 30 and October 30 is associated with column 616; whereas, a sixth date range between September 30 and November 30 is associated with column 617. Column 618 is shown as being associated with a seventh date range between October 30 and November 30, and column 619 is associated with the dates of November 30 and December 30. Row 622 shows comparisons of the relevant control framework versions for each of the respective dates and date ranges; whereas, row 623 shows comparisons of the data source versions comprising the relevant control framework versions for each of the respective dates and date ranges.

As set forth in column 613 of table 600, the version of the relevant control framework at an end of the second date range is compared with the version of the relevant control framework at a beginning of the second date range. In other words, the first version of the relevant control framework available on September 30 is compared with the version of the relevant control framework on July 30. Since table 1 shows that no version of the relevant control framework was available on July 30, the first version of the relevant control framework is shown as being a new control framework that comprises a first version of a new control frame work during the second date range and comprises the first version of source data from the first data source system 300, the second version of source data from the fifth data source system 300 and the first version of source data from the seventh data source system 300. Each of the source systems associated with the first version of the relevant control framework are deemed as comprising a new source system during the second date range since table 1 shows that no version of the relevant control framework was available on July 30.

Column 614 of table 600 shows a comparison of the second version of the relevant control framework available on October 30 with the version of the relevant control framework on July 30. The comparison of column 614 does not show the second version of the relevant control framework as comprising a new control framework due to the existence of the prior first version of the relevant control framework. Since table 1 shows that no version of the relevant control framework was available on July 30, the second version of the relevant control framework is shown as including the third version of source data from the first data source system 300, the second version of source data from the fifth data source system 300 and the first version of source data from the ninth data source system 300. Each of the source systems associated with the second version of the relevant control framework are deemed as comprising a new source system during the third date range since table 1 shows that no version of the relevant control framework was available on July 30.

Turning to column 615 of table 600, a comparison of the third version of the relevant control framework available on November 30 with the version of the relevant control framework on July 30 is illustrated. The comparison of column 615 does not show the third version of the relevant control framework as comprising a new control framework due to the existence of the prior first version of the relevant control framework but instead shows the third version of the relevant control framework as comprising a deleted control framework because the third version was deleted on November 1. Since table 1 shows that no version of the relevant control framework was available on July 30, the third version of the relevant control framework is shown as including the third version of source data from the first data source system 300, the second version of source data from the fifth data source system 300 and the first version of source data from the ninth data source system 300. Each of the source systems associated with the third version of the relevant control framework are deemed as comprising a removed source system during the third date range since the third version was deleted on November 1.

Column 616 of table 600 shows a comparison of the second version of the relevant control framework available on October 30 with the first version of the relevant control framework available on September 30. The comparison of column 616 does not show the second version of the relevant control framework as comprising a new control framework due to the existence of the first version of the relevant control framework. Relative to the first version of the relevant control framework, the second version of the relevant control framework added the first version of source data from the ninth data source system 300, changed from the first source data to the third source data of the first data source system 300, removed the first version of source data of the seventh data source system 300 and left the second version of source data from the fifth data source system 300 unchanged as set forth in column 616.

A comparison of the third version of the relevant control framework available on November 30 with the first version of the relevant control framework on September 30 is shown in column 617 of table 600. The comparison of column 617 illustrates that the third version of the relevant control framework comprises a deleted control framework because the third version was deleted on November 1. Relative to the first version of the relevant control framework, the third version of the relevant control framework is shown as including the third version of source data from the first data source system 300, the second version of source data from the fifth data source system 300 and the first version of source data from the ninth data source system 300, each of which is deemed to be removed when the third version of the relevant control framework was deleted on November 1 as set forth in table 500 of FIG. 12A.

As shown in column 618 of table 600, the third version of the relevant control framework available on November 30 is compared with the second version of the relevant control framework on October 30. The comparison of column 618 shows that the third version of the relevant control framework comprises a deleted control framework because the third version was deleted on November 1. Relative to the second version of the relevant control framework, the third version of the relevant control framework is shown as including the third version of source data from the first data source system 300, the second version of source data from the fifth data source system 300 and the first version of source data from the ninth data source system 300, each of which is deemed to be removed when the third version of the relevant control framework was deleted on November 1 as set forth in table 500 of FIG. 12A.

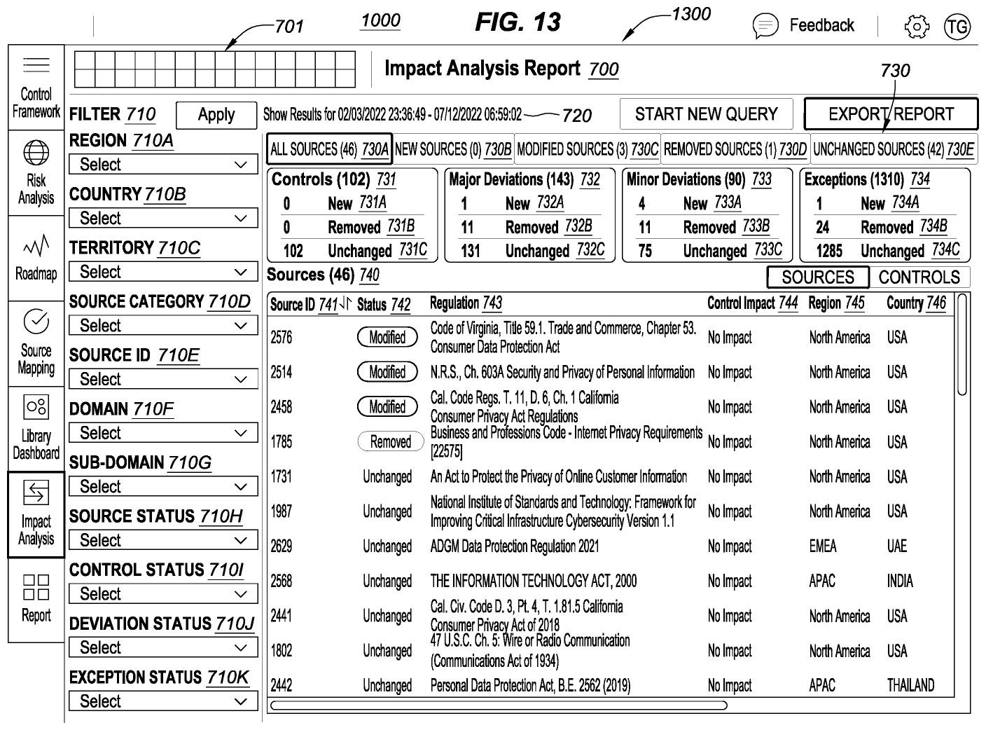

In the manner described in more detail above with reference to FIG. 1, the global privacy and data protection framework method 1000, at 1300, can generate one or more reports based upon the received source data. The reports can be presented to the user 210 (shown in FIG. 16) via, for example, a user interface 701 associated with the global privacy and data protection framework method 1000 as shown in FIG. 13. Turning to FIG. 13, user interface 701 is shown as presenting an exemplary impact analysis report 700 generated by the global privacy and data protection framework method 1000 is shown in FIG. 13. Turning to FIG. 13, the impact analysis report 700 is shown as including a result of a comparison of a relevant control framework between two predetermined days and/or times, at 720.

The comparison can be adjusted to include source data from one or more predetermined data source systems 300, at 730. The predetermined data source systems 300 can include all available data source systems 300, at 730A, new data source systems 300, at 730B, modified data source systems 300, at 730C, removed data source systems 300, at 730C, and/or unchanged data source systems 300, at 730D, without limitation. One or more filters 710 can determine a scope and/or content of the results comprising the impact analysis report 700. Exemplary filters 710 can include, but are not limited to, region filter 710A, a country filter 710B, a territory filter 710C, a data source category filter 710D, a data source identification information filter 710E, a domain filter 710F, a sub-domain filter 710G, a data source system filter 710H, a control status filter 7101, a deviation status filter 7101 and/or an exception status filter 710K.

As shown in FIG. 13, the impact analysis report 700 can show a number and other summary information for one or more controls, at 731. The summary information for the controls can include a number of new controls, at 731A, a number of removed controls, at 731B, a number of changed controls and/or a number of unchanged controls, at 731C, without limitation. The impact analysis report 700 optionally can include a number and other summary information for one or more major deviations, at 732. The summary information for the major deviations can include a number of new major deviations, at 732A, a number of removed major deviations, at 732B, a number of changed major deviations and/or a number of unchanged major deviations, at 732C, without limitation.

Additionally and/or alternatively, the impact analysis report 700 can show a number and other summary information for one or more minor deviations, at 733. The summary information for the minor deviations can include a number of new minor deviations, at 733A, a number of removed minor deviations, at 733B, a number of changed minor deviations and/or a number of unchanged minor deviations, at 733C, without limitation. The impact analysis report 700, in selected embodiments, can include a number and other summary information for one or more exceptions, at 734. The summary information for the exceptions can include a number of new exceptions, at 734A, a number of removed exceptions, at 734B, a number of changed exceptions and/or a number of unchanged exceptions, at 734C, without limitation.

The impact analysis report 700 of FIG. 13 is illustrated as including comparison results, at 740, for the source data and/or the data source systems 300 associated with the relevant control framework versions. The comparison results, at 740, for the data source and/or the data source systems 300 can include data source identification information, at 741, and/or current status information, at 742. As shown in FIG. 13, the source data can be associated with one or more regulations. The impact analysis report 700 thereby can include information about the relevant regulations such as a regulation name, at 743, a regulation region, at 745, and/or a regulation country, at 746, for each regulation identified in the comparison results. Advantageously, the impact analysis report 700 can include a control impact, at 744, associated with each identified regulation.

In selected embodiments, the global privacy and data protection framework method 1000 can enable the user 210 (shown in FIG. 16) to create one or more custom relationships between regulations. The custom relationships between regulations can be created with, and/or separately from, the mapping of the work request and associated source data and data source systems 300, at 1160 (shown in FIGS. 2A-B and 7A-B). The global privacy and data protection framework method 1000 can utilize the custom relationships between regulations to aggregate customized reports and/or groupings of source data, for example, without creating new source versions and/or new control framework versions. The custom relationships between regulations advantageously can help expedite analysis of the regulations by avoiding the multi-step workflow process 1110 for receiving current source data discussed in more detail above, for example, with reference to FIGS. 2A-B, 3A-F, 5A-B, 6A-B and 7A-B and/or without jeopardizing an integrity of the source versions and/or control framework versions.

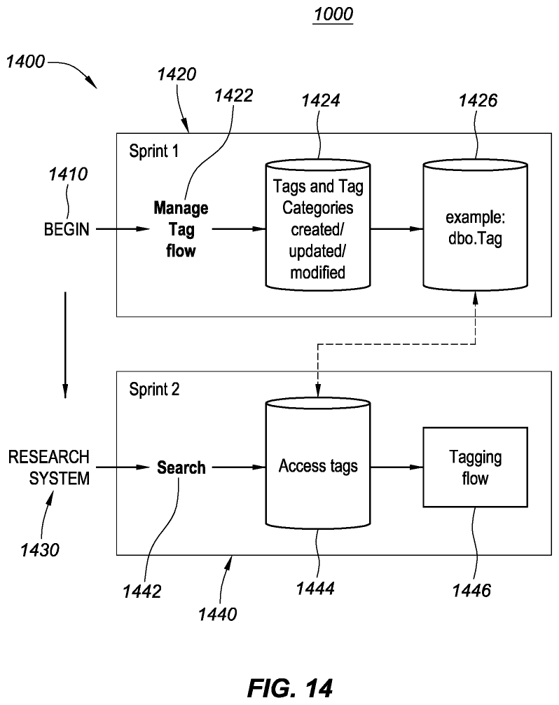

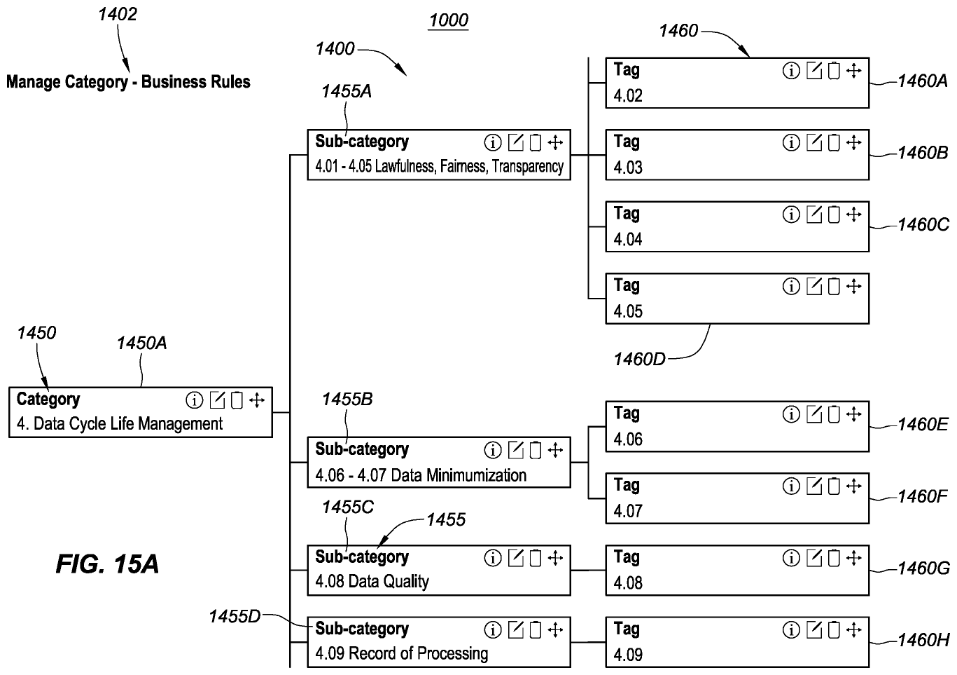

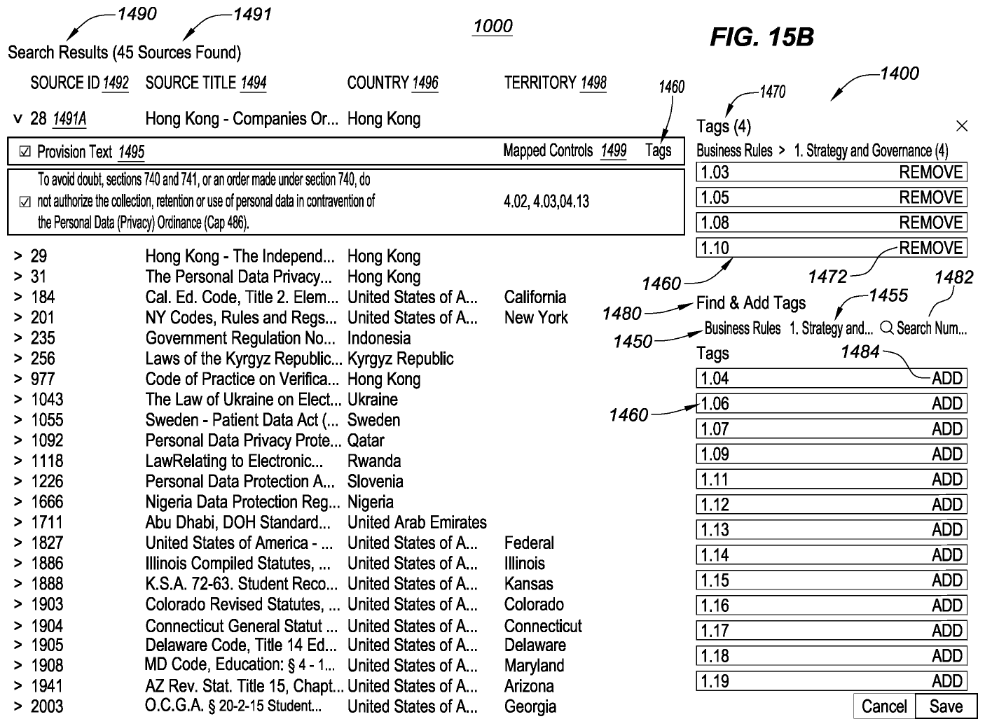

The global privacy and data protection framework method 1000, for instance, can include a tagging method 1400 for creating the custom relationships between regulations in the manner shown in FIG. 14. Turning to FIG. 14, the tagging method 1400 can enable the user 210 (shown in FIG. 16) to create a hierarchy of tags for supporting a rapid creation of categories 1450 (shown in FIG. 15A) and subcategories 1455 (shown in FIG. 15A) each being associated with at least one tag 1460 (shown in FIG. 15A) for application to selected regulation text segments. The tagging method 1400 can begin, at 1410, and comprise a first process 1420 by which tag flow can be managed, at 1422. The first process 1420 can include creating, updating, modifying and/or deleting one or more of the tags 1460 and/or one or more of the categories 1450 and/or subcategories 1455, at 1424, as desired. Thereby, at 1426, the first process 1420 can provide at least one tag 1460 for application to selected regulation text segments.

Additionally and/or alternatively, the tagging method 1400 can be associated with a research system (or circuit) 1430 and/or a second process 1440 as illustrated in FIG. 14. The research system 1430 advantageously can enable the user 210 to select one or more instances of the source data and/or one or more data source systems 300 based upon preselected criteria and apply one or more customized tags 1460 provided, at 1426, via the first process 1420. As shown in FIG. 14, the tagging method 1400 can enable the user 210 to perform a search, at 1442, of the source data and/or one or more data source systems 300. The second process 1440, at 1444, can include, accessing the customized tags 1460 provided, at 1426, via the first process 1420 and applying the accessed customized tags 1460 to manage tagging flow, at 1446.

The tagging method 1400 advantageously create one or more custom reports based on the tags 1460 in response to the user query about a regulation. In other words, the tags 1460 can form a foundation for creating unique and/or customizable perspectives on regulatory data via the research system 1430. Thereby, the tagging method 1400 can create one or more queryable datasets. Exemplary queryable datasets can comprise, but are not limited to, a list of regulations applicable to a topic area, such as the regulation.

The categories 1450 and/or subcategories 1455 can be created and managed in any suitable manner. An exemplary method 1402 for managing the categories 1450 and/or subcategories 1455 is shown in FIG. 15A. The method 1402 can be utilized for creating and/or managing one or more categories 1450 and/or one or more subcategories 1455 for different levels of tags 1460. Turning to FIG. 15A, an organization of categories 1450 and/or subcategories 1455 for business rules is shown as including a data cycle management category 1450A. A plurality of exemplary subcategories 1455 are shown as being associated with the data cycle management category 1450A. The subcategories 1455 can include, but are not limited, to a lawfulness, fairness and transparency subcategory 1455A, a data minimization subcategory 1455B, a data quality subcategory 1455C and/or a record of processing subcategory 1455D. Although shown and described as being associated with business rules in FIG. 15A for purposes of illustration only, the categories 1450 and/or subcategories 1455 can comprise a hierarchal organization that provides an association for any suitable type of information for inclusion in the database system 122 (shown in FIG. 16) or regulation library.

Each category 1450 and/or subcategory 1455 can be associated with at least one tag 1460. As illustrated in FIG. 15A, for example, the data cycle management category 1450A can be associated with a plurality of tags 1460A-H. More specifically, the tags 1460A-D are shown as being associated with the lawfulness, fairness and transparency subcategory 1455A, the tags 1460E, 1460F are shown as being associated with the data minimization subcategory 1455B. The data quality subcategory 1455C can be associated with the tag 1460G; whereas, the record of processing subcategory 1455D can be associated with the tag 1460H.

In selected embodiments, the method 1402 can enable the user 210 to interact with a suitable user interface system (not shown) for creating a new category 1450 and/or for creating a new subcategory 1455 under a relevant category 1450. The user interface system can include an icon, button or other interact mechanism that can be activated to create the new category 1450 and/or new subcategory 1455. Existing categories 1450 and/or subcategories 1455 similarly can be modified and/or removed via the user interface system. An existing subcategory 1455 under a first category 1450 optionally can be moved from the first category 1450 to a second category 1450. In selected embodiments, the existing subcategory 1455 can be dragged from the first category 1450 and dropped into the second category 1450 via the user interface system.

FIG. 15B shows an exemplary user interface 1490 for the research system 1430 of FIG. 14. The user interface 1490 can enable the user 210 (shown in FIG. 16) to apply one or more custom tags 1460 created via the first process 1420 (shown in FIG. 14) of the tagging method 1400. As illustrated in FIG. 15B, the user interface 1490 is shown with reference to a list of search results 1491. Each search result 1491, for example, can be associated with source identification information 1492, a title 1494 of the regulation or other source data, a relevant country 1496 and/or a relevant territory 1498, without limitation. In selected embodiments, at least one of the search results 1491 can be associated with the text 1495 of the regulation or other source data. FIG. 15B shows that the search results 1491 optionally can be associated with at least one mapped control 1499 and/or at least one tag 1460.

The user interface 1490 can enable the user 210 to associate the search results 1491 with at least one tag 1460 in any suitable manner. For example, the user interface 1490 can enable the user 210 to select at least one search result 1491A for tagging and to activate Find & Add Tags control indicia 1480. Activation of the Find & Add Tags control indicia 1480 can permit the user 210 to identify one or more relevant tags 1460 by filtering a listing of available tags 1460 by category 1450 and/or subcategory 1455. Additionally and/or alternatively, the user interface 1490 can include search indicia 1482 for initiating a search among the listing of available tags 1460 to identify the relevant tags 1460. Once identified, the relevant tags 1460 can be selected for association with the selected search result 1491A via activation of tag addition control indicia 1484.

As illustrated in FIG. 15B, the user interface 1490 optionally can include relevant tag indicia 1470. The relevant tag indicia 1470 can present each relevant tag 1460 associated with the selected search result 1491A. In selected embodiments, the relevant tag indicia 1470 can include editing or otherwise modifying the relevant tags 1460. The relevant tag indicia 1470 of FIG. 15B, for example, includes removal indicia 1472 for enabling the user 210 to disassociate one or more relevant tags 1460 from the selected search result 1491A.

The global privacy and data protection framework method 1000 can be implemented in any suitable manner. For example, the global privacy and data protection framework method 1000 can comprise a computer-implemented method and/or can be provided as a computer program product being encoded on one or more non-transitory machine-readable storage media. An exemplary embodiment of a global privacy and data protection framework system (or circuit) 100 is illustrated in FIG. 16. Turning to FIG. 16, the global privacy and data protection framework system 100 can comprise a user management system 110 in communication with a data management system 120. Stated somewhat differently, the global privacy and data protection framework system 100 can comprise a processing system (or circuit), such as a computer server system, a personal computing system, laptop computing system, tablet computing system, mobile telephone system or any other conventional type of processing system suitable for implementing the global privacy and data protection framework method 1000.

The user management system 110 can comprise a forward proxy server for allowing multiple clients to route traffic to an external network of the global privacy and data protection framework system 100. For example, the user management system 110 can be configured to communicate with at least one data source system 300 and, in the manner discussed in more detail herein, to receive regulatory or other source data from the data source system 300. The source data, for example, can include current source data associated with a regulation and/or updated source data associated with any change to the regulation over time.

In selected embodiments, the user management system 110 can comprise an authentication solution that can support, for example, user registration, user login and other user management processes for the global privacy and data protection framework system 100. The user management system 110 thereby can permit communication with a user processing device 200 associated with the user 210. The user processing device 200 can comprise a computer server system, a personal computing system, laptop computing system, tablet computing system, mobile telephone system or any other conventional type of processing device for enabling the user 210 to communicate with the user management system 110. For example, the user 210 can enter a user query.

The data management system 120 can include a database system (or circuit) 122 and can handle management functions for the database system 122, which can store the received source data associated with the regulations and provide the stored source data upon request. For example, the data management system 120 can store data models and attend to related data model functions. In selected embodiments, the data management system 120 can comprise an object storage solution for the cloud and/or can store massive amounts of unstructured source data and other data. Additionally and/or alternatively, the data management system 120 can include a cache for storing static source data and other data to improve data retrieval efficiency. The data management system 120 optionally can send electronic mail (or email) messages, preferably without maintaining a separate email server.

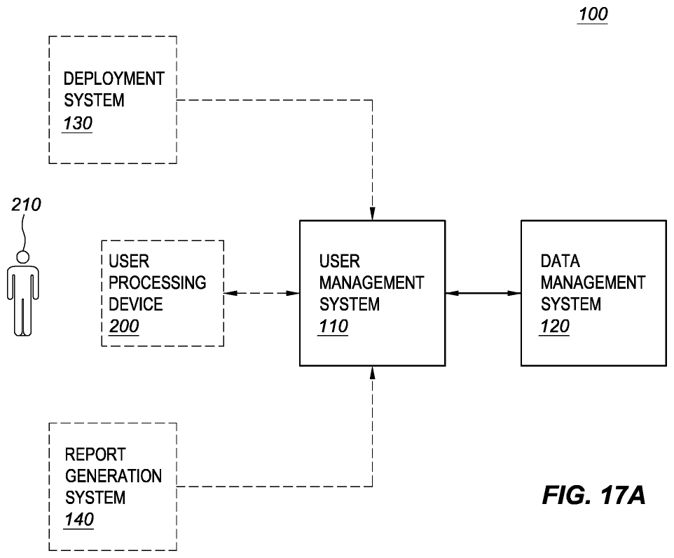

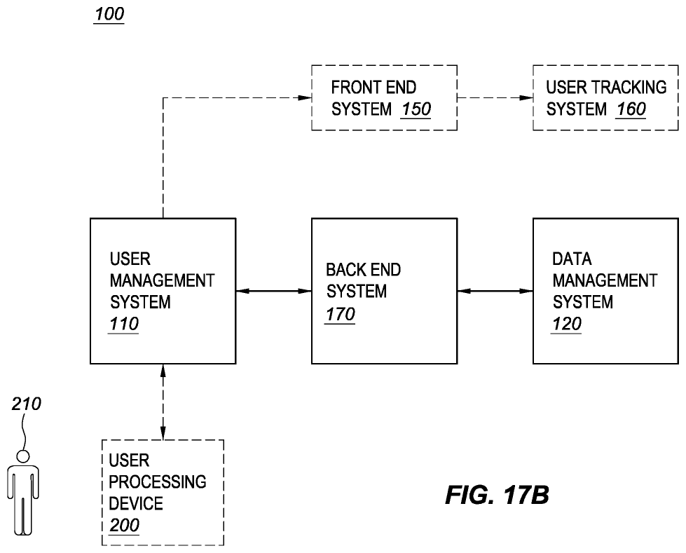

In selected embodiments, the global privacy and data protection framework method 1000 can include an optional deployment system 130 and/or an optional report generation system 140 as illustrated in FIG. 17A. The deployment system 130 can comprise selected project code and/or branches that can be advantageous for building and developing the global privacy and data protection framework system 100. Additionally and/or alternatively, the deployment system 130 can provide developer services, including development of a working plan and collaboration for developing and deploying code for the global privacy and data protection framework system 100. The deployment system 130, in selected embodiments, can help manage binaries and artifacts in the application development process and/or automate the application development and/or release process. The deployment system 130 preferably can help leverage built-in code-to-cloud pipelines and guardrails to deploy the code local processing systems (or circuits) to infrastructure available in the cloud.

The report generation system 140 can help facilitate analysis of the received source data and other data associated with the data protection framework system 100 and/or to provide related business intelligence. For example, the report generation system 140 can help visualize the received source data and other data associated with the data protection framework system 100 for facilitating data analysis and business intelligence.

As shown in FIG. 17B, the data protection framework system 100 can include a front end system (or circuit) 150, a user tracking system (or circuit) 160 and/or a back end system (or circuit) 170 in selected embodiments. Illustrated as being in communication with the user management system 110 and the user tracking system 160, the front end system 150 can help facilitate development of the global privacy and data protection framework system 100 in Hypertext Markup Language (or HTML) and/or TypeScript, which is a superset of typed JavaScript that can be used to build and/or manage large-scale JavaScript projects. The front end system 150 advantageously can provide resources to rapidly create hi-resolution mockups, prototypes and develop web-based products.

In selected embodiments, the front end system 150 can help the global privacy and data protection framework system 100 implement automatically refreshed scheduled tasks and/or advantageously can be used with any server system that can serve static files and can be used to display visualization in one or more components of the global privacy and data protection framework system 100. The front end system 150 optionally can enable the global privacy and data protection framework system 100 optionally can display flexible tables during source mapping as shown and described herein with reference to FIG. 10.

The user tracking system 160 can track online visits to one or more websites and display reports on these visits for analysis. The displayed reports advantageously can provide insights into user behavior and access that inform development strategy and security for the global privacy and data protection framework system 100. Additionally and/or alternatively, the user tracking system 160 can provide a better understanding about how the user 210 interacts with specific components of the global privacy and data protection framework system 100 and inform development strategy for the global privacy and data protection framework system 100.

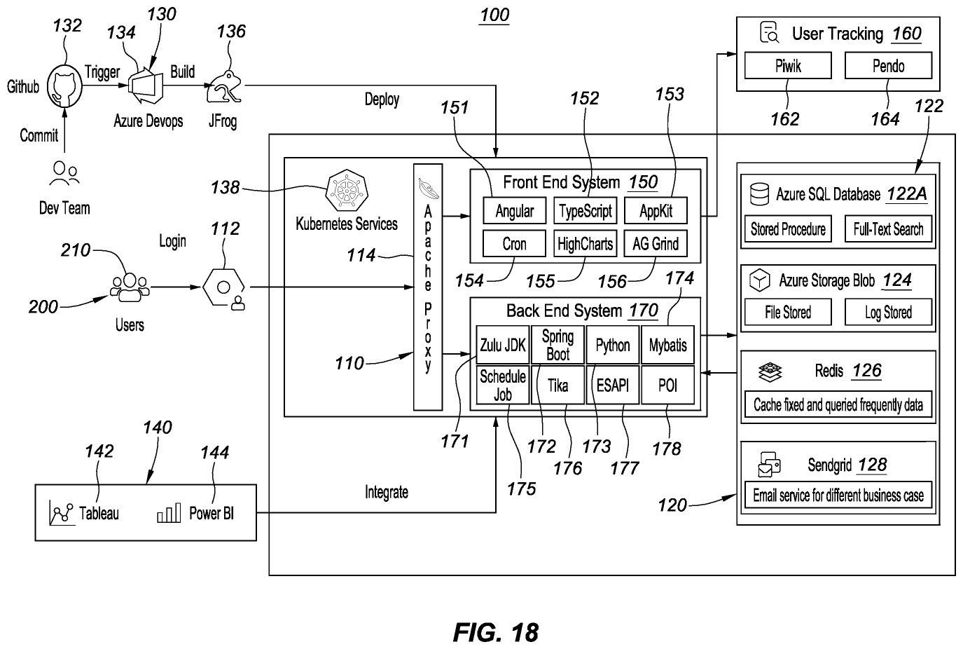

Additionally and/or alternatively, the backend system 170 create applications that can be run via the global privacy and data protection framework system 100 without dependencies and/or map Java objects to one or more database models. The backend system 170 optionally can enable the global privacy and data protection framework system 100 to generate and/or read selected files, such as files in a portable document format (or .pdf) and/or files in a Microsoft Excel format. In selected embodiments, the backend system 170 can provide a trace log. The backend system 170 of FIG. 18 also is illustrated as including a POI system (or circuit) 178.

In selected embodiments, the global privacy and data protection framework system 100 can enable the user 210 (shown in FIG. 16) to provide current source data for a regulation, at 900 (shown in FIG. 4), via the front end system 150. The front end system 150 likewise can support enabling the user 210 to visualize the regulation, at 1300A, retrieving the stored regulation information, at 1300B, and/or performing the analysis of the stored regulation information, at 1300D, in the manner discussed in more detail above with reference to FIG. 4. Additionally and/or alternatively, the backend system 170 can support addressing the current source data for the regulation, at 1200A (shown in FIG. 4), in selected embodiments. The backend system 170 optionally can generate the framework report from the retrieved regulation information, at 1300C, and/or perform a comparison between the stored regulation information associated with two or more versions of the regulation, at 1300E, in the manner discussed in more detail above with reference to FIG. 4.

Turning to FIG. 18, the user management system 110 can include a user management and authentication system (or circuit) 112 for supporting user registration, user login and other user management processes for the global privacy and data protection framework system 100. The user management system 110 thereby can permit communication with the user processing device 200. FIG. 18 also shows that the user management system 110 can comprise an Apache forward proxy server system 114 for allowing multiple clients to route traffic to an external network of the global privacy and data protection framework system 100. The user management system 110 thereby can be configured to communicate with at least one data source system 300 and, in the manner discussed in more detail herein, to receive regulatory or other source data from the data source system 300.

The data management system 120 of FIG. 18 is shown as including an Azure Structured Query Language (or SQL) database (or circuit) 122A available from Microsoft Corporation of Redmond, Wash., for handling management functions for the Azure SQL database system 122A, which can store the received source data associated with the regulations and provide the stored source data upon request. In selected embodiments, the Azure SQL database system 122A can store data models and otherwise attend to related data model functions. As illustrated in FIG. 18, the data management system 120 can comprise an Azure Storage Blob system (or circuit) 124 available from Microsoft Corporation of Redmond, Wash., for providing an object storage solution for the cloud and/or storing massive amounts of unstructured source data and other data.

The data management system 120 of FIG. 18 likewise is shown as including a Redis Caching Solution system (or circuit) 126 available from Redis Ltd. in Mountain View, Calif., for storing static source data and other data to improve data retrieval efficiency. Additionally and/or alternatively, the data management system 120 optionally include a SendGrid Email Delivery system (or circuit) 128 available from SendGrid of Denver, Colo., for sending email messages, preferably without maintaining a separate email server.

The optional deployment system 130 of FIG. 18 can include a Github management tool system (or circuit) 132 that is available from GitHub, Inc., of San Francisco, Calif. The Github management tool system 132 can comprise selected project code and/or branches that can be advantageous for building and developing the global privacy and data protection framework system 100. As illustrated in FIG. 18, the deployment system 130 can include an Azure Devops server system (or circuit) 134 available from Microsoft Corporation of Redmond, Wash., for providing developer services, including development of a working plan and collaboration for developing and deploying code for the global privacy and data protection framework system 100.

A JFrog system (or circuit) 136 is available from JFrog of Sunnyvale, Calif., and can help manage binaries and artifacts in the application development process. The JFrog system 136, for example, can automate the application development and/or release process. The deployment system 130 likewise is shown as comprising an Azure Kubernetes Services system (or circuit) 138. The Azure Kubernetes Services system 138 is available from Microsoft Corporation of Redmond, Wash., and can help leverage built-in code-to-cloud pipelines and guardrails to deploy the code local processing systems (or circuits) and/or the Github management tool system 132 to cloud infrastructure.

As shown in FIG. 18, the report generation system 140 can include a Tableau visualization tool system (or circuit) 142 available from Tableau Software, LLC, of Seattle, Wash. The Tableau visualization tool system 142 can help facilitate analysis of the received source data and other data associated with the data protection framework system 100 and/or to provide related business intelligence. In selected embodiments, the report generation system 140 can include a Power BI system (or circuit) 144. The Power BI system 144 is available from Microsoft Corporation of Redmond, Wash., and can help visualize the received source data and other data associated with the data protection framework system 100 for facilitating data analysis and business intelligence.

The front end system 150, in selected embodiments, can include an Angular code platform and framework system (or circuit) 151. The Angular code platform and framework system 151 is available from the Angular team at Google LLC of Mountain View, Calif., and can help facilitate development of the global privacy and data protection framework system 100 in Hypertext Markup Language (or HTML) and/or TypeScript 152. TypeScript 152 is a superset of typed JavaScript that can be used to build and/or manage large-scale JavaScript projects and developed by Microsoft Corporation of Redmond, Wash. As shown in FIG. 18, the front end system 150 can include an Appkit interface system (or circuit) 153. The Appkit interface system 153 is available from Apple Inc. of Cupertino, Calif., and is a graphical user interface toolkit for providing resources to rapidly create hi-resolution mockups, prototypes and develop web-based products.

A Cron template framework system (or circuit) 154 is a simple asynchronous template framework system for a node and is available from Cron Inc. of San Francisco, Calif. The Cron template framework system 154 can be included with the front end system 150 and can help the global privacy and data protection framework system 100 implement automatically refreshed scheduled tasks. Additionally and/or alternatively, the front end system 150 can comprise a Highcharts library system (or circuit) 155 as illustrated in FIG. 18. The Highcharts library system 155 is available from Highsoft AS of Vik i Sogn, Norway, and is a standalone library that does not require any additional frameworks or plugins to work.

The Highcharts library system 155 is solely based on native browser technologies, and all core functionality runs in the browser. As front-end library, the Highcharts library system 155 advantageously can be used with any server system that can serve static files and can be used to display visualization in one or more components of the global privacy and data protection framework system 100. The front end system 150 optionally can include an AG Grid system (or circuit) 156, which is available from GitHub, Inc., of San Francisco, Calif. The AG Grid system 156 is a fully-featured and highly customizable JavaScript data grid and can be used to display flexible tables during source mapping as shown and described herein with reference to FIG. 10.

FIG. 18 shows that the user tracking system 160 can include a Piwik system (or circuit) 162 and/or a Pendo system (or circuit) 164. The Piwik system 162, for example, is available from Piwik PRO LLC of New York, N.Y., and can track online visits to one or more websites and display reports on these visits for analysis. The displayed reports advantageously can provide insights into user behavior and access that inform development strategy and security for the global privacy and data protection framework system 100. The global privacy and data protection framework system 100 can leverage and otherwise utilize the Pendo system 164 to better understand how the user 210 interacts with specific components of the global privacy and data protection framework system 100 and inform development strategy for the global privacy and data protection framework system 100. The Pendo system 164 is available from Pendo.io, Inc., of Raleigh, N.C.

The backend system 170 of FIG. 18 is shown as including a Zulu JDK system (or circuit) 171 that is available from Azul Systems, Inc., of Sunnyvale, Calif., and/or a Spring Boot system (or circuit) 172 that is available from Spring of Palo Alto, Calif., and that can be utilized to create Spring-based applications that can be run via the global privacy and data protection framework system 100 without dependencies. Additionally and/or alternatively, the backend system 170 can comprise a Python system (or circuit) 173 and/or a Mybatis system (or circuit) 174. The Python system 173 is available from the Python Software Foundation of Fredericksburg, Va.; whereas, the Mybatis system 175 can comprise one or more advanced procedures for mapping Java objects related to selected regulations to one or more database models and is available from Apache Software Foundation in Forest Hill, Md.

A schedule job system (or circuit) 175 optionally can be included in the backend system 170. The backend system 170 can comprise a Tika system (or circuit) 176. The Tika system 176 can be used to enable the global privacy and data protection framework system 100 to generate and/or read portable document format (or .pdf) files and is available from Apache Software Foundation in Forest Hill, Md. Additionally and/or alternatively, the backend system 170 can include an OWASP Enterprise Security API (or ESAPI) system (or circuit) 177 that is available from the OSWAP Foundation of Wakefield, Md., and can be used by the global privacy and data protection framework system 100 to provide a trace log. The backend system 170 of FIG. 18 also is illustrated as including a POI system (or circuit) 178, which can be used to generate and/or read Microsoft Excel files and is available from Apache Software Foundation in Forest Hill, Md.

In selected embodiments, one or more of the features disclosed herein can be provided as a computer program product being encoded on one or more non-transitory machine-readable storage media. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A method for analyzing a plurality of regulations, comprising:
creating a first work request for first source data being associated with a first version of a first regulation and being received from a first data source system;
processing the first work request by associating first regulation version text and a first version date with the first version of the first regulation;
storing the processed first version of the first regulation with the first regulation version text and the first version date in a database circuit;
creating a second work request for second source data being associated with a second version of the first regulation and being received from a second data source system;
processing the second work request by associating second regulation version text and a second version date with the second version of the first regulation, the second version date being different from the first version date;
storing the processed second version of the first regulation with the second regulation version text and the second version date in the database circuit;
receiving a user query regarding the first regulation; and
in response to the user query,
retrieving the stored first and second versions of the first regulation from the database circuit;
comparing the retrieved first and second versions of the first regulation to identify at least one change to the first regulation between the first version date and the second version date; and
generating a report with a description for identifying the at least one change to the first regulation based upon said comparing,
wherein the report provides insight for a functional regulatory compliance program.

2. The method of claim 1, wherein said creating the second work request comprises creating the second work request for the second source data being received from the second data source system after the first source data is received from the first data source system.

3. The method of claim 1, wherein the second data source system comprises the first data source system.

4. The method of claim 1,
wherein the first source data is associated with a historic version of the first regulation, and
wherein the second source data is associated with a current version of the first regulation.

5. The method of claim 1,
wherein said receiving the user query includes receiving the user query with first inquiry date information and second inquiry date information, and
wherein said retrieving the stored first and second versions of the first regulation from the database circuit comprises retrieving the stored first version of the first regulation based upon the first inquiry date information and retrieving the stored second version of the first regulation based upon the second inquiry date information.

6. The method of claim 1, further comprising:
creating a third work request for third source data being associated with a third version of the first regulation and being received from a third data source system;
processing the third work request by associating third regulation version text and a third version date with the third version of the first regulation, the third version date being between the first version date and the second version date; and
storing the third version of the first regulation with the third regulation version text and the third version date in the database circuit.

7. The method of claim 6, wherein the third data source system comprises at least one of the first and second data source systems.

8. The method of claim 6, wherein the third version of the first regulation is received concurrently with at least one of the first version of the first regulation and the second version of the first regulation.

9. The method of claim 1,
wherein said creating the first work request includes creating the first work request for first source data being associated with a first version of a second regulation and being received from a third data source system;
wherein said processing the first work request includes associating first regulation version text and a first version date with the first version of the second regulation;
wherein said creating the second work request includes creating the second work request for second source data being associated with a second version of the second regulation and being received from a fourth data source system;
wherein said processing the second work request includes associating second regulation version text and a second version date with the second version of the second regulation, the second version date of the second regulation being different from the first version date of the second regulation; and
storing the first version of the first regulation with the first regulation version text and the first version date and the second version of the first regulation with the second regulation version text and the second version date in the database circuit.

10. The method of claim 9,
wherein said receiving the user query include receiving the user query regarding the first and second regulations,
wherein said retrieving includes retrieving the stored first and second versions of the second regulation from the database circuit,
wherein said comparing includes comparing the retrieved first and second versions of the second regulation to identify at least one change to the second regulation between the first version date and the second version date of the second regulation, and
wherein said generating the report includes generating the report with a description for identifying the at least one change to the second regulation based upon said comparing.

11. The method of claim 9,
wherein the third data source system comprises at least one of the first and second data source systems, and
wherein the fourth data source system comprises at least one of the first, second and third data source systems.

12. The method of claim 1,
wherein said processing the first work request includes parsing the first work request, and
wherein said processing the second work request includes parsing the second work request.

13. The method of claim 12,
wherein said processing the first work request includes reviewing the parsed first work request, and
wherein said processing the second work request includes reviewing the parsed second work request.

14. The method of claim 12,
wherein said processing the first work request includes mapping the parsed first work request, and
wherein said processing the second work request includes mapping the parsed second work request.

15. The method of claim 14,
wherein said processing the first work request includes reviewing the mapped first work request, and
wherein said processing the second work request includes reviewing the mapped second work request.

16. A computer program product for analyzing a plurality of regulations, the computer program product being encoded on one or more non-transitory machine-readable storage media and comprising:
instruction for processing first source data being associated with a first version of a regulation and being received from a first data source system by associating first regulation version text and a first version date with the first version of the regulation;
instruction for storing the first version of the regulation with the first regulation version text and the first version date in a database circuit;
instruction for processing second source data being associated with a second version of the regulation and being received from a second data source system by associating second regulation version text and a second version date with the second version of the regulation, the second version date being different from the first version date;
instruction for storing the second version of the regulation with the second regulation version text and the second version date in the database circuit;
instruction for receiving a user query regarding the regulation; and
in response to the user query,
instruction for retrieving the stored first and second versions of the regulation from the database circuit;
instruction for comparing the retrieved first and second versions of the regulation to identify at least one change to the regulation between the first version date and the second version date; and
instruction for generating a report with a description for identifying the at least one change to the regulation based upon the comparison of the retrieved first and second versions of the regulation,
wherein the report provides insight for a functional regulatory compliance program.

17. A system for analyzing a plurality of regulations, comprising:
a processor circuit being configured for:
processing first source data being associated with a first version of a regulation and being received from a first data source system by associating first regulation version text and a first version date with the first version of the regulation; and
processing second source data being associated with a second version of the regulation and being received from a second data source system by associating second regulation version text and a second version date with the second version of the regulation, the second version date being different from the first version date; and
a database circuit for storing the first version of the regulation with the first regulation version text and the first version date and the second version of the regulation with the second regulation version text and the second version date,
wherein said processing circuit is configured for retrieving the stored first and second versions of the regulation from said database circuit, comparing the retrieved first and second versions of the regulation to identify at least one change to the regulation between the first version date and the second version date, generating a report with a description for identifying the at least one change to the regulation based upon the comparison of the retrieved first and second versions of the regulation in response to a user query regarding the regulation, and
wherein the report provides insight for a functional regulatory compliance program.

18. The system of claim 17, wherein the second data source system comprises the first data source system.

19. The system of claim 17, wherein at least one of the first data source system and the second data source system is remote from said processor circuit.

20. The system of claim 17, wherein said processor circuit is configured to communicate with a user processing device for receiving the user query.
